(19) United States
(12) Patent Application Publication
(10) Pub. No.: US 2024/0272926 A1
(43) Pub. Date: Aug. 15, 2024

(54) BUILDING MANAGEMENT SYSTEM WITH INTEGRATION AND CONTAINERIZATION OF GATEWAY COMPONENTS ON EDGE DEVICES

(71) Applicant: Johnson Controls Tyco IP Holdings LLP, Milwaukee, WI (US)

(72) Inventors: Paul Lu, Buffalo Grove, IL (US); Vasanth Sivasubramanian, St. Louis, MO (US); Vivek Vishnu Gupta, Menomonee Falls, WI (US); Peter Jesse Hazelberg, Dousman, WI (US); Vaibhav Kumar, Gurgaon (IN); Deepak Tripathi, Delhi (IN); Abu Bakr Khan, Franklin, WI (US)

(73) Assignee: Johnson Controls Tyco IP Holdings LLP, Milwaukee, WI (US)

(21) Appl. No.: 18/438,195

(22) Filed: Feb. 9, 2024

(30) Foreign Application Priority Data
Feb. 10, 2023 (IN) 202341008712

(51) Int. Cl. G06F 9/455; G05B 15/02

(52) U.S. Cl. CPC G06F 9/45558; G05B 15/02; G06F 2009/45579; G06F 2009/45595

(57) ABSTRACT

Systems and methods described herein are directed to the integration and containerization of gateway components on edge devices, which may include building device gateways. A gateway executes a building device interface container that communicates, via an interface implemented by the building device interface container, with one or more building devices of the building to control or collect data from the one or more building devices. The gateway executes a processing container that processes the data from the one or more building devices. The gateway implements a virtual communication bus that facilitates communication between the building device interface container and the processing container.

### CROSS-REFERENCES TO RELATED APPLICATIONS

This application claims the benefit of and priority to Indian Patent Application No. 202341008712, filed Feb. 10, 2023, the contents of which is incorporated herein by reference in its entirety for all purposes.

### FIELD OF THE DISCLOSURE

The present disclosure relates generally to the integration and containerization of gateway components on edge devices, which may include building device gateways.

### BACKGROUND

The present disclosure relates generally to a building management system (BMS) that operates for a building, and automatic configuration techniques that may be utilized to configure various computing systems or equipment of a building.

A gateway device may manage the collection of data points of the subsystems of a building. The gateway device can provide collected data points of the subsystems to a building management system (BMS). The BMS may, in some embodiments, operate based on the collected data and/or push new values for data points down to the subsystem through the gateway.

### SUMMARY

At least one aspect of the present disclosure is directed to a building device gateway of a building. The building device gateway can include, for example, one or more processors coupled to a non-transitory memory. The building device gateway can execute a building device interface container that communicates, via an interface implemented by the building device interface container, with one or more building devices of the building to control or collect data from the one or more building devices. The building device gateway can execute a processing container comprising instructions that, when executed by the one or more processors, cause the one or more processors to process the data from the one or more building devices. The building device gateway can implement a virtual communication bus that facilitates communication between the building device interface container and the processing container.

In some implementations, the building device gateway can receive an update to one or more of the building device interface container or the processing container. In some implementations, the building device gateway can modify one or more of the building device interface container or the processing container according to the update. In some implementations, the virtual communication bus comprises a virtual Internet protocol (IP) network.

In some implementations, the building device gateway can execute a cloud communication container that communicates data transmitted via the virtual communication bus to or from a cloud computing system. In some implementations, the building device gateway can execute a cloud proxy container that formats data transmitted via the virtual communication bus according to a standard format of the cloud computing system. In some implementations, the cloud proxy container is further configured to periodically transmit the formatted data to the cloud computing system.

In some implementations, the virtual communication bus is configured to receive and transmit one or more messages identifying one or more topics. In some implementations, the processing container comprises a configuration that subscribes the processing container to a subset of the one or more topics. In some implementations, the processing container comprises one or more of a graphical user interface container, an analytical engine container, an edge management container, or a logs management container.

At least one other aspect of the present disclosure is directed to a method. The method can be performed, for example, by a building device gateway comprising one or more processors and a non-transitory memory. The method can include executing a building device interface container that communicates, via an interface implemented by the building device interface container, with one or more building devices of the building to control or collect data from the one or more building devices. The method can include executing a processing container comprising instructions that, when executed by the one or more processors, cause the one or more processors to process the data from the one or more building devices. The method can include implementing a virtual communication bus that facilitates communication between the building device interface container and the processing container.

In some implementations, the method can include receiving an update to one or more of the building device interface container or the processing container. In some implementations, the method can include modifying one or more of the building device interface container or the processing container according to the update. In some implementations, the virtual communication bus comprises a virtual IP network.

In some implementations, the method can include executing a cloud communication container that communicates data transmitted via the virtual communication bus to or from a cloud computing system. In some implementations, the method can include executing a cloud proxy container that formats data transmitted via the virtual communication bus according to a standard format of the cloud computing system. In some implementations, the cloud proxy container, when executed, is further configured to periodically transmit the formatted data to the cloud computing system.

In some implementations, implementing the virtual communication bus comprises receiving and transmitting one or more messages identifying one or more topics. In some implementations, the processing container comprises a configuration that subscribes the processing container to a subset of the one or more topics. In some implementations, the processing container comprises one or more of a graphical user interface container, an analytical engine container, an edge management container, or a logs management container.

Yet another aspect of the present disclosure is directed to a non-transitory computer-readable medium with processor-executable instructions embodied thereon that, when executed by one or more processors of a building device gateway, cause the building device gateway to perform one or more operations. The operations can include executing a building device interface container that communicates, via an interface implemented by the building device interface container, with one or more building devices of the building to control or collect data from the one or more building devices. The operations can include executing a processing container that processes the data from the one or more building devices. The operations can include implementing a virtual communication bus that facilitates communication between the building device interface container and the processing container.

In some implementations, the operations further include receiving an update to one or more of the building device interface container or the processing container. In some implementations, the operations further include modifying one or more of the building device interface container or the processing container according to the update.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a building data platform including an edge platform, a cloud platform, and a twin manager, according to an embodiment.

FIG. 2 is a graph projection of the twin manager of FIG. 1 including application programming interface (API) data, capability data, policy data, and services, according to an embodiment.

FIG. 3 is another graph projection of the twin manager of FIG. 1 including application programming interface (API) data, capability data, policy data, and services, according to an embodiment.

FIG. 4 is a graph projection of the twin manager of FIG. 1 including equipment and capability data for the equipment, according to an embodiment.

FIG. 5 is a block diagram of the edge platform of FIG. 1 shown in greater detail to include a connectivity manager, a device manager, and a device identity manager, according to an embodiment.

FIG. 6A is another block diagram of the edge platform of FIG. 1 shown in greater detail to include communication layers for facilitating communication between building subsystems and the cloud platform and the twin manager of FIG. 1, according to an embodiment.

FIG. 6B is another block diagram of the edge platform of FIG. 1 shown distributed across building devices of a building, according to an embodiment.

FIG. 7 is a block diagram of components of the edge platform of FIG. 1, including a connector, a building normalization layer, services, and integrations distributed across various computing devices of a building, according to an embodiment.

FIG. 8 is a block diagram of a local building management system (BMS) server including a connector and an adapter service of the edge platform of FIG. 1 that operate to connect an engine with the cloud platform of FIG. 1, according to an embodiment.

FIG. 9 is a block diagram of the engine of FIG. 8 including connectors and an adapter service to connect the engine with the local BMS server of FIG. 8 and the cloud platform of FIG. 1, according to an embodiment.

FIG. 10 is a block diagram of a gateway including an adapter service connecting the engine of FIG. 8 to the cloud platform of FIG. 1, according to an embodiment.

FIG. 11 is a block diagram of a surveillance camera and a smart thermostat for a zone of the building that uses the edge platform of FIG. 1 to perform event based control, according to an embodiment.

FIG. 12 is a block diagram of a cluster based gateway that runs micro-services for facilitating communication between building subsystems and cloud applications, according to an embodiment.

FIG. 13 is a flow diagram of an example method for deploying gateway components on one or more computing systems of a building, according to an embodiment.

FIG. 14 is a flow diagram of an example method for deploying gateway components on a local BMS server, according to an embodiment.

FIG. 15 is a flow diagram of an example method for deploying gateway components on a network engine, according to an embodiment.

FIG. 16 is a flow diagram of an example method for deploying gateway components on a dedicated gateway, according to an embodiment.

FIG. 17 is a flow diagram of an example method for implementing gateway components on a building device, according to an embodiment.

FIG. 18 is a flow diagram of an example method for deploying gateway components to perform a building control algorithm, according to an embodiment.

FIG. 19 is a system diagram that may be utilized to perform optimization and autoconfiguration of edge processing devices, according to an embodiment.

FIG. 20 is a block diagram of an example system including an example building device gateway that implements containerized gateway components, in accordance with one or more implementations.

FIG. 21 is a block diagram of an example base image that may be implemented by the building device gateway described in connection with FIGS. 20, in accordance with one or more implementations.

FIG. 22 is a flow diagram of an example method for the integration and containerization of gateway components on edge devices, in accordance with one or more implementations.

### DETAILED DESCRIPTION

### Overview

Referring generally to the figures, systems and methods for a building management system (BMS) with an edge system is shown, according to various exemplary embodiments. The edge system may, in some embodiments, be a software service added to a network of a BMS that can run on one or multiple different nodes of the network. The software service can be made up in terms of components, e.g., integration components, connector components, a building normalization component, software service components, endpoints, etc. The various components can be deployed on various nodes of the network to implement an edge platform that facilitates communication between a cloud or other off-premises platform and the local subsystems of the building. In some embodiments, the edge platform techniques described herein can be implemented for supporting off-premises platforms such as servers, computing clusters, computing systems located in a building other than the edge platform, or any other computing environment.

The nodes of the network could be servers, desktop computers, controllers, virtual machines, etc. In some implementations, the edge system can be deployed on multiple nodes of a network or multiple devices of a BMS with or without interfacing with a cloud or off-premises system. For example, in some implementations, the systems and methods of the present disclosure could be used to coordinate between multiple on-premises devices to perform functions of the BMS partially or wholly without interacting with a cloud or off-premises device (e.g., in a peer-to-peer manner between edge-based devices or in coordination with an on-premises server/gateway).

In some embodiments, the various components of the edge platform can be moved around various nodes of the BMS network as well as the cloud platform. The components may include software services, e.g., control applications, analytics applications, machine learning models, artificial intelligence systems, user interface applications, etc. The software services may have requirements, e.g., a requirement that another software service be present or be in communication with the software service, a particular level of processing resource availability, a particular level of storage availability, etc. In some embodiments, the services of the edge platform can be moved around the nodes of the network based on available data, processing hardware, memory devices, etc. of the nodes. The various software services can be dynamically relocated around the nodes of the network based on the requirements for each software service. In some embodiments, an orchestrator run in a cloud platform, orchestrators distributed across the nodes of the network, and/or the software service itself can make determinations to dynamically relocate the software service around the nodes of the network and/or the cloud platform.

In some embodiments, the edge system can implement plug and play capabilities for connecting devices of a building and connecting the devices to the cloud platform. In some embodiments, the components of the edge system can automatically configure the connection for a new device. For example, when a new device is connected to the edge platform, a tagging and/or recognition process can be performed. This tagging and recognition could be performed in a first building. The result of the tagging and/or recognition may be a configuration indicating how the new device or subsystem should be connected, e.g., point mappings, point lists, communication protocols, necessary integrations, etc. The tagging and/or discovery can, in some embodiments, be performed in a cloud platform and/or twin platform, e.g., based on a digital twin. The resulting configuration can be distributed to every node of the edge system, e.g., to a building normalization component. In some embodiments, the configuration can be stored in a single system, e.g., the cloud platform, and the building normalization component can retrieve the configuration from the cloud platform.

When another device of the same type is installed in the building or another building, a building normalization component can store an indication of the configuration and/or retrieve the indication of the configuration from the cloud platform. The building normalization component can facilitate plug and play by loading and/or implementing the configuration for the device without requiring a tagging and/or discover process. This can allow for the device to be installed and run without requiring any significant amount of setup.

In some embodiments, the building normalization component of one node may discover a device connected to the node. Responsive to detecting the new device, the building normalization component may search a device library and/or registry stored in the normalization component (or on another system) to identify a configuration for the new device. If the new device configuration is not present, the normalization component may send a broadcast to other nodes. For example, the broadcast could indicate an air handling unit (AHU) of a particular type, for a particular vendor, with particular points, etc. Other nodes could respond to the broadcast message with a configuration for the AHU. In some embodiments, a cloud platform could unify configurations for devices of multiple building sites and thus a configuration discovered at one building site could be used at another building site through the cloud platform. In some embodiments, the configurations for different devices could be stored in a digital twin. The digital twin could be used to perform auto configuration, in some embodiments.

In some embodiments, a digital twin of a building could be analyzed to identify how to configure a new device when the new device is connected to an edge device. For example, the digital twin could indicate the various points, communication protocols, functions, etc. of a device type of the new device (e.g., another instance of the device type). Based on the indication of the digital twin, a particular configuration for the new device could be deployed to the edge device that facilitates communication for the new device.

### Building Data Platform

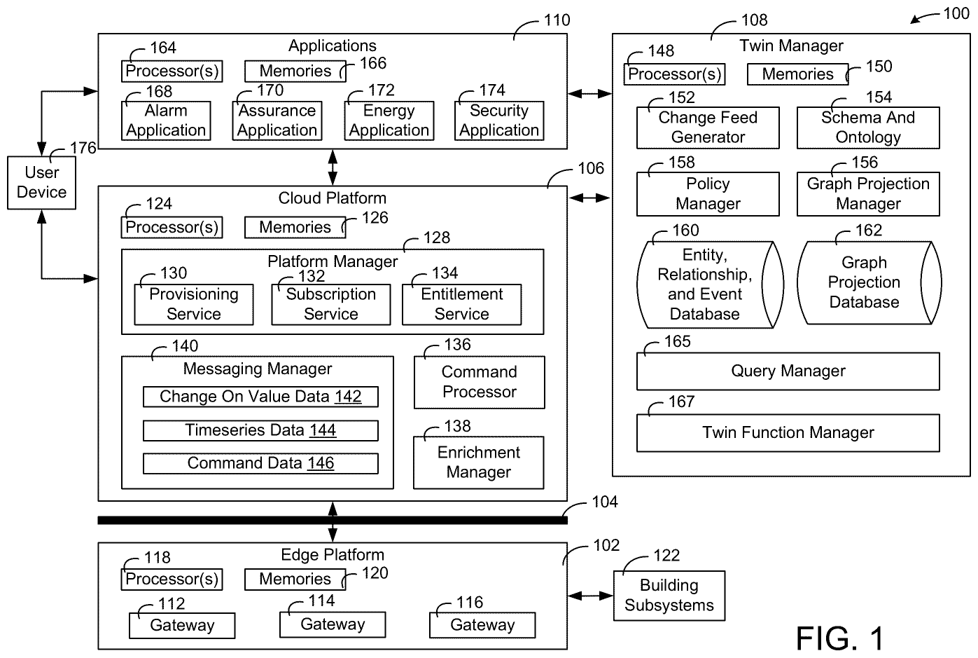

Referring now to FIG. 1, a building data platform 100 including an edge platform 102, a cloud platform 106, and a twin manager 108 are shown, according to an exemplary embodiment. The edge platform 102, the cloud platform 106, and the twin manager 108 can each be separate services deployed on the same or different computing systems. In some embodiments, the cloud platform 106 and the twin manager 108 are implemented in off premises computing systems, e.g., outside a building. The edge platform 102 can be implemented on-premises, e.g., within the building. However, any combination of on-premises and off-premises components of the building data platform 100 can be implemented.

The building data platform 100 includes applications 110. The applications 110 can be various applications that operate to manage the building subsystems 122. The applications 110 can be remote or on-premises applications (or a hybrid of both) that run on various computing systems. The applications 110 can include an alarm application 168 configured to manage alarms for the building subsystems 122. The applications 110 include an assurance application 170 that implements assurance services for the building subsystems 122. In some embodiments, the applications 110 include an energy application 172 configured to manage the energy usage of the building subsystems 122. The applications 110 include a security application 174 configured to manage security systems of the building.

In some embodiments, the applications 110 and/or the cloud platform 106 interacts with a user device 176. In some embodiments, a component or an entire application of the applications 110 runs on the user device 176. The user device 176 may be a laptop computer, a desktop computer, a smartphone, a tablet, and/or any other device with an input interface (e.g., touch screen, mouse, keyboard, etc.) and an output interface (e.g., a speaker, a display, etc.).

The applications 110, the twin manager 108, the cloud platform 106, and the edge platform 102 can be implemented on one or more computing systems, e.g., on processors and/or memory devices. For example, the edge platform 102 includes processor(s) 118 and memories 120, the cloud platform 106 includes processor(s) 124 and memories 126, the applications 110 include processor(s) 164 and memories 166, and the twin manager 108 includes processor(s) 148 and memories 150.

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 102 can be configured to provide connection to the building subsystems 122. The edge platform 102 can receive messages from the building subsystems 122 and/or deliver messages to the building subsystems 122. The edge platform 102 includes one or multiple gateways, e.g., the gateways 112-116. The gateways 112-116 can act as a gateway between the cloud platform 106 and the building subsystems 122. The gateways 112-116 can be the gateways described in U.S. patent application Ser. No. 17/127,303, filed Dec. 18, 2020, the entirety of which is incorporated by reference herein. In some embodiments, the applications 110 can be deployed on the edge platform 102. In this regard, lower latency in management of the building subsystems 122 can be realized.

The edge platform 102 can be connected to the cloud platform 106 via a network 104. The network 104 can communicatively couple the devices and systems of building data platform 100. In some embodiments, the network 104 is at least one of and/or a combination of a Wi-Fi network, a wired Ethernet network, a ZigBee network, a Bluetooth network, and/or any other wireless network. The network 104 may be a local area network or a wide area network (e.g., the Internet, a building WAN, etc.) and may use a variety of communications protocols (e.g., BACnet, IP, LON, etc.). The network 104 may include routers, modems, servers, cell towers, satellites, and/or network switches. The network 104 may be a combination of wired and wireless networks.

The cloud platform 106 can be configured to facilitate communication and routing of messages between the applications 110, the twin manager 108, the edge platform 102, and/or any other system. The cloud platform 106 can include a platform manager 128, a messaging manager 140, a command processor 136, and an enrichment manager 138. In some embodiments, the cloud platform 106 can facilitate messaging between the building data platform 100 via the network 104.

The messaging manager 140 can be configured to operate as a transport service that controls communication with the building subsystems 122 and/or any other system, e.g., managing commands to devices (C2D), commands to connectors (C2C) for external systems, commands from the device to the cloud (D2C), and/or notifications. The messaging manager 140 can receive different types of data from the applications 110, the twin manager 108, and/or the edge platform 102. The messaging manager 140 can receive change on value data 142, e.g., data that indicates that a value of a point has changed. The messaging manager 140 can receive timeseries data 144, e.g., a time correlated series of data entries each associated with a particular time stamp. Furthermore, the messaging manager 140 can receive command data 146. All of the messages handled by the cloud platform 106 can be handled as an event, e.g., the data 142-146 can each be packaged as an event with a data value occurring at a particular time (e.g., a temperature measurement made at a particular time).

The cloud platform 106 includes a command processor 136. The command processor 136 can be configured to receive commands to perform an action from the applications 110, the building subsystems 122, the user device 176, etc. The command processor 136 can manage the commands, determine whether the commanding system is authorized to perform the particular commands, and communicate the commands to the commanded system, e.g., the building subsystems 122 and/or the applications 110. The commands could be a command to change an operational setting that control environmental conditions of a building, a command to run analytics, etc.

The cloud platform 106 includes an enrichment manager 138. The enrichment manager 138 can be configured to enrich the events received by the messaging manager 140. The enrichment manager 138 can be configured to add contextual information to the events. The enrichment manager 138 can communicate with the twin manager 108 to retrieve the contextual information. In some embodiments, the contextual information is an indication of information related to the event. For example, if the event is a timeseries temperature measurement of a thermostat, contextual information such as the location of the thermostat (e.g., what room), the equipment controlled by the thermostat (e.g., what VAV), etc. can be added to the event. In this regard, when a consuming application, e.g., one of the applications 110 receives the event, the consuming application can operate based on the data of the event, the temperature measurement, and also the contextual information of the event.

The enrichment manager 138 can solve a problem that when a device produces a significant amount of information, the information may contain simple data without context. An example might include the data generated when a user scans a badge at a badge scanner of the building subsystems 122. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, build, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 building in a campus that receive 100,000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 138 may be:

```
{
  “id”: “someguid”,
    “eventType”: “Device_Heartbeat”,
    “eventTime”: “2018-01-27T00:00:00+00:00”
    “eventValue”: 1,
    “deviceID”: “someguid”
}
```

An example of an enriched event generated by the enrichment manager 138 may be:

{
“id”: “someguid”,
“eventType”: “Device_Heartbeat”,
“eventTime”: “2018-01-27T00:00:00+00:00”
“eventValue”: 1,
“deviceID”: “someguid”,
“buildingName”: “Building-48”,
“buildingID”: “SomeGuid”,
“panelID”: “SomeGuid”,
“panelName”: “Building-48-Panel-13”,
“cityID”: 371,
“cityName”: “Milwaukee”,
“stateID”: 48,
“stateName”: “Wisconsin (WI)”,
“countryID”: 1,
“countryName”: “United States”
}

By receiving enriched events, an application of the applications 110 can be able to populate and/or filter what events are associated with what areas. Furthermore, user interface generating applications can generate user interfaces that include the contextual information based on the enriched events.

The cloud platform 106 includes a platform manager 128. The platform manager 128 can be configured to manage the users and/or subscriptions of the cloud platform 106. For example, what subscribing building, user, and/or tenant utilizes the cloud platform 106. The platform manager 128 includes a provisioning service 130 configured to provision the cloud platform 106, the edge platform 102, and the twin manager 108. The platform manager 128 includes a subscription service 132 configured to manage a subscription of the building, user, and/or tenant while the entitlement service 134 can track entitlements of the buildings, users, and/or tenants.

The twin manager 108 can be configured to manage and maintain a digital twin. The digital twin can be a digital representation of the physical environment, e.g., a building. The twin manager 108 can include a change feed generator 152, a schema and ontology 154, a projection manager 156, a policy manager 158, an entity, relationship, and event database 160, and a graph projection database 162.

The graph projection manager 156 can be configured to construct graph projections and store the graph projections in the graph projection database 162. Entities, relationships, and events can be stored in the database 160. The graph projection manager 156 can retrieve entities, relationships, and/or events from the database 160 and construct a graph projection based on the retrieved entities, relationships and/or events. In some embodiments, the database 160 includes an entity-relationship collection for multiple subscriptions.

In some embodiment, the graph projection manager 156 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 156 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 156 and stored in the graph projection database 162 can be a knowledge graph and is an integration point. For example, the graph projections can represent floor plans and systems associated with each floor. Furthermore, the graph projections can include events, e.g., telemetry data of the building subsystems 122. The graph projections can show application services as nodes and API calls between the services as edges in the graph. The graph projections can illustrate the capabilities of spaces, users, and/or devices. The graph projections can include indications of the building subsystems 122, e.g., thermostats, cameras, VAVs, etc. The graph projection database 162 can store graph projections that keep up a current state of a building.

The graph projections of the graph projection database 162 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 138 can use a graph projection of the graph projection database 162 to enrich events. In some embodiments, the enrichment manager 138 can identify nodes and relationships that are associated with, and are pertinent to, the device that generated the event. For example, the enrichment manager 138 could identify a thermostat generating a temperature measurement event within the graph. The enrichment manager 138 can identify relationships between the thermostat and spaces, e.g., a zone that the thermostat is located in. The enrichment manager 138 can add an indication of the zone to the event.

Furthermore, the command processor 136 can be configured to utilize the graph projections to command the building subsystems 122. The command processor 136 can identify a policy for a commanding entity within the graph projection to determine whether the commanding entity has the ability to make the command. For example, the command processor 136, before allowing a user to make a command, determine, based on the graph projection database 162, to determine that the user has a policy to be able to make the command.

In some embodiments, the policies can be conditional based policies. For example, the building data platform 100 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 100 determines, based on the one or more conditional rules, that an action requested by a system does not match a normal behavior, the building data platform 100 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 100 may contact an administrator to determine whether to give the user permission to log in.

The change feed generator 152 can be configured to generate a feed of events that indicate changes to the digital twin, e.g., to the graph. The change feed generator 152 can track changes to the entities, relationships, and/or events of the graph. For example, the change feed generator 152 can detect an addition, deletion, and/or modification of a node or edge of the graph, e.g., changing the entities, relationships, and/or events within the database 160. In response to detecting a change to the graph, the change feed generator 152 can generate an event summarizing the change. The event can indicate what nodes and/or edges have changed and how the nodes and edges have changed. The events can be posted to a topic by the change feed generator 152.

The change feed generator 152 can implement a change feed of a knowledge graph. The building data platform 100 can implement a subscription to changes in the knowledge graph. When the change feed generator 152 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 108 may contain the history and the current state of the graph based upon schema evaluation, a consumer can retain a copy of that data, and thereby create dynamic views using the change feed.

The schema and ontology 154 can define the message schema and graph ontology of the twin manager 108. The message schema can define what format messages received by the messaging manager 140 should have, e.g., what parameters, what formats, etc. The ontology can define graph projections, e.g., the ontology that a user wishes to view. For example, various systems, applications, and/or users can be associated with a graph ontology. Accordingly, when the graph projection manager 156 generates an graph projection for a user, system, or subscription, the graph projection manager 156 can generate a graph projection according to the ontology specific to the user. For example, the ontology can define what types of entities are related in what order in a graph, for example, for the ontology for a subscription of “Customer A,” the graph projection manager 156 can create relationships for a graph projection based on the rule:

Region←→Building←→Floor←→Space←→Asset

For the ontology of a subscription of “Customer B,” the graph projection manager 156 can create relationships based on the rule:

Building Floor←→Asset

The policy manager 158 can be configured to respond to requests from other applications and/or systems for policies. The policy manager 158 can consult a graph projection to determine what permissions different applications, users, and/or devices have. The graph projection can indicate various permissions that different types of entities have and the policy manager 158 can search the graph projection to identify the permissions of a particular entity. The policy manager 158 can facilitate fine grain access control with user permissions. The policy manager 158 can apply permissions across a graph, e.g., if “user can view all data associated with floor 1” then they see all subsystem data for that floor, e.g., surveillance cameras, HVAC devices, fire detection and response devices, etc.

The twin manager 108 includes a query manager 165 and a twin function manager 167. The query manger 164 can be configured to handle queries received from a requesting system, e.g., the user device 176, the applications 110, and/or any other system. The query manager 165 can receive queries that include query parameters and context. The query manager 165 can query the graph projection database 162 with the query parameters to retrieve a result. The query manager 165 can then cause an event processor, e.g., a twin function, to operate based on the result and the context. In some embodiments, the query manager 165 can select the twin function based on the context and/or perform operates based on the context.

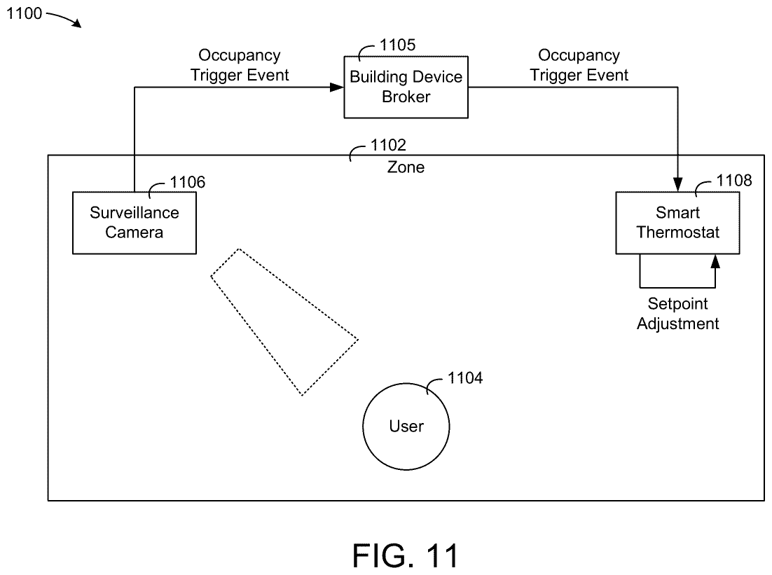

The twin function manager 167 can be configured to manage the execution of twin functions. The twin function manager 167 can receive an indication of a context query that identifies a particular data element and/or pattern in the graph projection database 162. Responsive to the particular data element and/or pattern occurring in the graph projection database 162 (e.g., based on a new data event added to the graph projection database 162 and/or change to nodes or edges of the graph projection database 162, the twin function manager 167 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc. The twin function manager 167 can be configured to perform the operations of the FIGS. 11-15.

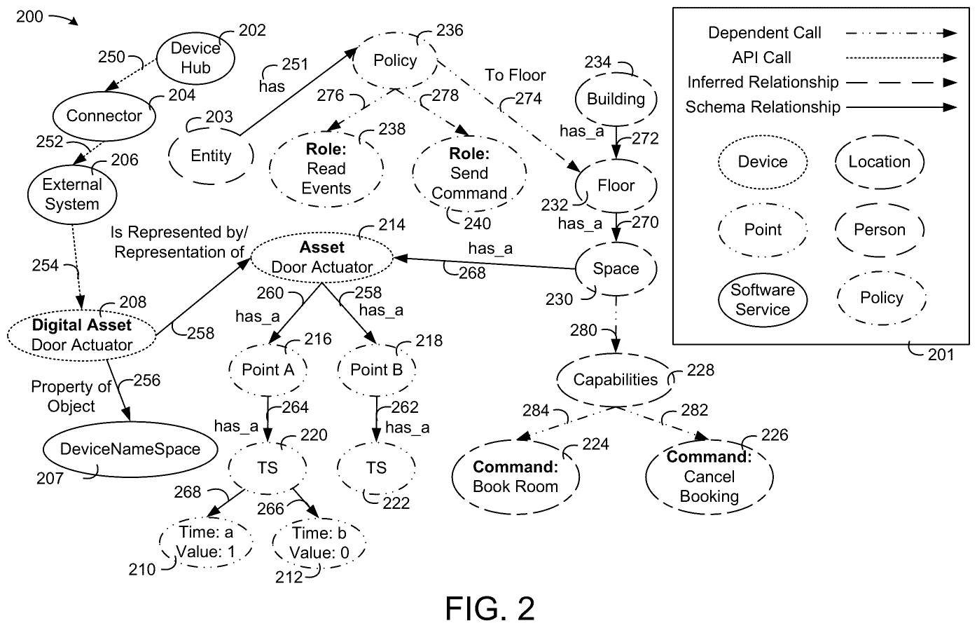

Referring now to FIG. 2, a graph projection 200 of the twin manager 108 including application programming interface (API) data, capability data, policy data, and services is shown, according to an exemplary embodiment. The graph projection 200 includes nodes 202-240 and edges 250-272. The nodes 202-240 and the edges 250-272 are defined according to the key 201. The nodes 202-240 represent different types of entities, devices, locations, points, persons, policies, and software services (e.g., API services). The edges 250-272 represent relationships between the nodes 202-240, e.g., dependent calls, API calls, inferred relationships, and schema relationships (e.g., BRICK relationships).

The graph projection 200 includes a device hub 202 which may represent a software service that facilitates the communication of data and commands between the cloud platform 106 and a device of the building subsystems 122, e.g., door actuator 214. The device hub 202 is related to a connector 204, an external system 206, and a digital asset “Door Actuator” 208 by edge 250, edge 252, and edge 254.

The cloud platform 106 can be configured to identify the device hub 202, the connector 204, the external system 206 related to the door actuator 214 by searching the graph projection 200 and identifying the edges 250-254 and edge 258. The graph projection 200 includes a digital representation of the “Door Actuator,” node 208. The digital asset “Door Actuator” 208 includes a “DeviceNameSpace” represented by node 207 and related to the digital asset “Door Actuator” 208 by the “Property of Object” edge 256.

The “Door Actuator” 214 has points and timeseries. The “Door Actuator” 214 is related to “Point A” 216 by a “has_a” edge 260. The “Door Actuator” 214 is related to “Point B” 218 by a “has_A” edge 258. Furthermore, timeseries associated with the points A and B are represented by nodes “TS” 220 and “TS” 222. The timeseries are related to the points A and B by “has_a” edge 264 and “has_a” edge 262. The timeseries “TS” 220 has particular samples, sample 210 and 212 each related to “TS” 220 with edges 268 and 266 respectively. Each sample includes a time and a value. Each sample may be an event received from the door actuator that the cloud platform 106 ingests into the entity, relationship, and event database 160, e.g., ingests into the graph projection 200.

The graph projection 200 includes a building 234 representing a physical building. The building includes a floor represented by floor 232 related to the building 234 by the “has_a” edge from the building 234 to the floor 232. The floor has a space indicated by the edge “has_a” 270 between the floor 232 and the space 230. The space has particular capabilities, e.g., is a room that can be booked for a meeting, conference, private study time, etc. Furthermore, the booking can be canceled. The capabilities for the floor 232 are represented by capabilities 228 related to space 230 by edge 280. The capabilities 228 are related to two different commands, command “book room” 224 and command “cancel booking” 226 related to capabilities 228 by edge 284 and edge 282 respectively.

If the cloud platform 106 receives a command to book the space represented by the node, space 230, the cloud platform 106 can search the graph projection 200 for the capabilities for the 228 related to the space 230 to determine whether the cloud platform 106 can book the room.

In some embodiments, the cloud platform 106 could receive a request to book a room in a particular building, e.g., the building 234. The cloud platform 106 could search the graph projection 200 to identify spaces that have the capabilities to be booked, e.g., identify the space 230 based on the capabilities 228 related to the space 230. The cloud platform 106 can reply to the request with an indication of the space and allow the requesting entity to book the space 230.

The graph projection 200 includes a policy 236 for the floor 232. The policy 236 is related set for the floor 232 based on a “To Floor” edge 274 between the policy 236 and the floor 232. The policy 236 is related to different roles for the floor 232, read events 238 via edge 276 and send command 240 via edge 278. The policy 236 is set for the entity 203 based on has edge 251 between the entity 203 and the policy 236.

The twin manager 108 can identify policies for particular entities, e.g., users, software applications, systems, devices, etc. based on the policy 236. For example, if the cloud platform 106 receives a command to book the space 230. The cloud platform 106 can communicate with the twin manager 108 to verify that the entity requesting to book the space 230 has a policy to book the space. The twin manager 108 can identify the entity requesting to book the space as the entity 203 by searching the graph projection 200. Furthermore, the twin manager 108 can further identify the edge has 251 between the entity 203 and the policy 236 and the edge between the policy 236 and the command 240.

Furthermore, the twin manager 108 can identify that the entity 203 has the ability to command the space 230 based on the edge between the policy 236 and the edge 270 between the floor 232 and the space 230. In response to identifying the entity 203 has the ability to book the space 230, the twin manager 108 can provide an indication to the cloud platform 106.

Furthermore, if the entity makes a request to read events for the space 230, e.g., the sample 210 and the sample 212, the twin manager 108 can identify the edge has 251 between the entity 203 and the policy 236, the edge between the policy 236 and the read events 238, the edge between the policy 236 and the floor 232, the “has_a” edge 270 between the floor 232 and the space 230, the edge 268 between the space 230 and the door actuator 214, the edge 260 between the door actuator 214 and the point A 216, the “has_a” edge 264 between the point A 216 and the TS 220, and the edges 268 and 266 between the TS 220 and the samples 210 and 212 respectively.

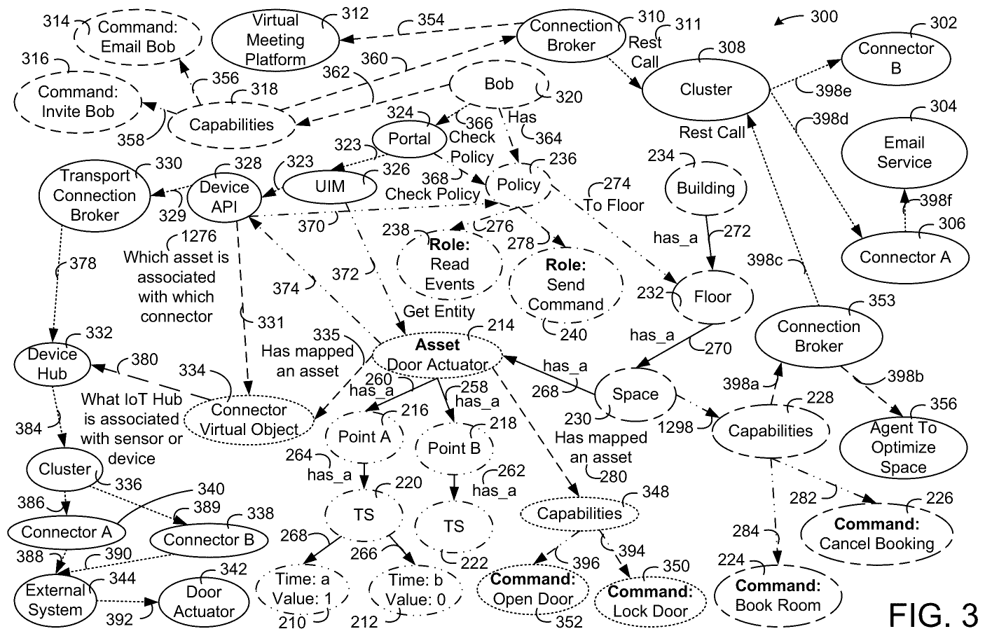

Referring now to FIG. 3, a graph projection 300 of the twin manager 108 including application programming interface (API) data, capability data, policy data, and services is shown, according to an exemplary embodiment. The graph projection 300 includes the nodes and edges described in the graph projection 200 of FIG. 2. The graph projection 300 includes a connection broker related to capabilities 228 by edge 398a. The connection broker 353 can be a node representing a software application configured to facilitate a connection with another software application. In some embodiments, the cloud platform 106 can identify the system that implements the capabilities 228 by identifying the edge 398a between the capabilities 228 and the connection broker 353.

The connection broker 353 is related to an agent that optimizes a space 356 via edge 398b. The agent represented by the node 356 can book and cancel bookings for the space represented by the node 230 based on the edge 398b between the connection broker 353 and the node 356 and the edge 398a between the capabilities 228 and the connection broker 353.

The connection broker 353 is related to a cluster 308 by edge 398c. Cluster 308 is related to connector B 302 via edge 398c and connector A 306 via edge 398d. The connector A 306 is related to an external subscription service 304. A connection broker 310 is related to cluster 308 via an edge 311 representing a rest call that the connection broker represented by node 310 can make to the cluster represented by cluster 308.

The connection broker 310 is related to a virtual meeting platform 312 by an edge 354. The node 312 represents an external system that represents a virtual meeting platform. The connection broker represented by node 310 can represent a software component that facilitates a connection between the cloud platform 106 and the virtual meeting platform represented by node 312. When the cloud platform 106 needs to communicate with the virtual meeting platform represented by the node 312, the cloud platform 106 can identify the edge 354 between the connection broker 310 and the virtual meeting platform 312 and select the connection broker represented by the node 310 to facilitate communication with the virtual meeting platform represented by the node 312.

A capabilities node 318 can be connected to the connection broker 310 via edge 360. The capabilities 318 can be capabilities of the virtual meeting platform represented by the node 312 and can be related to the node 312 through the edge 360 to the connection broker 310 and the edge 354 between the connection broker 310 and the node 312. The capabilities 318 can define capabilities of the virtual meeting platform represented by the node 312. The node 320 is related to capabilities 318 via edge 362. The capabilities may be an invite bob command represented by node 316 and an email bob command represented by node 314. The capabilities 318 can be linked to a node 320 representing a user, Bob. The cloud platform 106 can facilitate email commands to send emails to the user Bob via the email service represented by the node 304. The node 304 is related to the connect a node 306 via edge 398f. Furthermore, the cloud platform 106 can facilitate sending an invite for a virtual meeting via the virtual meeting platform represented by the node 312 linked to the node 318 via the edge 358.

The node 320 for the user Bob can be associated with the policy 236 via the “has” edge 364. Furthermore, the node 320 can have a “check policy” edge 366 with a portal node 324. The device API node 328 has a check policy edge 370 to the policy node 236. The portal node 324 has an edge 368 to the policy node 236. The portal node 324 has an edge 323 to a node 326 representing a user input manager (UIM). The portal node 324 is related to the UIM node 326 via an edge 323. The UIM node 326 has an edge 323 to a device API node 328. The UIM node 326 is related to the door actuator node 214 via edge 372. The door actuator node 214 has an edge 374 to the device API node 328. The door actuator 214 has an edge 335 to the connector virtual object 334. The device hub 332 is related to the connector virtual object via edge 380. The device API node 328 can be an API for the door actuator 214. The connector virtual object 334 is related to the device API node 328 via the edge 331.

The device API node 328 is related to a transport connection broker 330 via an edge 329. The transport connection broker 330 is related to a device hub 332 via an edge 378. The device hub represented by node 332 can be a software component that hands the communication of data and commands for the door actuator 214. The cloud platform 106 can identify where to store data within the graph projection 300 received from the door actuator by identifying the nodes and edges between the points 216 and 218 and the device hub node 332. Similarly, the cloud platform 308 can identify commands for the door actuator that can be facilitated by the device hub represented by the node 332, e.g., by identifying edges between the device hub node 332 and an open door node 352 and an lock door node 350. The door actuator 114 has an edge “has mapped an asset” 280 between the node 214 and a capabilities node 348. The capabilities node 348 and the nodes 352 and 350 are linked by edges 396 and 394.

The device hub 332 is linked to a cluster 336 via an edge 384. The cluster 336 is linked to connector A 340 and connector B 338 by edges 386 and the edge 389. The connector A 340 and the connector B 338 is linked to an external system 344 via edges 388 and 390. The external system 344 is linked to a door actuator 342 via an edge 392.

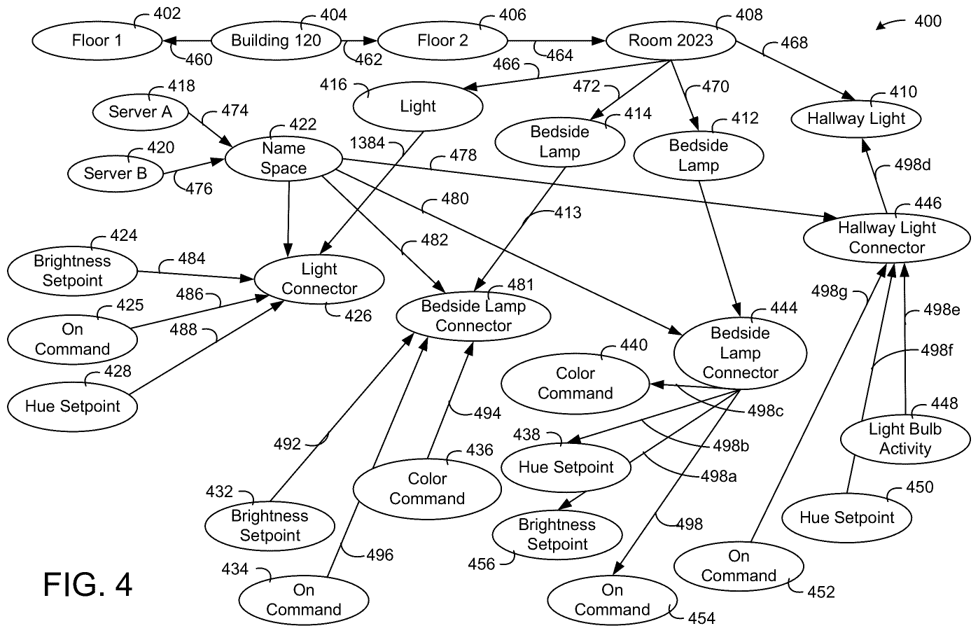

Referring now to FIG. 4, a graph projection 400 of the twin manager 108 including equipment and capability data for the equipment is shown, according to an exemplary embodiment. The graph projection 400 includes nodes 402-456 and edges 360-498f. The cloud platform 106 can search the graph projection 400 to identify capabilities of different pieces of equipment.

A building node 404 represents a particular building that includes two floors. A floor 1 node 402 is linked to the building node 404 via edge 460 while a floor 2 node 406 is linked to the building node 404 via edge 462. The floor 2 includes a particular room represented by edge 464 between floor 2 node 406 and room node 408. Various pieces of equipment are included within the room. A light represented by light node 416, a bedside lamp node 414, a bedside lamp node 412, and a hallway light node 410 are related to room node 408 via edge 466, edge 472, edge 470, and edge 468.

The light represented by light node 416 is related to a light connector 426 via edge 484. The light connector 426 is related to multiple commands for the light represented by the light node 416 via edges 484, 486, and 488. The commands may be a brightness setpoint 424, an on command 425, and a hue setpoint 428. The cloud platform 106 can receive a request to identify commands for the light represented by the light 416 and can identify the nodes 424-428 and provide an indication of the commands represented by the node 424-428 to the requesting entity. The requesting entity can then send commands for the commands represented by the nodes 424-428.

The bedside lamp node 414 is linked to a bedside lamp connector 481 via an edge 413. The connector 481 is related to commands for the bedside lamp represented by the bedside lamp node 414 via edges 492, 496, and 494. The command nodes are a brightness setpoint node 432, an on command node 434, and a color command 436. The hallway light 410 is related to a hallway light connector 446 via an edge 498d. The hallway light connector 446 is linked to multiple commands for the hallway light node 410 via edges 498g, 498f, and 498e. The commands are represented by an on command node 452, a hue setpoint node 450, and a light bulb activity node 448.

The graph projection 400 includes a name space node 422 related to a server A node 418 and a server B node 420 via edges 474 and 476. The name space node 422 is related to the bedside lamp connector 481, the bedside lamp connector 444, and the hallway light connector 446 via edges 482, 480, and 478. The bedside lamp connector 444 is related to commands, e.g., the color command node 440, the hue setpoint command 438, a brightness setpoint command 456, and an on command 454 via edges 498c, 498b, 498a, and 498.

### Edge Platform

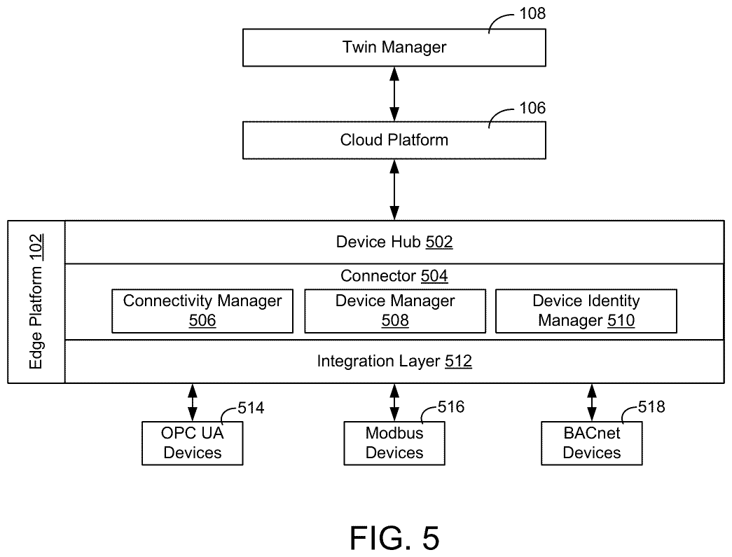

Referring now to FIG. 5, the edge platform 102 is shown in greater detail to include a connectivity manager 506, a device manager 508, and a device identity manager 510, according to an exemplary embodiment. In some embodiments, the edge platform 102 of FIG. 5 may be a particular instance run on a computing device. For example, the edge platform 102 could be instantiated one or multiple times on various computing devices of a building, a cloud, etc. In some embodiments, each instance of the edge platform 102 may include the connectivity manager 506, the device manager 508, and/or the device identity manager 510. These three components may serve as the core of the edge platform 102.

The edge platform 102 can include a device hub 502, a connector 504, and/or an integration layer 512. The edge platform 102 can facilitate communication between the devices 514-518 and the cloud platform 106 and/or twin manager 108. The communication can be telemetry, commands, control data, etc. Examples of command and control via a building data platform is described in U.S. patent application Ser. No. 17/134,661 filed Dec. 28, 2020, the entirety of which is incorporated by reference herein.

The devices 514-518 can be building devices that communicate with the edge platform 102 via a variety of various building protocols. For example, the protocol could be Open Platform Communications (OPC) Unified Architecture (UA), Modbus, BACnet, etc. The integration layer 512 can, in some embodiments, integrate the various devices 514-518 through the respective communication protocols of each of the devices 514-518. In some embodiments, the integration layer 512 can dynamically include various integration components based on the needs of the instance of the edge platform 102, for example, if a BACnet device is connected to the edge platform 102, the edge platform 102 may run a BACnet integration component. The connector 504 may be the core service of the edge platform 102. In some embodiments, every instance of the edge platform 102 can include the connector 504. In some embodiments, the edge platform 102 is a light version of a gateway.

In some embodiments, the connectivity manager 506 operates to connect the devices 514-518 with the cloud platform 106 and/or the twin manager 108. The connectivity manager 506 can allow a device running the connectivity manager 506 to connect with an ecosystem, the cloud platform 106, another device, another device which in turn connects the device to the cloud, connects to a data center, a private on-premises cloud, etc. The connectivity manager 506 can facilitate communication northbound (with higher level networks), southbound (with lower level networks), and/or east/west (e.g., with peer networks). The connectivity manager 506 can implement communication via MQ Telemetry Transport (MQTT) and/or sparkplug, in some embodiments. The operational abilities of the connectivity manager 506 can be extended via an software development toolkit (SDK), and/or an API. In some embodiments, the connectivity manager 506 can handle offline network states with various networks.

In some embodiments, the device manager 508 can be configured to manage updates and/or upgrades for the device that the device manager 508 is run on, the software for the edge platform 102 itself, and/or devices connected to the edge platform 102, e.g., the devices 514-518. The software updates could be new software components, e.g., services, new integrations, etc. The device manager 508 can be used to manage software for edge platforms for a site, e.g., make updates or changes on a large scale across multiple devices. In some embodiments, the device manager 508 can implement an upgrade campaign where one or more certain device types and/or pieces of software are all updated together. The update depth may be of any order, e.g., a single update to a device, an update to a device and a lower level device that the device communication with, etc. In some embodiments, the software updates are delta updates, which are suitable for low-bandwidth devices. For example, instead of replacing an entire piece of software on the edge platform 102, only the portions of the piece of software that need to be updated may be updated, thus reducing the amount of data that needs to be downloaded to the edge platform 102 in order to complete the update.

The device identity manager 510 can implement authorization and authentication for the edge platform 102. For example, when the edge platform 102 connects with the cloud platform 106, the twin manager 108, and/or the devices 514-518, the device identity manager 510 can identify the edge platform 102 to the various platforms, managers, and/or devices. Regardless of the device that the edge platform 102 is implemented on, the device identity manager 510 can handle identification and uniquely identify the edge platform 102. The device identity manager 510 can handle certification management, trust data, authentication, authorization, encryption keys, credentials, signatures, etc. Furthermore, the device identity manager 510 may implement various security features for the edge platform 102, e.g., antivirus software, firewalls, verified private networks (VPNs), etc. Furthermore, the device identity manager 510 can manage commissioning and/or provisioning for the edge platform 102.

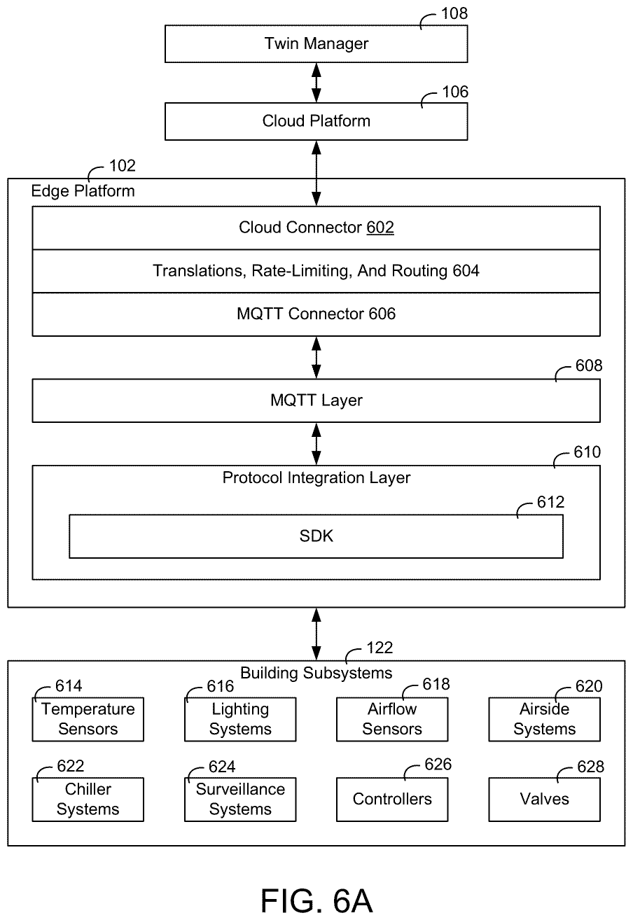

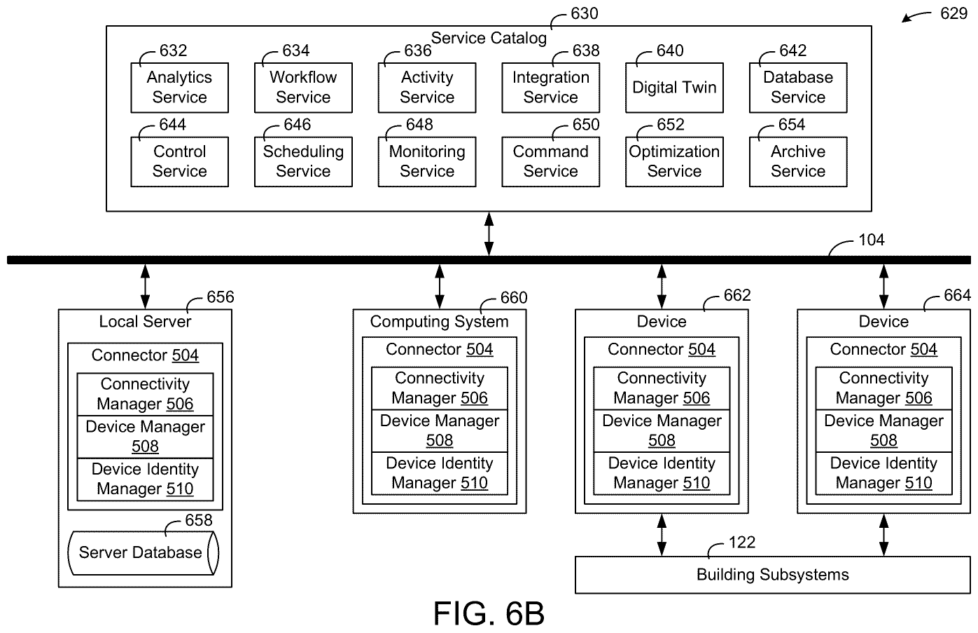

Referring now to FIG. 6A, another block diagram of the edge platform 102 is shown in greater detail to include communication layers for facilitating communication between building subsystems 122 and the cloud platform 106 and/or the twin manager of FIG. 1, according to an exemplary embodiment. The building subsystems 122 may include devices of various different building subsystems, e.g., HVAC subsystems, fire response subsystems, access control subsystems, surveillance subsystems, etc. The devices may include temperature sensors 614, lighting systems 616, airflow sensors 618, airside systems 620, chiller systems 622, surveillance systems 624, controllers 626, valves 628, etc.

The edge platform 102 can include a protocol integration layer 610 that facilities communication with the building subsystems 122 via one or more protocols. In some embodiments, the protocol integration layer 610 can be dynamically updated with a new protocol integration responsive to detecting that a new device is connected to the edge platform 102 and the new device requires the new protocol integration. In some embodiments, the protocol integration layer 610 can be customized through an SDK 612.

In some embodiments, the edge platform 102 can handle MQTT communication through an MQTT layer 608 and an MQTT connector 606. In some embodiments, the MQTT layer 608 and/or the MQTT connector 606 handles MQTT based communication and/or any other publication/subscription based communication where devices can subscribe to topics and publish to topics. In some embodiments, the MQTT connector 606 implements an MQTT broker configured to manage topics and facilitate publications to topics, subscriptions to topics, etc. to support communication between the building subsystems 122 and/or with the cloud platform 106. An example of devices of a building communicating via a publication/subscription method is shown in FIG. 11.

The edge platform 102 includes a translations, rate-limiting, and routing layer 604. The layer 604 can handle translating data from one format to another format, e.g., from a first format used by the building subsystems 122 to a format that the cloud platform 106 expects, or vice versa. The layer 604 can further perform rate limiting to control the rate at which data is transmitted, requests are sent, requests are received, etc. The layer 604 can further perform message routing, in some embodiments. The cloud connector 602 may connect the edge platform 102, e.g., establish and/or communicate with one or more communication endpoints between the cloud platform 106 and the cloud connector 602.

Referring now to FIG. 6B, a system 629 where the edge platform 102 is shown distributed across building devices of a building, according to an exemplary embodiment. The local server 656, the computing system 660, the device 662, and/or the device 664 may all be located on-premises within a building, in some embodiments. The various devices 662 and/or 664 may, in some embodiments, be gateway boxes, e.g., gateways 112-116. The gateway boxes may be the various gateways described in U.S. patent application Ser. No. 17/127,303 filed Dec. 18, 2020, the entirety of which is incorporated by reference herein. The computing system 660 could be a desktop computer, a server system, a microcomputer, a mini personal computer (PC), a laptop computer, a dedicated computing resource in a building, etc. The local server 656 may be an on-premises computer system that provides resources, data, services or other programs to computing devices of the building. The system 629 includes a local server 656 that can include a server database 658 that stores data of the building, in some embodiments.

In some embodiments, the device 662 and/or the device 664 implement gateway operations for connecting the devices of the building subsystems 122 with the cloud platform 106 and/or the twin manager 108. In some embodiments, the devices 662 and/or 664 can communicate with the building subsystems 122, collect data from the building subsystems 122, and communicate the data to the cloud platform 106 and/or the twin manager 108. In some embodiments, the devices 662 and/or the device 664 can push commands from the cloud platform 106 and/or the twin manager 108 to the building subsystem 122.

The systems and devices 656-664 can each run an instance of the edge platform 102. In some embodiments, the systems and devices 656-664 run the connector 504 which may include, in some embodiments, the connectivity manager 506, the device manager 508, and/or the device identity manager 510. In some embodiments, the device manager 508 controls what services each of the systems and devices 656-664 run, e.g., what services from a service catalog 630 each of the systems and devices 656-664 run.

The service catalog 630 can be stored in the cloud platform 106, within a local server (e.g., in the server database 658 of the local server 656), on the computing system 660, on the device 662, on the device 664, etc. The various services of the service catalog 630 can be run on the systems and devices 656-664, in some embodiments. The services can further move around the systems and devices 656-664 based on the available computing resources, processing speeds, data availability, the locations of other services which produce data or perform operations required by the service, etc.

The service catalog 630 can include an analytics service 632 that generates analytics data based on building data of the building subsystems 122, a workflow service 634 that implements a workflow, and/or an activity service 636 that performs an activity. The service catalog 630 includes an integration service 638 that integrates a device with a particular subsystem (e.g., a BACnet integration, a Modbus integration, etc.), a digital twin service 640 that runs a digital twin, and/or a database service 642 that implements a database for storing building data. The service catalog 630 can include a control service 644 for operating the building subsystems 122, a scheduling service 646 that handles scheduling of areas (e.g., desks, conference rooms, etc.) of a building, and/or a monitoring service 648 that monitors a piece of equipment of the building subsystem 122. The service catalog 630 includes a command service 650 that implements operational commands for the building subsystems 122, an optimization service 652 that runs an optimization to identify operational parameters for the building subsystems 122, and/or achieve service 654 that archives settings, configurations, etc. for the building subsystem 122, etc.

In some embodiments, the various systems 656, 660, 662, and 664 can realize technical advantages by implementing services of the service catalog 630 locally and/or storing the service catalog 630 locally. Because the services can be implemented locally, i.e., within a building, lower latency can be realized in making control decisions or deriving information since the communication time between the systems 656, 660, 662, and 664 and the cloud is not needed to run the services. Furthermore, because the systems 656, 660, 662, and 664 can run independently of the cloud (e.g., implement their services independently) even if the network 104 fails or encounters an error that prevents communication between the cloud and the systems 656, 660, 662, and 664, the systems can continue operation without interruption. Furthermore, by balancing computation between the cloud and the systems 656, 660, 662, and 664, power usage can be balanced more effectively. Furthermore, the system 629 has the ability to scale (e.g., grow or shrink) the functionality/services provided on edge devices based on capabilities of edge hardware onto which edge system is being implemented.

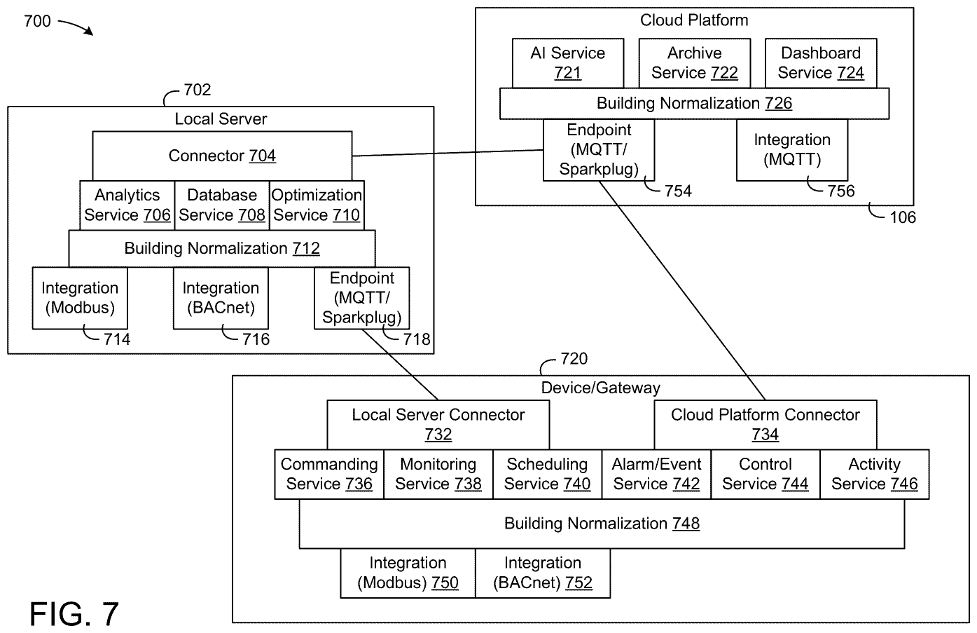

Referring now to FIG. 7, a system 700 where connectors, building normalization layers, services, and integrations are distributed across various computing devices of a building is shown, according to an exemplary embodiment. In the system 700, the cloud platform 106, a local server 702, and a device/gateway 720 run components of the edge platform 102, e.g., connectors, building normalization layers, services, and integrations. The local server 702 can be a server system located within a building. The device/gateway 720 could be a building device located within the building, in some embodiments. For example, the device/gateway 720 could be a smart thermostat, a surveillance camera, an access control system, etc. In some embodiments, the device gateway 720 is a dedicated gateway box. The building device may be a physical building device, and may include a memory device (e.g., a flash memory, a RAM, a ROM, etc.). The memory of the physical building device can store one or more data samples, which may be any data related to the operation of the physical building device. For example, if the building device is a smart thermostat, the data samples can be timestamped temperature readings. If the building device is a surveillance camera, the data samples may be

The local server 702 can include a connector 704, services 706-710, a building normalization layer 712, and integrations 714-718. These components of the local server 702 can be deployed to the local server 702, e.g., from the cloud platform 106. These components may further be dynamically moved to various other devices of the building, in some embodiments. The connector 704 may be the connector described with reference to FIG. 5 that includes the connectivity manager 506, the device manager 508, and/or the device identity manager 510. The connector 704 may connect the local server 702 with the cloud platform 106, in some embodiments. For example, the connector 704 may enable communication with an endpoint of the cloud platform 106, e.g., the endpoint 754 which could be an MQTT endpoint or a Sparkplug endpoint.

The building normalization layer 712 can be a software component that runs the integrations 714-718 and/or the analytics 706-710. The building normalization layer 712 can be configured to allow for a variety of different integrations and/or analytics to be deployed to the local server 702. In some embodiments, the building normalization layer 712 could allow for any service of the service catalog 630 to run on the local server 702. Furthermore, the building normalization layer 712 can relocate, or allow for relocation, of services and/or integrations across the cloud platform 106, the local server 702, and/or the device/gateway 720. In some embodiments, the services 706-710 are relocatable based on processing power of the local server 702, based on communication bandwidth, available data, etc. The services can be moved from one device to another in the system 700 such that the requirements for the service are met appropriately.

Furthermore, instances of the integrations 714-718 can be relocatable and/or deployable. The integrations 714-718 may be instantiated on devices of the system 700 based on the requirements of the devices, e.g., whether the local server 702 needs to communicate with a particular device (e.g., the Modbus integration 714 could be deployed to the local server 702 responsive to a detection that the local server 702 needs to communicate with a Modbus device). The locations of the integrations can be limited by the physical protocols that each device is capable of implementing and/or security limitations of each device.

In some embodiments, the deployment and/or movement of services and/or integrations can be done manually and/or in an automated manner. For example, when a building site is commissioned, a user could manually select, e.g., via a user interface on the user device 176, the devices of the system 700 where each service and/or integration should run. In some embodiments, instead of having a user select the locations, a system, e.g., the cloud platform 106, could deploy services and/or integrations to the devices of the system 700 automatically based on the ideal locations for each of multiple different services and/or integrations.

In some embodiments, an orchestrator (e.g., run on instances of the building normalization layer 712 or in the cloud platform 106) or a service and/or integration itself could determine that a particular service and/or integration should move from one device to another device after deployment. In some embodiments, as the devices of the system 700 change, e.g., more or less services are run, hard drives are filled with data, physical building devices are moved, installed, and/or uninstalled, the available data, bandwidth, computing resources, and/or memory resources may change. The services and/or integrations can be moved from a first device to a second more appropriate device responsive to a detection that the first device is not meeting the requirements of the service and/or integration.

As an example, an energy efficiency model service could be deployed to the system 700. For example, a user may request that an energy efficiency model service run in their building. Alternatively, a system may identify that an energy efficiency model service would improve the performance of the building and automatically deploy the service. The energy efficiency model service may have requirements. For example, the energy efficiency model may have a high data throughput requirement, a requirement for access to weather data, a high requirement for data storage to store historical data needed to make inferences, etc. In some embodiments, a rules engine with rules could define whether services get pushed around to other devices, whether model goes back to the cloud for more training, whether an upgrade is needed to implement an increase in points, etc.

As another example, a historian service may manage a log of historical building data collected for a building, e.g., store a record of historical temperature measurements of a building, store a record of building occupant counts, store a record of operational control decisions (e.g., setpoints, static pressure setpoints, fan speeds, etc.), etc. One or more other services may depend on the historian, for example, the one or more other services may consume historical data recorded by the historian. In some embodiments, other services can be relocated along with the historian service such that the other services can operate on the historian data. For example, an occupancy prediction service may need a historical log of occupancy record by the historian service to run. In some embodiments, instead of having the occupancy prediction service and the historian run on the same physical device, a particular integrations between the two devices that the historian service and the occupancy prediction service run on could be established such that occupancy data of the historian service can be provided from the historian service to the occupancy prediction service.

This portability of services and/or integrations removes dependencies between hardware and software. Allowing services and/or integrations to move from one device to another device can keep services running continuously even if the run on a variety of locations. This decouples software from hardware.

In some embodiments, the building normalization layer 712 can facilitate auto discovery of devices and/or perform auto configuration. In some embodiments, the building normalization 726 of the cloud platform 106 performs the auto discovery. In some embodiments, responsive to detecting a new device connected to the local server 702, e.g., a new device of the building subsystems 122, the building normalization can identify points of the new device, e.g., identify measurement points, control points, etc. In some embodiments, the building normalization layer 712 performs a discovery process where strings, tags, or other metadata is analyzed to identify each point. In some embodiments, a discover process as discussed in U.S. patent application Ser. No. 16/885,959 filed May 28, 2020, U.S. patent application Ser. No. 16/885,968 filed May 28, 2020, U.S. patent application Ser. No. 16/722,439 filed Dec. 20, 2019 (now U.S. Pat. No. 10,831,163), and U.S. patent application Ser. No. 16/663,623 filed Oct. 25, 2019, which are incorporated by reference herein in their entireties.

In some embodiments, the cloud platform 106 performs a site survey of all devices of a site or multiple sites. For example, the cloud platform 106 could identify all devices installed in the system 700. Furthermore, the cloud platform 106 could perform discovery for any devices that are not recognized. The result of the discovery of a device could be a configuration for the device, for example, indications of points to collect data from and/or send commands to. The cloud platform 106 can, in some embodiments, distribute a copy of the configuration for the device to all of the instances of the building normalization layer 712. In some embodiments, the copy of the configuration can be distributed to other buildings different from the building that the device was discovered at. In this regard, responsive to a similar device type being installed somewhere else, e.g., in the same building, in a different building, at a different campus, etc. the instance of the building normalization can select the copy of the device configuration and implement the device configuration for the device.

Similarly, if the instance of the building normalization detects a new device that is not recognized, the building normalization could perform a discovery process for the new device and distribute the configuration for the new device to other instances of the building normalization. In this regard, each building normalization instance can implement learning by discovering new devices and injecting device configurations into a device catalog stored and distributed across each building normalization instance.

In some embodiments, the device catalog can store names of every data point of every device. In some embodiments, the services that operate on the data points can consume the data points based on the indications of the data points in the device catalog. Furthermore, the integrations may collect data from data points and/or send actions to the data points based on the naming of the device catalog. In some embodiments, the various building normalization and synchronize the device catalogs they store. For example, changes to one device catalog can be distributed to other building normalizations. If a point name was changed for a device, this change could be distributed across all building normalizations through the device catalog synchronization such that there are no disruptions to the services that consume the point.

The analytics service 706 may be a service that generates one or more analytics based on building data received from a building device, e.g., directly from the building device or through a gateway that communicates with the building device, e.g., from the device/gateway 720. The analytics service 706 can be configured to generate an analytics data based on the building data such as a carbon emissions metric, an energy consumption metric, a comfort score, a health score, etc. The database service 708 can operate to store building data, e.g., building data collected from the device/gateway 720. In some embodiments, the analytics service 706 may operate against historical data stored in the database service 708. In some embodiments, the analytics service 706 may have a requirement that the analytics service 706 is implemented with access to a database service 706 that stores historical data. In this regard, the analytics service 706 can be deployed to, or relocated to a device including an instantiation of the database service 708. In some embodiments, the database service 708 could be deployed to the local server 702 responsive to determining that the analytics service 706 requires the database service 708 to run.

The optimization service 710 can be a service that operates to implement an optimization of one or more variables based on one or more constraints. The optimization service 710 could, in some embodiments, implement optimization for allocating loads, making control decisions, improving energy usage and/or occupant comfort etc. The optimization performed by the optimization service 710 could be the optimization described in U.S. Patent Application Ser. No. 17/542,184 filed Dec. 3, 2021, which is incorporated by reference herein.

The Modbus integration 714 can be a software component that enables the local server 702 to collect building data for data points of building devices that operate with a Modbus protocol. Furthermore, the Modbus integration 714 can enable the local server 702 to communicate data, e.g., operating parameters, setpoints, load allocations, etc. to the building device. The communicated data may, in some embodiments, be control decisions determined by the optimization service 710.

Similarly, the BACnet integration 716 can enable the local server 702 to communicate with one or more BACnet based devices, e.g., send data to, or receive data from, the BACnet based devices. The endpoint 718 could be an endpoint for MQTT and/or Sparkplug. In some embodiments, the element 718 can be a software service including an endpoint and/or a layer for implementing MQTT and/or Sparkplug communication. In the system 700, the endpoint 718 can be used for communicating by the local server 702 with the device/gateway 720, in some embodiments.

The cloud platform 106 can include an artificial intelligence (AI) service 721, an archive service 722, and/or a dashboard service 724. The AI service 721 can run one or more artificial intelligence operations, e.g., inferring information, performing autonomous control of the building, etc. The archive service 722 may archive building data received from the device/gateway 720 (e.g., collected point data). The archive service 722 may, in some embodiments, store control decisions made by another service, e.g., the AI service 721, the optimization service 710, etc. The dashboard service 724 can be configured to provide a user interface to a user with analytic results, e.g., generated by the analytics service 706, command interfaces, etc. The cloud platform 106 is further shown to include the building normalization 726, which may be an instance of the building normalization layer 712.

The cloud platform 106 further includes an endpoint 754 for communicating with the local server 702 and/or the device/gateway 720. The cloud platform 106 may include an integration 756, e.g., an MQTT integration supporting MQTT based communication with MQTT devices.

The device/gateway 720 can include a local server connector 732 and a cloud platform connector 734. The cloud platform connector 734 can connect the device/gateway 720 with the cloud platform 106. The local server connector 732 can connect the device/gateway 720 with the local server 702. The device/gateway 720 includes a commanding service 736 configured to implement commands for devices of the building subsystems 122 (e.g., the device/gateway 720 itself or another device connected to the device/gateway 720). The monitoring service 738 can be configured to monitor operation of the devices of the building subsystems 122, the scheduling service 740 can implement scheduling for a space or asset, the alarm/event service 742 can generate alarms and/or events when specific rules are tripped based on the device data, the control service 744 can implement a control algorithm and/or application for the devices of the building subsystems 122, and/or the activity service 746 can implement a particular activity for the devices of the building subsystems 122.

The device/gateway 720 further includes a building normalization 748. The building normalization 748 may be an instance of the building normalization layer 712, in some embodiments. The device/gateway 720 may further include integrations 750-752. The integration 750 may be a Modbus integration for communicating with a Modbus device. The integration 752 may be a BACnet integration for communicating with BACnet devices.

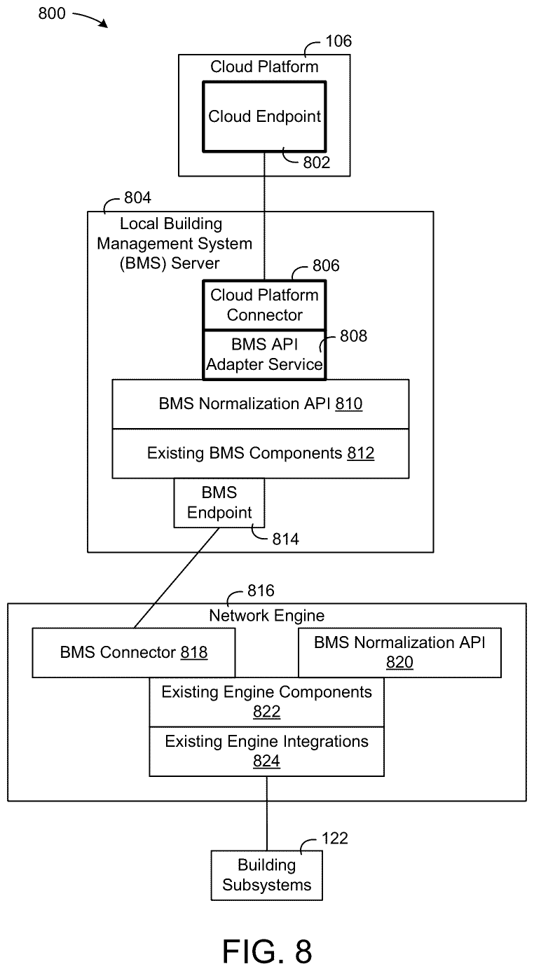

Referring now to FIG. 8, system 800 including a local building management system (BMS) server 804 including a cloud platform connector 806 and a BMS API adapter service 808 that operate to connect a network engine 816 with the cloud platform 106 is shown, according to an exemplary embodiment. The components 802, 806, and 808 may be components of the edge platform 102, in some embodiments. In some embodiments, the cloud platform connector 806 is the same as, or similar to, the connector 504, e.g., includes the connectivity manager 506, the device manager 508, and/or the device identity manager 510.

The local BMS server 804 may be a server that implements building applications and/or data collection. The building applications can be the various services discussed herein, e.g., the services of the service catalog 630. In some embodiments, the BMS server 804 can include data storage for storing historical data. In some embodiments, the local BMS server 804 can be the local server 656 and/or the local server 702. In some embodiments, the local BMS server 804 can implement user interfaces for viewing on a user device 176. The local BMS server 804 includes a BMS normalization API 810 for allowing external systems to communicate with the local BMS server 804. Furthermore, the local BMS server 804 includes BMS components 812. These components may implement the user interfaces, applications, data storage and/or logging, etc. Furthermore, the local BMS server 804 includes a BMS endpoint 814 for communicating with the network engine 816. The BMS endpoint 814 may also connect to other devices, for example, via a local or external network. The BMS endpoint 814 can connect to any type of device capable of communicating with the local BMS server 804.

The system 800 includes a network engine 816. The network engine 816 can be configured to handle network operations for networks of the building. For example, the engine integrations 824 of the network engine 816 can be configured to facilitate communication via BACnet, Modbus, CAN, N2, and/or any other protocol. In some embodiments, the network communication is non-IP based communication. In some embodiments, the network communication is IP based communication, e.g., Internet enabled smart devices, BACnet/IP, etc. In some embodiments, the network engine 816 can communicate data collected from the building subsystems 122 and pass the data to the local BMS server 804.

In some embodiments, the network engine 816 includes existing engine components 822. The engine components 822 can be configured to implement network features for managing the various building networks that the building subsystems 122 communicate with. The network engine 816 may further include a BMS normalization API 820 that implements integration with other external systems. The network engine 816 further includes a BMS connector 818 that facilitates a connection between the network engine 816 and a BMS endpoint 814. In some embodiments, the BMS connector 818 collects point data received from the building subsystems 122 via the engine integrations 824 and communicates the collected points to the BMS endpoint 814.

In the system 800, the local BMS server 804 can be adapted to facilitate communication between the local BMS server 804, the network engine 816, and/or the building subsystems 122 with the cloud platform 106. In some embodiments, the adaption can be implemented by deploying an endpoint 802 to the cloud platform 106. The endpoint 802 can be any suitable type of cloud endpoint, and may include or implement any type of cloud API or access mechanism. The endpoint 802 can include an MQTT and/or Sparkplug endpoint, in some embodiments. Furthermore, a cloud platform connector 806 could be deployed to the local BMS server 804. The cloud platform connector 806 could facilitate communication between the local BMS server 804 and the cloud platform 106. Furthermore, a BMS API adapter service 808 can be deployed to the local BMS server 804 to implement an integration between the cloud platform connector 806 and the BMS normalization API 810. The BMS API adapter service 808 can form a bridge between the existing BMS components 812 and the cloud platform connector 806.

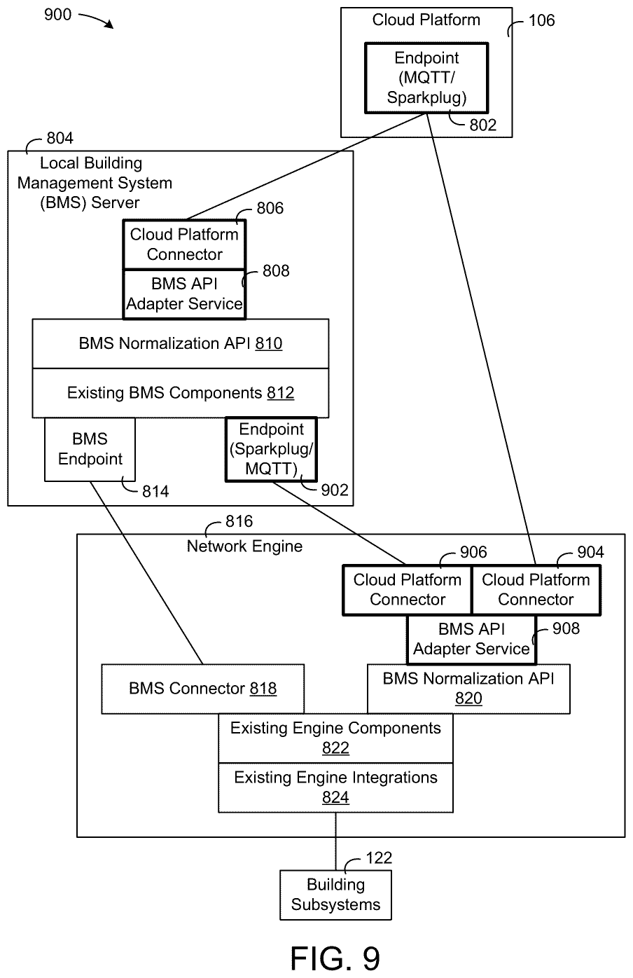

Referring now to FIG. 9, a system 900 including the local BMS server 804, the network engine 816, and the cloud platform 106 is shown where the network engine 816 includes connectors and an adapter service that connect the engine with the local BMS server 804 and the cloud platform 106, according to an exemplary embodiment. In the system 900, the network engine 816 can be adapted to facilitate communication directly between the network engine 816 and the cloud platform 106.

In the system 900, reusable cloud connector components and/or a reusable adapter service are deployed to the network engine 816 to enable the network engine 816 to communicate directly with the cloud platform 106 endpoint 802. In this regard, components of the edge platform 102 can be deployed to the network engine 816 itself allowing for plug and play on the engine such that gateway functions can be run on the network engine 816 itself.

In the system 900, a cloud platform connector 906 and a cloud platform connector 904 can be deployed to the network engine 816. The cloud platform connector 906 and/or the cloud platform connector 904 can be instances of the cloud platform 806. Furthermore, an endpoint 902 can be deployed to the local BMS server 804. The endpoint 902 can be a sparkplug and/or MQTT endpoint. The cloud platform connector 906 can be configured to facilitate communication between the network engine 816 and the endpoint 902. In some embodiments, point data can be communicated between the building subsystems 122 and the endpoint 902. Furthermore, the cloud platform connector 904 can configured to facilitate communication between the endpoint 802 and the network engine 816, in some embodiments. A BMS API adapter service 908 can integrate the cloud platform connector 906 and/or the cloud platform connector 904 with the BMS normalization API 820.

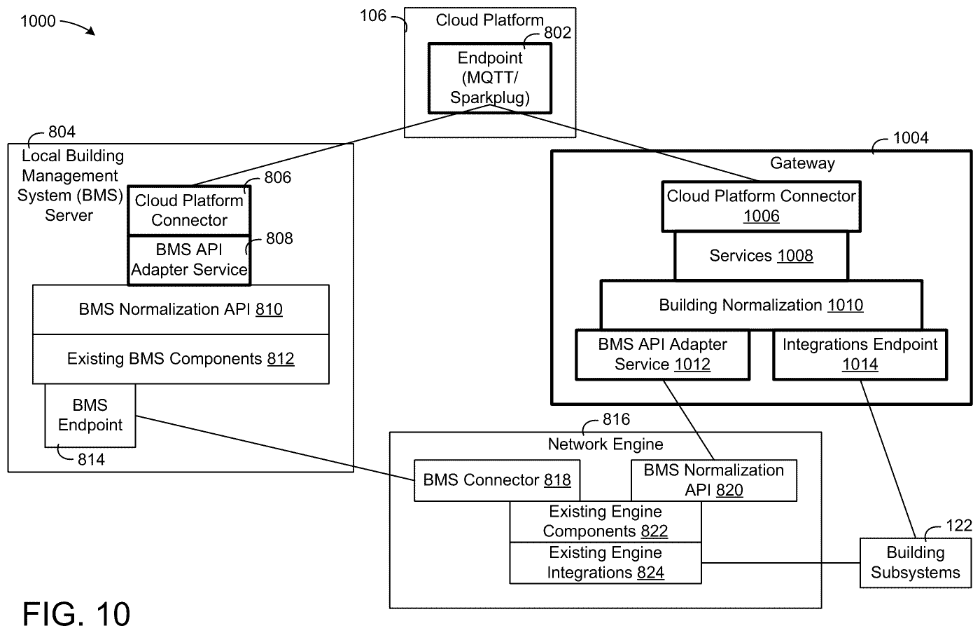

Referring now to FIG. 10, a system 1000 including a gateway 1004 including a BMS adapter service application programming interface (API) connecting the network engine 816 to the cloud platform 106 is shown, according to an exemplary embodiment. In the system 1000, the gateway 1004 can facilitate communication between the cloud platform 106 and the network engine 816, in some embodiments. The gateway 1004 can be a physical computing system and/or device, e.g., one of the gateways 112-116. The gateway 1004 can be the instance of the edge platform 102 described in FIG. 5 and/or FIG. 6A.

In some embodiments, the gateway 1004 can be deployed on a computing node of a building that the gateway software, e.g., the components 1006-1014. In some embodiments, the gateway 1004 can be installed in a building as a new physical device. In some embodiments, gateway devices can be built on computing nodes of a network to communicate with legacy devices, e.g., the network engine 816 and/or the building subsystems 122. In some embodiments, the gateway 1004 can be deployed to a computing system to enable the network engine 816 to communicate with the cloud platform 106. In some embodiments, the gateway 1004 is a new physical device and/or is a modified existing gateway. In some embodiments, the cloud platform 106 can identify what physical devices are near and/or are connected to the network engine 816. The cloud platform 106 can deploy the gateway 1004 to the identified physical device. Some pieces of the software stack of the gateway may be legacy.

The gateway 1004 can include a cloud platform connector 1006 configured to facilitate communication between the endpoint 802 of the cloud platform 106 and/or the gateway 1004. The cloud platform connector 1006 can be an instance of the cloud platform 806 and/or the connector 504. The gateway 1004 can further include services 1008. The services 1008 can be the services described with reference to FIGS. 6B and/or 7. The gateway 1004 further includes a building normalization 1010. The building normalization 1010 can be the same as or similar to the building normalizations layers 712, 728, and/or 748 described with reference to FIG. 7. The gateway 1004 further includes a BMS API adapter service 1012 that can be configured to facilitate communication with the BMS normalization API 820. The BMS API adapter service 1012 can be the same as and/or similar to the BMS API adapter service 808 and/or the BMS API adapter service 908. The gateway 1004 may further include integrations endpoint 1014 which may facilitate communication directly with the building subsystems 122.

In some embodiments, the gateway 1004, via the cloud platform connector 1006 and/or the BMS API adapter service 1012 can facilitate direct communication between the network engine 816 and the cloud platform 106. For example, data collected from the building subsystems 122 can be collected via the engine integrations 824 and communicated to the gateway 1004 via the BMS normalization API 820 and the BMS API adapter service 1012. The cloud platform connector 1006 can communicate the collected data points to the endpoint 802 of the cloud platform 106. The BMS API adapter service 1012 and the BMS API adapter service 808 can be common adapters which can make calls and/or responses to the BMS normalization API 810 and/or the BMS normalization API 820.

The gateway 1004 can allow for the addition of services (e.g., the services 1008) and/or integrations (e.g., integrations endpoint 1014) to the system 1000 that may not be deployable to the local BMS server 804 and/or the network engine 816. In FIG. 10, the network engine 816 is not adapted but is brought into the ecosystem of the system 1000 through the gateway 1004, in comparison to the deployed connectivity to the local BMS server 804 in FIG. 8 and the deployed connectivity to the network engine 816 of FIG. 9.

Referring now to FIG. 11, a system 1100 including a surveillance camera 1106 and a smart thermostat 1108 for a zone 1102 of the building that uses the edge platform 102 to facilitate event based control is shown, according to an exemplary embodiment. In the system 1100, the surveillance camera 1106 and/or the smart thermostat 1108 can run gateway components of the edge platform 102. For example, the surveillance camera 1106 and/or the smart thermostat 1108 could include the connector 504. In some embodiments, the surveillance camera 1106 and/or the smart thermostat 1108 can include an endpoint, e.g., an MQTT endpoint such as the endpoints described in FIGS. 7-10.

In some embodiments, the surveillance camera 1106 and/or the smart thermostat 1108 are themselves gateways. The gateways may be built in a portable language such as RUST and embedded within the surveillance camera 1106 and/or the smart thermostat 1108. In some embodiments, one or both of the surveillance camera 1106 and/or the smart thermostat 1108 can implement a building device broker 1105. In some embodiments, the building device broker 1105 can be implemented on a separate building gateway, e.g., the device/gateway 720 and/or the gateway 1004.

In some embodiments, the surveillance camera 1106 can perform motion detection, e.g., detect the presence of the user 1104. In some embodiments, responsive to detecting the user 1104, the surveillance camera 1106 can generate an occupancy trigger event. The occupancy trigger event can be published to a topic by the surveillance camera 1106. The building device broker 1105 can, in some embodiments, handle various topics, handle topic subscriptions, topic publishing, etc. In some embodiments, the smart thermostat 1108 may be subscribed to an occupancy topic for the zone 1102 that the surveillance camera 1106 publishes occupancy trigger events to. The smart thermostat 1108 may, in some embodiments, adjust a temperature setpoint responsive to receiving an occupancy trigger event being published to the topic.

In some embodiments, an IoT platform and/or other application is subscribed to the topic that the surveillance camera 1106 subscribes to and commands the smart thermostat 1108 to adjust its temperature setpoint responsive to detecting the occupancy trigger event. In some embodiments the events, topics, publishing, and/or subscriptions are MQTT based messages. In some embodiments, the event communicated by the surveillance camera 1106 is an Open Network Video Interface Forum (ONVIF) event.

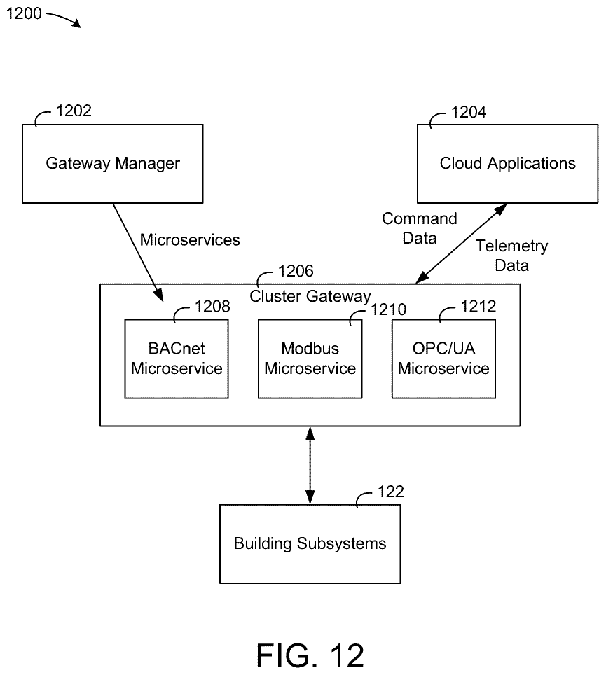

Referring now to FIG. 12, a system 1200 including a cluster based gateway 1206 that runs micro-services for facilitating communication between building subsystems 122 and cloud applications 1204 is shown, according to an exemplary embodiment. In some embodiments, to collect telemetry data from building subsystems 122 (e.g., BMS systems, fire systems, security systems, etc.), the system 1200 includes a gateway which collects data from the building subsystems 122 and communicates the information to the cloud, e.g., to the cloud applications 1204, the cloud platform 106, etc.

In some embodiments, such a gateway could include a mini personal computer (PC) with various software connectors that connect the gateway to the building subsystems 122, e.g., a BACnet connector, an OPC/UA connector, a Modbus connector, a Transmission Control Protocol and Internet Protocol TCP/IP connector, and/or various other protocols. In some embodiments, the mini PC runs an operating system that hosts various micro-services for the communication.

In some embodiments, hosting a mini PC in a building has issues. For example, the operating system on the mini PC may need to be updated for security patches and/or operating system updates. This might result in impacting the micro-services which the mini PC runs. Micro-services may stop, may be deleted, and/or may have to updated to manage the changes in operating system. Furthermore, the mini PC may need to be managed by a local building information technologies (IT) team. The mini PC may be impacted by the building network and/or IT policies on the network. The mini PC may need to be commissioned by a technician visit to a local site. Similarly, a site visit by the technician may be required for trouble shooting any time that the mini PC encounters issues. For an increase in demand for the services of the mini PC, a technician may need to visit the site to make physical and/or software updates to the mini PC, which may incur additional cost for field testing and/or certifying new hardware and/or software.

To solve one or more of these issues, the system 1200 could include a cluster gateway 1206. The cluster gateway 1206 cold be a cluster including one or more micro-services in containers. For example, the cluster gateway 1206 could be a Kubernetes cluster with Docker instances of micro-services. For example, the cluster gateway 1206 could run a BACnet micro-serve 1208, a Modbus micro-service 1210, and/or an OPC/U micro-service 1212. The cluster gateway 1206 can replace the mini PC with a more generic hardware device with the capability to host one or more different and/or changing containers.

In some embodiments, software updates to the cluster gateway 1206 can be managed centrally by a gateway manager 1202. The gateway manager 1202 could push new micro-services, e.g., a BACnet micro-service, a Modbus micro-service 1210, and/or a OPC/UA micro-service to the cluster gateway 1206. In this manner, software upgrades are not dependent on an IT infrastructure at a building. A building owner may manage the underlying hardware that the cluster gateway 1206 runs on while the cluster gateway 1206 may be managed by a separate development entity. In some embodiments, commissioning for the cluster gateway 1206 is managed remotely. Furthermore, the workload for the cluster gateway 1206 can be managed, in some embodiments. In some embodiments, the cluster gateway 1206 runs independent of the hardware on which it is hosted, and thus any underlying hardware upgrades do not require testing for software tools and/or software stack of the cluster gateway 1206.

The gateway manager 1202 can be configured to install and/or upgrade the cluster gateway 1206. The gateway manager 1202 can make upgrades to the micro-services that the cluster gateway 1206 runs and/or make upgrades to the operating environment of the cluster gateway 1206. In some embodiments, upgrades, security patches, new software, etc. can be pushed by the gateway manager 1202 to the cluster gateway 1206 in an automated manner. In some embodiments, errors and/or issues of the cluster gateway 1206 can be managed remotely and users can receive notifications regarding the errors and/or issues. In some embodiments, commissioning for the cluster gateway 1206 can be automated and the cluster gateway 1206 can be set up to run on a variety of different hardware environments.

In some embodiments, the cluster gateway 1206 can provide telemetry data of the building subsystems 122 to the cloud applications 1204. Furthermore, the cloud applications 1204 can provide command and control data to the cluster gateway 1206 for controlling the building subsystems 122. In some embodiments, command and/or control operations can be handled by the cluster gateway 1206. This may provide the ability to manage the demand and/or bandwidth requirements of the site by commanding the various containers including the micro-services on the cluster gateway 1206. This may allow for the management of upgrades and/or testing. Furthermore, this may allow for the replication of development, testing, and/or production environments. The cloud applications 1204 could be energy management applications, optimization applications, etc. In some embodiments, the cloud applications 1204 are the applications 110. In some embodiments, the cloud applications 1204 are the cloud platform 106.

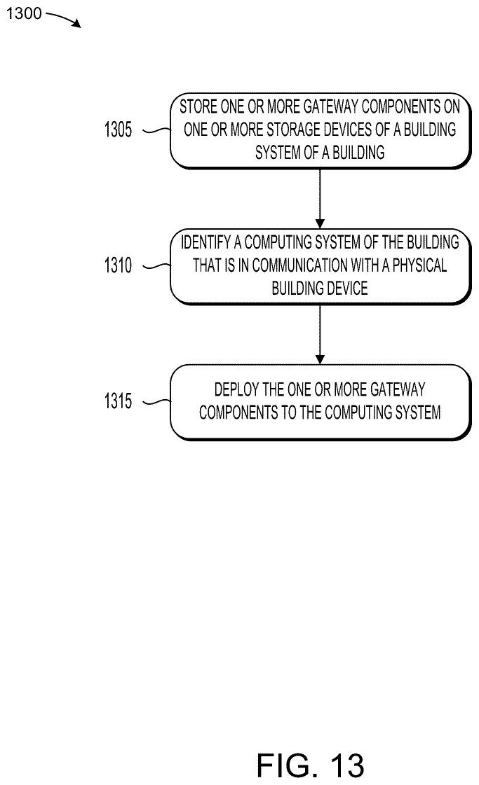

Referring to FIG. 13, illustrated is a flow diagram of an example method 1300 for deploying gateway components on one or more computing systems of a building, according to an exemplary embodiment. In various embodiments, the local server 702 performs the method 1300. However, it should be understood that any computing system described herein may perform any or all of the operations described in connection with the method 1300. For example, in some embodiments, the cloud platform 106 performs method 1300. In yet other embodiments, the local server 702 may perform the method 1300. For example, the cloud platform 106 may perform method 1300 to deploy gateway components on one or more computing devices (e.g., the local server 702, the device/gateway 720, the local BMS server 804, the network engine 816, the gateway 1004, the gateway manager 1202, the cluster gateway 1206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 1300 is referred to herein as the “building system.”

At step 1305, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 106) and facilitate communication with a physical building device (e.g., the device/gateway 720, the building subsystems 122, etc.). The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12.

At step 1310, the building system can identify a computing system of the building that is in communication with the physical building device, the physical building device storing one or more data samples. Identifying the computing system can include accessing a database or lookup table of computing systems or devices that are present within or otherwise associated with managing one or more aspects of the building. In some implementations, the building system can query a network of the building to which the building system is communicatively coupled, to identify one or more other computing systems on the network. The computing systems may be associated with respective identifiers, and may communicate with the building system via the network or another suitable communications interface, connector, or integration, as described herein. The computing system may be in communication with one or more physical building devices, as described herein. In some implementations, the building system can identify each of the computing systems of the building that are in communication with at least one physical building device.

At step 1315, the building system can deploy the one or more gateway components to the identified computing system responsive to identifying that the computing system is in communication with the physical building device(s). For example, the building system can utilize one or more communication channels, which may be established via a network of the building, to transmit the gateway components to each of the identified computing systems of the building. Deploying the one or more gateway components can include installing or otherwise configuring the gateway components to execute at the one or more identified computing systems. Generally, the gateway components can be executed to perform any of the operations described herein. Deploying the gateway components can include forming storing computer-executable instructions corresponding to the gateway components at the identified computing systems. In some implementations, the particular gateway components deployed at an identified computing system can be selected based on the type of the physical building device to which the identified computing system is connected. Likewise, in some embodiments, the particular gateway components deployed at an identified computing system can be selected to correspond to an operation, type, or processing capability of the identified computing system, among other factors as described herein. Deploying the gateway components may include storing the gateway components in one or more predetermined memory regions at the computing system (e.g., in a particular directory, executable memory region, etc.), and may include installing, configuring, or otherwise applying one or more configuration settings for the gateway components or for the operation of the computing system.

As described herein, the one or more gateway components can include any type of software component, hardware configuration settings, or combinations thereof. The gateway components may include processor-executable instructions, which can be executed by the computing system to which the gateway component(s) are deployed. The one or more gateway components can cause the computing system to communicate with the physical building device to receive the one or more data samples (e.g., via one or more networks or communication interfaces). Additionally, the one or more gateway components cause the computing system to communicate the one or more data samples to the cloud platform. For example, the gateway components can include one or more adapters or communication software APIs that facilitate communication between computing devices within, and external to, the building. The gateway components may include adapters that cause the computing system to communicate with one or more network engines. The gateway components can include instructions that, when executed by the computing system, cause the computing system to detect a new physical building device connected to the computing system (e.g., by searching through different connected devices by device identifier, etc.), and then search a device library for a configuration of the new physical building device. Using the configuration for the new physical device, the gateway components can cause the computing system to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the computing system to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the computing system. The building system can query the computing system to determine the current operating characteristics (e.g., processing resources, storage resources, data availability, or a presence of another building service executing at the computing system, etc.), to determine that the computing system meets the one or more requirements for the gateway component(s). If the computing system meets the requirements, the building system can deploy the corresponding gateway components to the computing system. If the requirements are not met, the building system may deploy the gateway components to another computing system. The building system can periodically query, or otherwise receive messages from, the computing system that indicate the current operating characteristics of the computing system. In doing so, the building system can identify whether the requirements for the building service (or other gateway components) are no longer met by the computing system. If the requirements are no longer met, the building system can move (e.g., terminate execution of the gateway components or remove the gateway components from the computing system, and re-deploy the gateway components) the gateway components (e.g., the building service) from the computing system to a different computing system that meets the one or more requirements of the building service or gateway component(s).

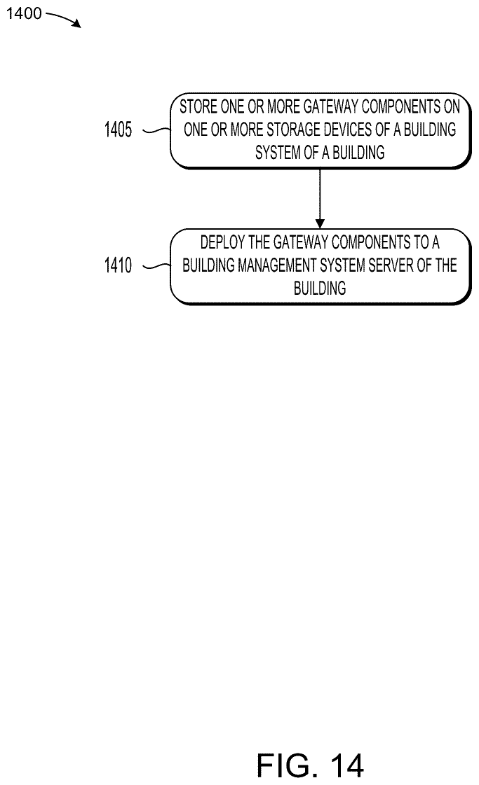

Referring to FIG. 14 is a flow diagram of an example method 1400 for deploying gateway components on a local BMS server, according to an exemplary embodiment. In various embodiments, the local server 702 performs the method 1400. However, it should be understood that any computing system described herein may perform any or all of the operations described in connection with the method 1400. For example, in some embodiments, the cloud platform 106 performs method 1400. In yet other embodiments, the local server 702 may perform the method 1400. For example, the cloud platform 106 may perform method 1400 to deploy gateway components on one or more computing devices (e.g., the local server 702, the device/gateway 720, the local BMS server 804, the network engine 816, the gateway 1004, the gateway manager 1202, the cluster gateway 1206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 1400 is referred to herein as the “building system.”

At step 1405, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 106) and facilitate communication with a physical building device (e.g., the device/gateway 720, the building subsystems 122, etc.). The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12.

At step 1410, the building system can deploy the one or more gateway components to a BMS server, which may be in communication with one or more building devices via one or more network engines, as shown in FIG. 8. The BMS server can execute one or more BMS applications on the data samples received (e.g., via one or more networks or communication interfaces) from the physical building devices. To deploy the gateway components, the building system can utilize one or more communication channels, which may be established via a network of the building, to transmit the gateway components to the BMS server of the building. Deploying the one or more gateway components can include installing or otherwise configuring the gateway components to execute at the BMS server. Generally, the gateway components can be executed to perform any of the operations described herein. Deploying the gateway components can include forming storing computer-executable instructions corresponding to the gateway components at the BMS server. In some implementations, the particular gateway components deployed at the BMS server can be selected based on the type of the physical building device(s) to which the BMS server is connected (e.g., via the network engine, etc.), or to other types of computing systems with which the BMS server is in communication. Likewise, in some embodiments, the particular gateway components deployed at the BMS server can be selected to correspond to an operation, type, or processing capability of the BMS server, among other factors as described herein. Deploying the gateway components may include storing the gateway components in one or more predetermined memory regions at the BMS server (e.g., in a particular directory, executable memory region, etc.), and may include installing, configuring, or otherwise applying one or more configuration settings for the gateway components or for the operation of the BMS server.

As described herein, the one or more gateway components can include any type of software component, hardware configuration settings, or combinations thereof. The gateway components may include processor-executable instructions, which can be executed by the BMS server to which the gateway component(s) are deployed. The one or more gateway components can cause the BMS server to communicate with the physical building device to receive the one or more data samples (e.g., via one or more networks or communication interfaces). Additionally, the one or more gateway components cause the BMS server to communicate the one or more data samples to the cloud platform. For example, the gateway components can include one or more adapters or communication software APIs that facilitate communication between computing devices within, and external to, the building. The gateway components may include adapters that cause the BMS server to communicate with one or more network engines. The gateway components can include instructions that, when executed by the BMS server, cause the BMS server to detect a new physical building device connected to the BMS server (e.g., by searching through different connected devices by device identifier, etc.), and then search a device library for a configuration of the new physical building device. Using the configuration for the new physical device, the gateway components can cause the BMS server to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the BMS server to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the BMS server. The building system can query the BMS server to determine the current operating characteristics (e.g., processing resources, storage resources, data availability, or a presence of another building service executing at the BMS server, etc.), to determine that the BMS server meets the one or more requirements for the gateway component(s). If the BMS server meets the requirements, the building system can deploy the corresponding gateway components to the BMS server. If the requirements are not met, the building system may deploy the gateway components to another BMS server. The building system can periodically query, or otherwise receive messages from, the BMS server that indicate the current operating characteristics of the BMS server. In doing so, the building system can identify whether the requirements for the building service (or other gateway components) are no longer met by the BMS server. If the requirements are no longer met, the building system can move (e.g., terminate execution of the gateway components or remove the gateway components from the BMS server, and re-deploy the gateway components) the gateway components (e.g., the building service) from the BMS server to a different computing system that meets the one or more requirements of the building service or gateway component(s). In some implementations, the building system can identify communication protocols corresponding to the physical building devices associated with the BMS server, and deploy one or more integration components (e.g., associated with the physical building devices) to the BMS server to communicate with the one or more physical building devices via the one or more communication protocols. The integration components can be part of the one or more gateway components.

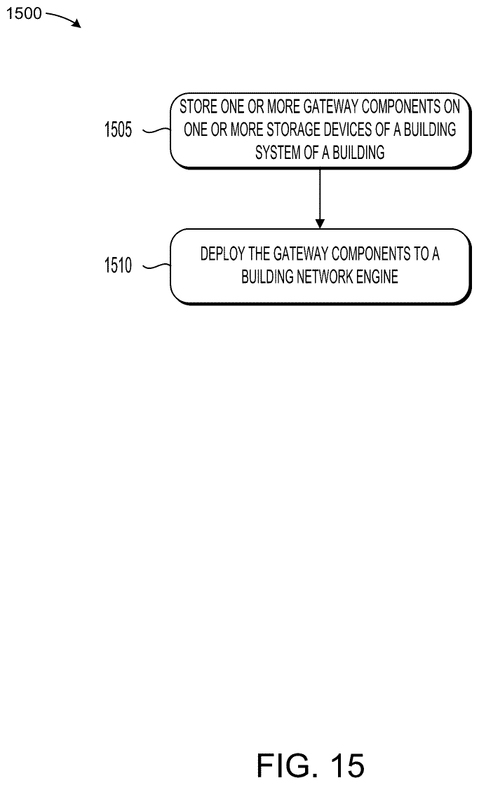

Referring to FIG. 15 is a flow diagram of an example method 1500 for deploying gateway components on a network engine, according to an exemplary embodiment. In various embodiments, the local server 702 performs the method 1500. However, it should be understood that any computing system described herein may perform any or all of the operations described in connection with the method 1500. For example, in some embodiments, the cloud platform 106 performs method 1500. In yet other embodiments, the local server 702 may perform the method 1500. For example, the cloud platform 106 may perform method 1500 to deploy gateway components on one or more computing devices (e.g., the local server 702, the device/gateway 720, the local BMS server 804, the network engine 816, the gateway 1004, the gateway manager 1202, the cluster gateway 1206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 1500 is referred to herein as the “building system.”

At step 1505, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 106) and facilitate communication with a physical building device (e.g., the device/gateway 720, the building subsystems 122, etc.). The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12.

At step 1510, the building system can deploy the one or more gateway components to a network engine, which may implement one or more local communications networks for one or more building devices of the building and receive one or more data samples from the one or more building devices, as described herein. To deploy the gateway components, the building system can utilize one or more communication channels, which may be established via a network of the building, to transmit the gateway components to the Network engine of the building. Deploying the one or more gateway components can include installing or otherwise configuring the gateway components to execute at the network engine. Generally, the gateway components can be executed to perform any of the operations described herein. Deploying the gateway components can include forming storing computer-executable instructions corresponding to the gateway components at the network engine. In some implementations, the particular gateway components deployed at the network engine can be selected based on the type of the physical building device(s) to which the network engine is connected (e.g., via one or more networks implemented by the network engine, etc.), or to other types of computing systems with which the network engine is in communication. Likewise, in some embodiments, the particular gateway components deployed at the network engine can be selected to correspond to an operation, type, or processing capability of the network engine, among other factors as described herein. Deploying the gateway components may include storing the gateway components in one or more predetermined memory regions at the network engine (e.g., in a particular directory, executable memory region, etc.), and may include installing, configuring, or otherwise applying one or more configuration settings for the gateway components or for the operation of the network engine.

As described herein, the one or more gateway components can include any type of software component, hardware configuration settings, or combinations thereof. The gateway components may include processor-executable instructions, which can be executed by the network engine to which the gateway component(s) are deployed. The one or more gateway components can cause the network engine to communicate with the physical building device to receive the one or more data samples (e.g., via one or more networks or communication interfaces). Additionally, the one or more gateway components cause the network engine to communicate the one or more data samples to the cloud platform. For example, the gateway components can include one or more adapters or communication software APIs that facilitate communication between computing devices within, and external to, the building. The gateway components may include adapters that cause the network engine to communicate with one or more other computing systems (e.g., a BMS server, other building subsystems, etc.). The gateway components can include instructions that, when executed by the network engine, cause the network engine to detect a new physical building device connected to the network engine (e.g., by searching through different connected devices by device identifier, etc.), and then search a device library for a configuration of the new physical building device. Using the configuration for the new physical device, the gateway components can cause the network engine to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the network engine to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the network engine. The building system can query the network engine to determine the current operating characteristics (e.g., processing resources, storage resources, data availability, or a presence of another building service executing at the network engine, etc.), to determine that the network engine meets the one or more requirements for the gateway component(s). If the network engine meets the requirements, the building system can deploy the corresponding gateway components to the network engine. If the requirements are not met, the building system may deploy the gateway components to another network engine. The building system can periodically query, or otherwise receive messages from, the network engine that indicate the current operating characteristics of the network engine. In doing so, the building system can identify whether the requirements for the building service (or other gateway components) are no longer met by the network engine. If the requirements are no longer met, the building system can move (e.g., terminate execution of the gateway components or remove the gateway components from the network engine, and re-deploy the gateway components) the gateway components (e.g., the building service) from the network engine to a different computing system that meets the one or more requirements of the building service or gateway component(s). In some implementations, the building system can identify communication protocols corresponding to the physical building devices associated with the network engine, and deploy one or more integration components (e.g., associated with the physical building devices) to the network engine to communicate with the one or more physical building devices via the one or more communication protocols. The integration components can be part of the one or more gateway components.

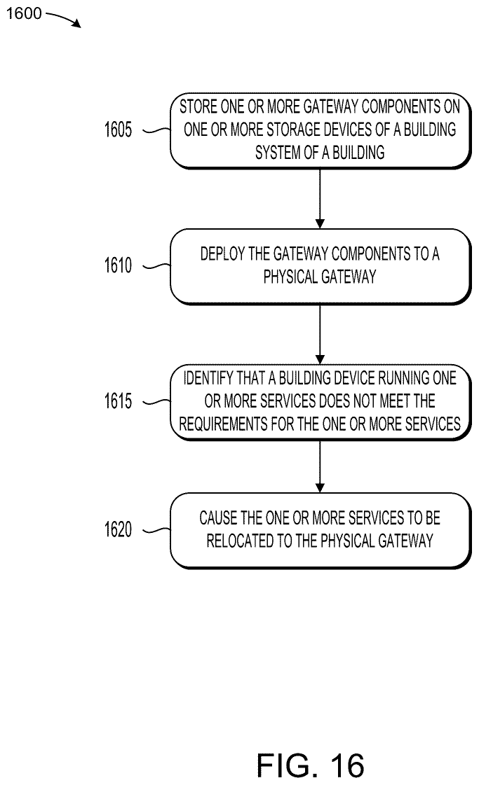

Referring to FIG. 16 is a flow diagram of an example method 1600 for deploying gateway components on a dedicated gateway, according to an exemplary embodiment. In various embodiments, the local server 702 performs the method 1600. However, it should be understood that any computing system described herein may perform any or all of the operations described in connection with the method 1600. For example, in some embodiments, the cloud platform 106 performs method 1600. In yet other embodiments, the local server 702 may perform the method 1600. For example, the cloud platform 106 may perform method 1600 to deploy gateway components on one or more computing devices (e.g., the local server 702, the device/gateway 720, the local BMS server 804, the network engine 816, the gateway 1004, the gateway manager 1202, the cluster gateway 1206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 1600 is referred to herein as the “building system.”

At step 1605, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 106) and facilitate communication with a physical building device (e.g., the device/gateway 720, the building subsystems 122, etc.). The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12.

At step 1610, the building system can deploy the one or more gateway components to a physical gateway, which may communicate and receive data samples from one or more physical building devices of the building, and provide the data samples to the cloud platform. To deploy the gateway components, the building system can utilize one or more communication channels, which may be established via a network of the building, to transmit the gateway components to the physical gateway of the building. Deploying the one or more gateway components can include installing or otherwise configuring the gateway components to execute at the physical gateway. Generally, the gateway components can be executed to perform any of the operations described herein. Deploying the gateway components can include forming storing computer-executable instructions corresponding to the gateway components at the physical gateway. In some implementations, the particular gateway components deployed at the physical gateway can be selected based on the type of the physical building device(s) to which the physical gateway is connected, or to other types of computing systems with which the physical gateway is in communication. Likewise, in some embodiments, the particular gateway components deployed at the physical gateway can be selected to correspond to an operation, type, or processing capability of the physical gateway, among other factors as described herein. Deploying the gateway components may include storing the gateway components in one or more predetermined memory regions at the physical gateway (e.g., in a particular directory, executable memory region, etc.), and may include installing, configuring, or otherwise applying one or more configuration settings for the gateway components or for the operation of the physical gateway.

As described herein, the one or more gateway components can include any type of software component, hardware configuration settings, or combinations thereof. The gateway components may include processor-executable instructions, which can be executed by the physical gateway to which the gateway component(s) are deployed. The one or more gateway components can cause the physical gateway to communicate with the physical building device to receive the one or more data samples (e.g., via one or more networks or communication interfaces). Additionally, the one or more gateway components cause the physical gateway to communicate the one or more data samples to the cloud platform. For example, the gateway components can include one or more adapters or communication software APIs that facilitate communication between computing devices within, and external to, the building. The gateway components may include adapters that cause the physical gateway to communicate with one or more other computing systems (e.g., a BMS server, other building subsystems, etc.). The gateway components can include instructions that, when executed by the physical gateway, cause the physical gateway to detect a new physical building device connected to the physical gateway (e.g., by searching through different connected devices by device identifier, etc.), and then search a device library for a configuration of the new physical building device. Using the configuration for the new physical device, the gateway components can cause the physical gateway to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

At step 1615, the building system can identify a building device (e.g., via the gateway on which the gateway components are deployed) that is executing one or more building services that does not meet the requirements for executing the one or more building services. The buildings services, for example, may cause the building device to generate data based on the one or more data samples, which may be analytics data or any other type of data described herein that may be based on or associated with the data samples. The requirements may include required processing resources, storage resources, data availability, or a presence of another building service executing at the building device. The building system can query the building device to determine the current operating characteristics (e.g., processing resources, storage resources, data availability, or a presence of another building service executing at the building device, etc.), to determine that the building device meets the one or more requirements for the building service(s). If the requirements are not met, the building system can perform step 1620. The building system may periodically query the building device to determine whether the building device meets the requirements for the building services.

At step 1620, the building system can cause (e.g., by transmitting computer-executable instructions to the building device and the gateway) the building services to be relocated to the gateway on which the gateway component(s) are deployed. To do so, the building system can move the building services from the building device to the gateway on which the gateway component(s) are deployed, for example, by terminating execution of the building services or removing the building services from the building device, and then re-deploying or copying the building services, including any application state information or configuration information, to the gateway.

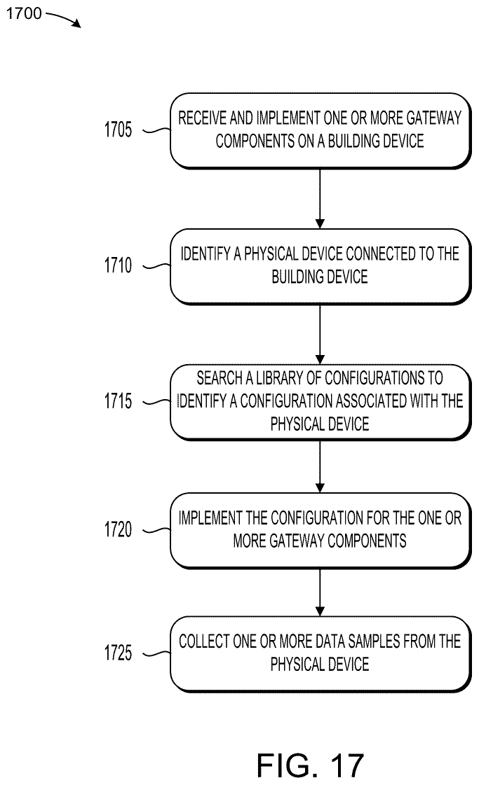

Referring to FIG. 17 is a flow diagram of an example method 1700 for implementing gateway components on a building device, according to an exemplary embodiment. In various embodiments, the device/gateway 720 performs the method 1700. However, it should be understood that any computing system on which gateway components are deployed, as described herein, may perform any or all of the operations described in connection with the method 1700. For example, in some embodiments, the BMS server 804, the network engine 816, the gateway 1004, the building broker device 1105, the gateway manager 1202, or the cluster gateway 1206 performs method 1700. In yet other embodiments, the local server 702 may perform the method 1700. The computing system performing the operations of the method 1700 is referred to herein as the “building device.”

At step 1705, the building device can receive one or more gateway components and implement the one or more gateway components on the building device. The one or more gateway components can facilitate communication between a cloud platform and the building device. The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12. The building device can receive the gateway components from any type of computing device described herein that can deploy the gateway components to the building device, including the cloud platform 106, the BMS server 804, or the network engine 816, among others.

At step 1710, the building device can identify a physical device connected to the building device based on the one or more gateway components. For example, the gateway components can include instructions that, when executed by the physical gateway, cause the physical gateway to detect a physical device connected to the physical gateway (e.g., by searching through different connected devices by device identifier, etc.). then The gateway components can receive one or more values for control points of the physical device, for example, from the building system, from the cloud platform, or from another system or device described herein, and communicate the one or more values to the control points of the physical device via the one or more gateway components.

At step 1715, the building device can search a library of configurations for a plurality of different physical devices with the identity of the physical device to identify a configuration for collecting data samples from the physical device connected to the building device and retrieve the configuration. Search a device library for a configuration of the physical device. The gateway components can also perform a discovery process to discover the configuration for the physical device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library.

At step 1720, the building device can implement the configuration for the one or more gateway components. Using the configuration for the physical device, the gateway components can cause the physical gateway to implement the configuration to facilitate communication with the physical device. The configuration may include configuration for communication hardware (e.g., wireless or wired communications interfaces, etc.) that configure the communication hardware to communicate with the physical device. The configuration can specify a communication protocol that can be used to communicate with the physical device, and may include computer-executable instructions that, when executed, cause the building device to execute an API that carries out the communication protocol to communicate with the physical device.

At step 1725, the building device can collect one or more data samples from the physical device based on the one or more gateway components and the configuration. For example, the gateway components or the configuration can include an API, or other computer-executable instructions, that the building device can utilize to communicate with and retrieve one or more data samples from the physical device. The data samples can be, for example, sensor data, operational data, configuration data, or any other data described herein. Additionally, the building device can utilize one or more of the gateway components to communicate the data samples to another computing system, such as the cloud platform, a BMS server, a network engine, or a physical gateway, among others.

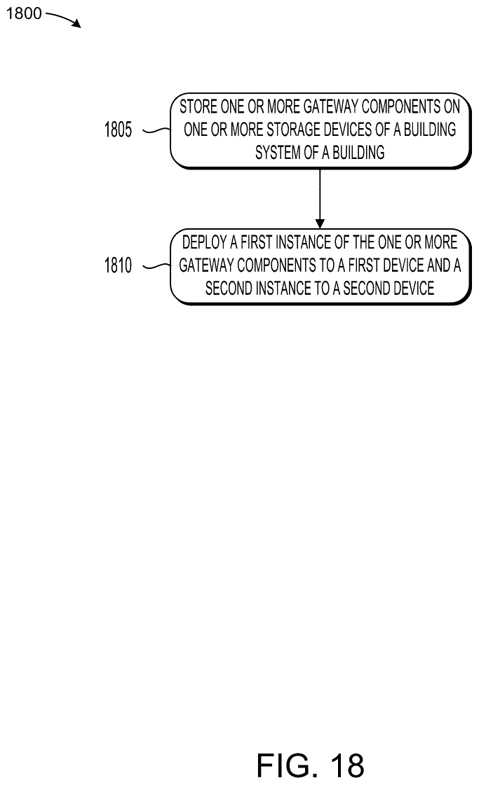

Referring to FIG. 18 is a flow diagram of an example method 1800 for deploying gateway components to perform a building control algorithm, according to an exemplary embodiment. In various embodiments, the local server 702 performs the method 1800. However, it should be understood that any computing system described herein may perform any or all of the operations described in connection with the method 1800. For example, in some embodiments, the cloud platform 106 performs method 1800. In yet other embodiments, the local server 702 may perform the method 1800. For example, the cloud platform 106 may perform method 1800 to deploy gateway components on one or more computing devices (e.g., the local server 702, the device/gateway 720, the local BMS server 804, the network engine 816, the gateway 1004, the gateway manager 1202, the cluster gateway 1206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 1800 is referred to herein as the “building system.”

At step 1805, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 106) and facilitate communication with a physical building device (e.g., the device/gateway 720, the building subsystems 122, etc.). The gateway components can be, for example, any of the, connectors, building normalization layers, services, or integrations described herein, including but certainly not limited to the connector 704, services 706-710, a building normalization layer 712, and integrations 714-718, among other components, software, integrations, configuration settings, or any other software-related data described in connection with FIGS. 1-12.

At step 1810, the building system can a first instance of the one or more gateway components to a first edge device and a second instance of the one or more gateway components to a second edge device. The first edge device can measure a first condition of the building and the second edge device can control the first condition or a second condition of the building. The first edge device (e.g., a building device) can be a surveillance camera, and the first condition can be a presence of a person in the building (e.g., within the field of view of the surveillance camera). The second edge device can be a smart thermostat, and the second condition can be a temperature setting of the building. However, it should be understood that the first edge device and the second edge device can be any type of building device capable of capturing data relating to the building or controlling one or more functions, conditions, or other controllable characteristics of the building. To deploy the gateway components, the building system can utilize one or more communication channels, which may be established via a network of the building, to transmit the gateway components to the first edge device and the second edge device of the building.

Deploying the one or more gateway components can include installing or otherwise configuring the gateway components to execute at the first edge device and the second edge device. Generally, the gateway components can be executed to perform any of the operations described herein. Deploying the gateway components can include forming storing computer-executable instructions corresponding to the gateway components at the first edge device and the second edge device. In some implementations, the particular gateway components deployed at the first edge device and the second edge device can be selected based on the operations, functionality, type, or processing capabilities of the first edge device and the second edge device, among other factors as described herein. Deploying the gateway components may include storing the gateway components in one or more predetermined memory regions at the first edge device and the second edge device (e.g., in a particular directory, executable memory region, etc.), and may include installing, configuring, or otherwise applying one or more configuration settings for the gateway components or for the operation of the first edge device and the second edge device. Gateway components can be deployed to the first edge device or the second edge device based on a communication protocol utilized by the first edge device or the second edge device. The building system can select gateway components to deploy to the first edge device or the second edge device that include computer-executable instructions that allow the first edge device and the second edge device to communicate with one another, and with other computing systems using various communication protocols.

As described herein, the one or more gateway components can include any type of software component, hardware configuration settings, or combinations thereof. The gateway components may include processor-executable instructions, which can be executed by the physical gateway to which the gateway component(s) are deployed. The one or more gateway components can cause the physical gateway to communicate with a building device broker (e.g., the building device broker 1105) to facilitate communication of data samples, conditions, operations, or signals between the first edge device and the second edge device. Additionally, the one or more gateway components cause the first edge device or the second edge device to communicate data samples, operations, signals, or messages to the cloud platform. The gateway components may include adapters or integrations that facilitate communication with one or more other computing systems (e.g., a BMS server, other building subsystems, etc.). The gateway components can cause the first edge device to communicate an event (e.g., a person entering the building, entering a room, or any other detected event, etc.) to the second edge device based on a rule being triggered associated with the first condition. The rule can be, for example, to set certain climate control settings (e.g., temperature, etc.) when a person has been detected. However, it should be understood that any type of user-definable condition can be utilized. The second instance of the one or more gateway components executing at the second edge device can cause the second edge device to control the second condition (e.g., the temperature of the building, etc.) upon receiving the event from the first edge device (e.g., via the building device broker, via the cloud platform, via direct communication, etc.). The building components may include one or more building services that can generate additional analytics data based on detected events, conditions, or other information gathered or processed by the first edge device or the second edge device.

### Optimization and Autoconfiguration of Edge Devices

The techniques described herein may be utilized to optimize and configure edge devices utilizing various computing systems described herein, including the cloud platform 106, the twin manager 108, the edge platform 102, the user device 176, the local server 656, the computing system 660, the local server 702, the local BMS server 804, the network engine 816, the gateway 1004, the building broker device 1105, the gateway manager 1206, the cluster gateway 1206, or the building subsystems 122, among others.

Cloud-based data processing has become more popular due to the decreased cost and increased scale and efficiency of cloud computing systems. Cloud computing is useful when attempting to process data gathered from devices, such as the various building devices described herein, that would otherwise lack the processing power or appropriately optimized software to process that data locally. However, the use of cloud computing platforms for processing large amounts of data from a large pool of edge devices becomes more and more inefficient as the number of edge devices increases. The reduction in processing efficiency and increased latency makes certain types of processing, such as real-time or near real-time processing, impractical to perform using a cloud-processing system architecture.

To address these issues, the systems and methods described herein can be utilized to optimize software components, such as machine-learning models, to execute directly on edge devices. The optimization techniques described herein can be utilized to automatically modify, configure, or generate various components (e.g., gateway components, engine components, connectors, machine-learning models, APIs, etc.) such that the components are optimized for the particular edge device on which they will execute. The configuration of the components can be performed based on the architecture, processing capability, and processing demand of the edge device, among other factors as described herein. While various implementations described herein are configured to allow for processing to be performed at edge devices, it should be understood that, in various embodiments, processing may additionally or alternatively be performed both in edge devices and in other on-premises and/or off-premises devices, including cloud or other off-premises standalone or distributed computing systems, and all such embodiments are contemplated within the scope of the present disclosure.

Automatically optimizing and configuring components for edge devices, when those components would otherwise execute on a cloud computing system, improves the overall computational efficiency of the system. In particular, the use of edge processing enables a distributed processing platform that reduces the inherent latency in communicating and polling a cloud computing system, which enables real-time or near real-time processing of data captured by the edge device. Additionally, utilizing edge processing improves the efficiency and bandwidth of the networks on which the edge devices operate. In a cloud computing architecture, all edge devices would need to transmit all of the data points captured to the cloud computing system for processing (which is particularly burdensome for near real-time processing). By automatically optimizing components to execute on edge devices, the data points captured by the edge devices need not be transmitted en masse to the cloud computing system, which significantly reduces the amount of network resources required to execute certain components, and improves the overall efficiency of the system.

Additionally, the systems and methods described herein can be utilized to automatically configure (sometimes referred to herein as “autoconfigure” or performing “autoconfiguration”) edge devices by managing the components, connectors, operating system features, and other related data via a cloud computing system. The techniques described herein can be utilized to manage the operations of and coordinate the lifecycle of edge devices remotely, via a cloud computing system. The device management techniques described herein can be utilized to manage and execute commands that update software of edge devices, reboot edge devices, manage the configuration of edge devices, restore edge devices to their factory default settings or software configuration, and activate or deactivate edge devices, among other operations. The techniques described herein can be utilized to define and customize connector software, which can facilitate communications between two or more computing devices described herein. The connector software can be remotely defined and managed via user interfaces provided by a cloud computing system. The connector software can then be pushed to edge devices using the device management techniques described herein.

Various implementations of the present disclosure may utilize any feature or combination of features described in U.S. Patent Application Nos. 63/315,442, 63/315,452, 63/315,454, 63/315,459, and/or 63/315,463, each of which is incorporated herein by reference in its entirety and for all purposes. For example, in some such implementations, embodiments of the present disclosure may utilize a common data bus at the edge devices, be configured to ingest information from other on-premises/edge devices via one or more protocol agents or brokers, and/or may utilize various other features shown and described in the aforementioned patent applications. In some such implementations, the systems and methods of the present disclosure may incorporate one or more of the features shown and described, for example, with respect to FIG. 3 (or any of the other illustrative figures and accompanying disclosure) of U.S. Patent Application No. 63/315,463. Additionally or alternatively, various implementations of the present disclosure may utilize any feature or combination of features described in U.S. patent application Ser. Nos. 16/792,149, 17/229,782, 17/304,933, 16/379,700, 16/190,105, 17/648,281, 63/267,386, and/or 17/892,927, each of which is incorporated herein by reference in its entirety and for all purposes.

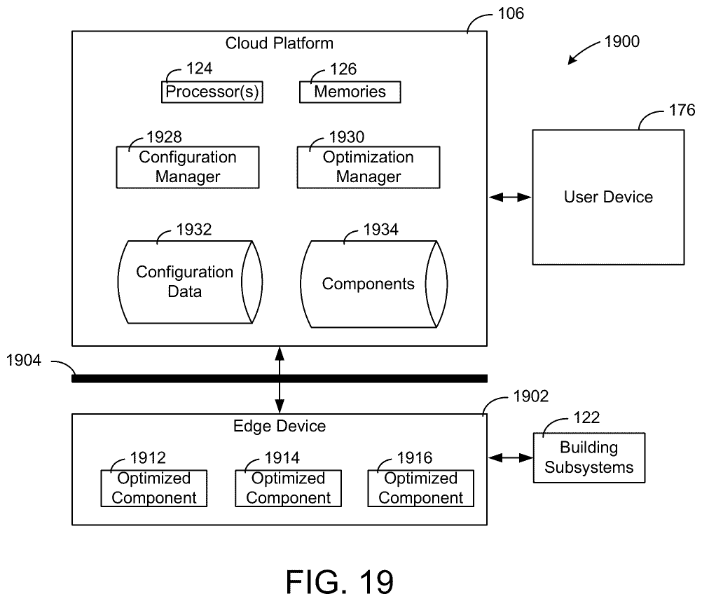

Referring to FIG. 19, illustrated is diagram of a system 1900 that may be utilized to perform optimization and automatic configuration of edge devices, according to an embodiment. As shown, the system 1900 can include an edge device 1902, a cloud platform 106, and a user device 176, in an embodiment. The edge device 1902, the cloud platform 106, and the user device 176 can each be separate services deployed on the same or different computing systems. In some embodiments, the cloud platform 106 and the user device 176 are implemented in off premises computing systems, e.g., outside a building. The edge device 1902 can be implemented on-premises, e.g., within the building. However, any combination of on-premises and off-premises components of the system 1900 can be implemented.

As described herein, the cloud platform 106 can include one or more processors 124 and one or more memories 126. The processor(s) 124 can include a general purpose or specific purpose processors, an ASIC, a graphical processing unit (GPU) one or more field programmable gate arrays, a group of processing components, or other suitable processing components. The processor(s) 124 may be configured to execute computer code and/or instructions stored in the memories 126 or received from other computer readable media (e.g., CDROM, network storage, a remote server, etc.). The processor(s) 124 may be part of multiple servers or computing systems that make up the cloud platform 106, for example, in a remote datacenter, server farm, or other type of distributed computing environment.

The memories 126 can include one or more devices (e.g., memory units, memory devices, storage devices, etc.) for storing data or computer code for completing or facilitating the various processes described in the present disclosure. The memories 126 can include RAM, ROM, hard drive storage, temporary storage, non-volatile memory, flash memory, optical memory, or any other suitable memory for storing software objects or computer instructions. The memories 126 can include database components, object code components, script components, or any other type of information structure for supporting the various activities and information structures described in the present disclosure. The memories 126 can be communicably connected to the processors and can include computer code for executing (e.g., by the processors 124) one or more processes described herein.

Although not necessarily pictured here, the configuration data 1932 and the components 1934 may be stored as part of the memories 126, or may be stored in external databases that are in communication with the cloud platform 106 (e.g., via one or more networks). The configuration data 1932 can include any of the data relating to configuring the edge devices 1902, as described herein. The configuration data can include software information of the edge devices 1902, operating system information of the edge devices 1902, status information (e.g., device up-time, service schedule, maintenance history, etc.), as well as metadata corresponding to the edge devices 1902, among other information. The configuration data 1932 can be created, updated, or modified by the cloud platform 106 based on the techniques described herein. In embodiment, in response to corresponding requests from the user device 176, or in response to scheduled updates or changes, the cloud platform 106 can update a local configuration of a respective edge device 1902 based on the techniques described herein.

The configuration data 1932 can include data configured for a number of edge devices 1902, and for a wide variety of edge devices 1902 (e.g., network engines, device gateways, local servers, etc.). For example, the configuration data 1932 can include configuration data for any of the computing devices, systems, or platforms described herein. The configuration data 1932 can be managed, updated, or otherwise utilized by the configuration manager 1928, as described herein. The configuration data 1932 may also include connectivity data. The connectivity data may include information relating to which edge devices 1902 are connected to other devices in a network, one or more possible communication pathways (e.g., via routers, switches, gateways, etc.) to communicate with the edge devices 1902, and network topology information (e.g., of the network 1904, of networks to which the network 1904 is connected, etc.).

The components 1934 can include software that can be optimized using various techniques described herein. The components 1934 can include connectors, data processing applications, or other types of processor-executable instructions. The components 1934 may be executable by the cloud platform 106 to perform one or more data processing operations (e.g., analysis of sensor data, machine-learning operations, unsupervised clustering of data retrieved using various techniques described herein, etc.). As described in further detail herein, the optimization manager 1930 can optimize one or more of the components 1934 for one or more target edge devices 1902. In brief overview, the optimization manager 1930 can access the computational capabilities, architecture, status, and other information relating to the target edge device 1902, and can automatically modify one or more of the components to be optimized for the target edge device 1902.

Each of the configuration manager 1928 and the optimization manager 1930 may be hardware, software, or a combination of hardware and software of the cloud platform 106. The configuration manager 1928 and the optimization manager 1930 can execute one or more computing devices or servers of the cloud platform 106 to perform the various operations described herein. In an embodiment, the configuration manager 1928 and the optimization manager 1930 can be stored as processor-executable instructions in the memories 126, and when executed by the cloud platform 106, cause the cloud platform 106 to perform the various operations associated with each of the configuration manager 1928 and the optimization manager 1930.

The edge device 1902 may include any of the functionality of the edge device 102, or the components thereof. The edge device 1902 can communicate with the the building subsystems 122, as described herein. The edge device 1902 can receive messages from the building subsystems 122 or deliver messages to the building subsystems 122. The edge device 1902 can includes one or multiple optimized components, e.g., the optimized components 1912, 1914, and 1916. Additionally, the edge device 1902 can include a local configuration, which may include a software configuration or installation, an operating system configuration or installation, driver configuration or installation, or any other type of component configuration described herein.

The optimized components 1912-1916 can include software that has been optimized by the optimization manager 1930 of the cloud platform 106 to execute on the edge device 1902, for example, to perform edge processing of data received by or retrieved from the building subsystems 122. Although not pictured here for visual clarify, the edge devices 1902 may include communication components, such as connectors or other communication software, hardware, or executable instructions as described herein, that can act as a gateway between the cloud platform 106 and the building subsystems 122. In some embodiments, the cloud platform 106 can deploy one or more of the optimized components 1912-1916 to the edge device 1902, using various techniques described herein. In this regard, lower latency in management of the building subsystems 122 can be realized.

The edge device 1902 can be connected to the cloud platform 106 via a network 1904. The network 1904 can communicatively couple the devices and systems of the system 1900. In some embodiments, the network 1904 is at least one of and/or a combination of a Wi-Fi network, a wired Ethernet network, a ZigBee network, a Bluetooth network, and/or any other wireless network. The network 1904 may be a local area network or a wide area network (e.g., the Internet, a building WAN, etc.) and may use a variety of communications protocols (e.g., BACnet, IP, LON, etc.). The network 1904 may include routers, modems, servers, cell towers, satellites, and/or network switches. The network 1904 may be a combination of wired and wireless networks. Although only one edge device 1902 is shown in the system 1900 for visual clarity and simplicity, it should be understood that any number of edge devices 1902 (corresponding to any number of buildings) can be included in the system 1900 and communicate with the cloud platform 106 as described herein.

The cloud platform 106 can be configured to facilitate communication and routing of messages between the user device 176 and the edge device 1902, and/or any other system. The cloud platform 106 can include any of the components described herein, and can implement any of the processing functionality of the devices described herein. In an embodiment, the cloud platform 106 can host a web-based service or website, via which the user device 176 can access one or more user interfaces to coordinate various functionality described herein. In some embodiments, the cloud platform 106 can facilitate communications between various computing systems described herein via the network 1904.

The user device 176 may be a laptop computer, a desktop computer, a smartphone, a tablet, and/or any other device with an input interface (e.g., touch screen, mouse, keyboard, etc.) and an output interface (e.g., a speaker, a display, etc.). The user device 176 can receive input via the input interface, and provide output via the output interface. For example, the user device 176 can receive user input (e.g., interactions such as mouse clicks, keyboard input, tap or touch gestures, etc.), which may correspond to interactions. The user device 176 can present one or more user interfaces described herein (e.g., the user interfaces provided by the cloud platform 106) via the output interface.

The user device 176 can be in communication with the cloud platform 106 via the network 1904. For example, the user device 176 can access one or more web-based user interfaces provided by the cloud platform 106 (e.g., by accessing a corresponding uniform resource locator (URL) or uniform resource identifier (URI), etc.). In response to corresponding interactions with the user interfaces, the user device 176 can transmit requests to the cloud platform 106 to perform one or more operations, including the operations described in connection with the configuration manager 1928 or the optimization manager 1930.

Referring now to the operations of the configuration manager 1928, the configuration manager 1928 can coordinate and facilitate management of edge devices 1902, including the creation and autoconfiguration of connector templates for one or more edge devices 1902, and providing device management functionality via the network 1904. The configuration manager 1928 can manage and execute commands that update software of edge devices, reboot edge devices, manage the configuration of edge devices 1902, restore edge devices 1902 to their factory default settings or software configuration, and activate or deactivate edge devices 1902, among other operations. The connection manager 1928 may also monitor connectivity between edge devices, identify a connection failure between two edge devices, and determine a recommendation to address the connection failure.

The configuration manager 1928 can access and provide a list of edge devices 1902 with which the cloud platform 106 can communicate, for example, for display in a user interface. To generate and display the list, the configuration manager 1928 can access the configuration data 1932, which stores identifiers of the edge devices 1902, along with their corresponding status. The user interface can display various information about each edge device 1902, including a device name, a group name, an edge status, a platform name (e.g., processor architecture), an operating system version, a software package version (e.g., which may corresponding to one or more components described herein), a hostname (shown here as an IP address), a gateway name of a gate to which the edge device is connected (if any), and a date identifying the last software upgrade.

In the user interface, each item in the list of devices includes a button that, when interacted with, enables the user to issue one or more commands to the configuration manager 1928 to manage the respective device. Drop-down menus can provide a list of commands for each edge device, such as a command to reboot the respect edge device 1902, a reset to factory default command, a deactivation command, and an upgrade software command. To upgrade, update, or configure software, the configuration manager 1928 can transmit updated software to the respective edge device 1902, and cause the respective edge device 1902 to execute processor-executable instructions to install and configure the software according to the commands issued by the configuration manager 1928.

In an embodiment, when an upgrade software command is selected at the user interfaces provided by the configuration manager 1928, the configuration manager 1928 can provide another user interface to enable the user to select one or more software components, versions, or deployments to deploy to the respective edge device. In an embodiment, if a software version is already up-to-date (e.g., no upgrades available) the configuration manager 1928 can display a notification indicating that the software is up-to-date. The configuration manager 1928 can further provide graphical user interfaces (or other types of selectable user interface elements), or application programming interfaces, that can be utilized to specify which software components to deploy, upgrade, or otherwise provide to the edge device 1902.

The configuration manager 1928 can manage any type of software, component, connector, or other processor-executable instructions that can be provided to and executed by the edge device 1902 in a similar manner. When a software upgrade is selected or specified, the configuration manager 1928 can begin to deploy the selected software to the edge device 1902, and can execute one or more scripts or processor-executable instructions to install and configure the selected software at the edge device 1902. The configuration manager 1928 can transmit the data for the installation to the edge device 1902 via the network 1904.

As the selected components are being deployed, the configuration manager 1928 can maintain and display information indicating a status of the edge device 1902 and the status of the deployment. A historic listing of other operations performed by the configuration manager 1928 can also be maintained or displayed in a status interface. Each item in the listing can include a name of the action performed by the configuration manager 1928, a status of the respective item (e.g., “InProgress,” “Completed,” “Failed,” etc.), a date and timestamp corresponding to the operation, and a message (e.g., a status message, etc.) corresponding to the respective action. Any of the information presented on the user interfaces provided by the configuration manager 1928 can be stored as part of the configuration data 1932.

The configuration manager 1928 can provide user interfaces that enable an operator to configure one or more edge devices 1902, or the components deployed thereon. For example, the configuration manager 1928 can display a user interface that shows a list of configuration templates. The example that follows describes a configuration process for a chiller controller with a device name “VSExxx.” However, similar operations may be performed for any software on any number of edge devices, in order to configure one or more connectors, components, or other processor-executable instructions to facilitate communication between building devices.

The connectors implemented by the configuration manager 1928 can be utilized to connect with different sensors and devices at the edge (e.g., the building subsystems 122), retrieve and format data retrieved from the building subsystems 122, and provide said data in one or more data structures to the cloud platform 106. The connectors may be similar to, or may be or include, any of the connectors described herein. The configuration manager 1928 can provide user interfaces that enable a user to specify parameters for a template connector, which can then be generated by the configuration manager 1928 and provided to the edge device 1902 to retrieve data. In this example, a new connector for a VSExxx device has been defined.

Upon creating the connector template for the VSExxx device, the configuration manager 1928 can enables selection or specification of one or more parameters for the template connector, such as a name for the template, a direction for the data (e.g., inbound is receiving data, such as from a sensor, outbound is providing data, and bidirectional includes functionality for inbound and output), as well as using sensor discovery (e.g., the device discovery functionality described herein). Additionally, the configuration manager 1928 can also enable selection or specification of one or more applications that execute on the edge device 1902 that implement the connector. In an embodiment, if an application is not selected, a default application may be selected based on, for example, other parameters specified for the connector, such as data types or server fields. The application can be developed by the operator for the specific edge device using a software development kit that invokes one or more APIs of the cloud platform 106 or the configuration manager 1928, thereby enabling the cloud platform 106 to communicate with the edge device 1902 via the APIs.

The configuration manager 1928 can enable selection or specification of one or more server parameters for the connector (e.g., parameters that coordinate data retrieval or provision, ports, addresses, device data, etc.). The configuration manager 1928 can enable selection or specification of one or more parameters for each field (e.g., field name, property name, value type (e.g., data type such as string, integer, floating-point value, etc.), default value, whether the parameter is a required parameter, and one or more guidance notes that may be accessed while working with the respective connector via the user device 176, etc.).

The configuration manager 1928 can enable selection of one or more sensor data parameters for the connector template. The sensor parameters can similarly be selected and added form the user interface elements (or via APIs) provided by the configuration manager 1928. The sensor parameters can include parameters of the sensors in communication with the edge device 1902 that are accessed using the connector template. Fields similar to those provided for the server parameters can be specified for each field of the sensor parameters, as shown. In this example, the edge device is in communication with a building subsystem 122 that gathers data from four vibration sensors, and therefore there are fields for sensor parameters that correspond to each of the four vibration sensors. In an embodiment, the device discovery functionality described herein can be utilized to identify one or more configurations or sensors, which can be provided to the configuration manager 1928 such that the template connector can be automatically populated.

The configuration manager 1928 can save the template in the configuration data 1932. When the operator wants to deploy the generated template to an edge device, the configuration manager 1928 can be utilized to deploy one or more connectors. The configuration manager 1928 can present a user interface that enables the operator to deploy one or more connectors to a selected edge device. In this example, there is one edge device listed, but it should be understood that any number of edge devices may be listed and managed by the configuration manager 1928. The configuration manager 1928 can allow selection of one or more generated connector templates (e.g., via a user interface or an API), which can then be deployed on the edge device 1902 using the techniques described herein.

Referring now to the operations of the optimization manager 1930, the optimization manager 1930 can optimize one or more of the components 1934 to execute on a target edge device 1902, by generating corresponding optimized components (e.g. the optimized components 1912-1916). As described herein, cloud-based computing is impractical or impossible for real-time or near real-time data processing, due to the inherent latency of cloud computing. To address these issues, the optimization manager 1930 can optimize and deploy one or more components 1934 for a target edge device 1902, such that the target edge device 1902 can execute the corresponding optimized component at the edge without necessarily performing cloud computing.

The components 1932 may include machine-learning models that execute using data gathered from the building subsystems 122 as input. An example machine learning workflow can include of preprocessing, prediction (or executing another type of machine-learning operation), and post processing. Constrained devices (e.g., the edge devices 1902) may generally have fewer resources to run machine-learning workflows than the cloud platform 106. This problem is compounded by the fact that typical machine-learning workflows are written in dynamic languages like Python. Although dynamic languages can accelerate deployment of machine-learning implementations, such languages are inefficient when it comes to resource usage and are not as computationally efficient compared to compiled languages. As such, machine-learning models are typically developed in a dynamic language and then executed on a large cluster of servers (e.g., the cloud platform 106). Additionally, the data is pre- and post-processed before and after machine learning model prediction in a workflow by the cloud platform 106 (e.g., by another cluster of computing devices, etc.).

One approach to solving this problem is to combine machine learning and stream processing using components (e.g., the optimized components 1912-1916) to be executed on an edge device 1902. To do so, the optimization manager 1930 can generate code that gets compiled into code specific to the machine-learning model and the target edge device 1902, thereby using the computational resources and memory of the edge device 1902 as efficiently as possible. To do so, the optimization manager 1930 can utilize two sets of APIs. One set of APIs is utilized for stream processing and other set of APIs is used for machine learning. The stream processing APIs can be used to read data, and perform pre-processing and post-processing. The machine learning APIs can be executed on the edge device 1902 to load the model, bind the model inputs to the streams of data and bind the outputs to streams that can be processed further.

The optimization manager 1930 can support existing machine-learning libraries as any new machine libraries that may be developed as part of the components 1934. Once a machine-learning model is developed in a framework of their choice, they can define all the pre-processing and post-processing of inputs and outputs using API bindings that invoke functionality of the optimization manager 1930. Once the code for the machine-learning model and the pre-processing and post-processing steps have been developed, the optimization manager 1930 can apply software optimization techniques and generate an optimized model and stream processing definitions (e.g., the optimized components 1912-1916) into a compiled language (e.g., C, C++, Rust, etc.). The optimization manager 1930 can then compiles the generated code while targeting a native binary for the target edge device 1902, suing runtime that is already deployed on the target edge device 1902 (e.g., one or more software configurations, operating systems, hardware acceleration libraries, etc.).

One advantage of this approach is operators that develop machine-learning models need not manually optimize the machine-learning models for any specific target edge device 1902. The optimization manager 1930 can automatically identify and apply optimizations to machine-learning models based on the respective type of model, input data, and other operator-specified (e.g., via one or more user interfaces) parameters of the machine-learning model. Some example optimizations include pruning. The optimization manager 1930 can generate code for machine-learning models that can execute efficiently while using fewer computational resources and with faster inference times for a target edge device 1902. This enables efficient edge processing without tedious manual intervention or optimizations.

Models that will be optimized by the optimization manager 1930 can be platform agnostic and may be developed using any suitable the machine-learning library or framework. Once a model has been developed and tested locally using a framework implemented or utilized by the optimization manager 1930, the optimization manager 1930 can utilize input provided by a user to determine one or more model parameters. The model parameters can include, but are not limited to, model architecture type, number of layers, layer type, loss function type, layer architecture, or other types of machine-learning model architecture parameters. The optimization manager 1930 can also enable a user to specify target system information (e.g., architecture, computational resources, other constraints, etc.). Based on this data, the optimization manager 1930 can select an optimal runtime for the model, which can be used to compile the model while targeting the target edge device 1902.

In an example implementation, an operator may first define a machine-learning model using a library such as Tensorflow, which may utilize more computational resources than are practically available at a target edge device 1902. Because the model is specified in a dynamic language, the model is agnostic of a target platform, but may implemented in a target runtime which could be different from runtimes present at the target edge device 1902. The optimization manager 1930 can then perform one or more optimization techniques on the model, to optimize the model in various dimensions. For example, the optimization manager 1930 can detect the processor types present on the target edge device 1902 (e.g., via the configuration data 1932 or by communicating with the target edge device 1902 via the network 1904). Furthering this example, if the model can be targeted to run on one or more GPUs, and the target edge device 1902 includes a GPU that is available for machine-learning processing, the optimization manager 1930 can configure the model to utilize the GPU accelerated runtimes of the target edge device. Likewise, if the model can be targeted to run on a general-purpose CPU, and the target edge device includes a general-purpose CPU that is available for machine-learning processing, the optimization manager 1930 can automatically transform the model to execute on a CPU runtime for the target edge device 1902 (e.g., OpenVINO, etc.). In another example, if the target edge device 1902 is a resource constrained device, such as an ARM platform, the optimization manager 1930 can transform the model to utilize the tflite runtime, which is less computationally intensive and optimized for ARM devices. Additionally, the optimization manager 1930 may deploy tflite to the target edge device 1902, if not already installed. In addition, the optimization manager 1930 can further optimize the model to take advantage of vendor-specific libraries like armnn, for example, when targeting an ARM device.

Referring back to the functionality of the configuration manager 1928, the configuration manager 1928 can monitor and identify connection failures in the network 1904 or other networks to which the edge devices 1902 are connected. In particular, the configuration manager can monitor connectivity between edge devices, identify a connection failure between two edge devices, and determine a recommendation to address the connection failure. The configuration manager 1928 can perform these operations, for example, in response to a corresponding request from the user device 176. As described herein, the configuration manager 1928 can provide one or more web-based user interfaces that enable the user device 176 to provide requests relating to the connectivity functionality of the configuration manager 1928. The configuration manager 1928 can store connectivity data as part of the configuration information 1930. The connectivity data can include information relating to which edge devices 1902 are connected to other devices in a network, one or more possible communication pathways (e.g., via routers, switches, gateways, etc.) to communicate with the edge devices 1902, and network topology information (e.g., of the network 1904, of networks to which the network 1904 is connected, etc.), network state information, among other network features described herein.

The configuration manager 1928 can utilize a variety of techniques to diagnose connectivity problems on various networks (e.g., the network 1904, underlay networks, overlay networks, etc.). For example, the configuration manager 1928 can ping local devices to check the connectivity of local devices behind an Airwall gateway, check tunnels to determine whether communications can travel over a host identity protocol (HIP) tunnel (e.g., and create a tunnel between two Airwalls if one does not exist), ping an IP or hostname from an Airwall via an underlay or overlay network (e.g., both of which may be included in the network 1904), perform a traceroute to an IP or hostname from an Airwall from an overlay or underlay network, as well as check HIP connectivity to an Airwall relay (e.g., an Airwall that relays traffic between two other Airwalls when they cannot communicate directly on an underlay network due to potential network address translation (NAT) issues), among other functionality.

Based on requests from the user device 176 and based on network information in the configuration data 1932, the configuration manager 1928 can automatically select and execute operations to check and diagnose potential connectivity issues between at least two edge devices 1902 (or between an edge device 1902 and another computing system described herein, or between two other computing systems that communicate via the network 1904). Automatic detection and diagnosis of network connectivity issues is useful because operators may not have all of the information or resources to manually detect or rectify the connectivity issues without the present techniques. Some example network issues include Airwalls that need to be in a relay rule so they can communicate via relay because they do not have direct underlay connectivity, firewall rules inadvertently blocking a HIP port preventing connectivity, or broken underlay network connectivity due to a gateway and its local device(s) not having routes set up to communicate with remote devices, among others.

The configuration manager 1928 can detect network settings (e.g., portions of the configuration data 1932) that have been misconfigured and are causing connectivity issues between two or more devices. Some example network configuration issues can include disabled devices, disabled gateways, disabled networks or subnets, or rules that otherwise block traffic between two or more devices (e.g., blocked ports, blocked connectivity functionality, etc.). Using the user interfaces provided by the configuration manager 1928, the user device 176 can select two or more device for which to check and diagnose connectivity. Based on the results of its analysis, the configuration manager 1928 can provide one or more suggestions in the web-based interface to address any detected connectivity issues.

Some example conditions in the network 1904 that the configuration manager 1928 can detect include connectivity rules (or lack thereof) in the underlay or overlay network that prevent device connectivity, port filtering that blocks internet control message protocol (ICMP) traffic, offline gateways (e.g., Airwalls), or lack of configuration to communicate with remote devices, among others. To detect these conditions, the configuration manager 1928 can identify and maintain various information about the status of the network in the configuration data 1932, including device groups policies and blocks; the status (e.g., enabled, disabled) of devices, gateways (e.g., Airwalls), and overlay networks; relay rule data; local device ping; remote device ping on an overlay network; information from gateway underlay network pings and BEX (e.g., HIP tunnel handshake); gateway connectivity data (e.g., whether the gateway is connecting to other Airwalls successfully); relay probes; and relay diagnostic information; among other data.

One or more source devices (e.g., an edge device 1902, other computing systems described herein) and one or more destination devices (e.g., another edge device 1902, other computing systems described herein, etc.) can be selected (e.g., via a user interface or an API) or identified, in order to evaluate connectivity between the selected devices. The A hostname or an IP address may be provided as the source or destination device. Upon selection of the devices, the configuration manager 1928 can access the network topology information in the configuration data 1932, and generate a graph indicating a communication pathway (e.g., via the network 1904, which may include one or more gateways) between the two devices.

The configuration manager 1928 can then present the generated graph showing the communication pathway on another user interface. The configuration manager 1928 can check the connectivity between the two selected devices. The configuration manager 1928 can begin executing the various connectivity checks described herein. In an embodiment, the configuration manager 1928 may execute one or more of the connectivity operations in parallel to improve computational efficiency. In doing so, the configuration manager 1928 can analyze the results of the diagnostic tests performed between the two devices to determine whether connectivity was successful.

When the configuration manager 1928 is performing the connectivity checks, the configuration manager 1928 can display another user interface that shows a status of the diagnostic operations. As each diagnostic test completes, the configuration manager 1928 can dynamically update the user interface to include each result of each diagnostic test. The user interface can be dynamically updated to display a list of each completed diagnostic test and its corresponding status (e.g., passed, failed, awaiting results, etc.). Once all of the diagnostic tests have been performed, the configuration manager 1928 can provide a list of recommendations to address any connectivity issues that are detected.

The configuration manager 1928 can detect or implement port filtering (e.g., including layer 4 rules), provide tunnel statistics, pass application traffic (e.g., RDP, HTTP/S, SSH, etc.), and inspect cloud routes and security groups, among other functionality. In some embodiments, the configuration manager 1928 can enable a user to select a network object and indicate an IP address within the network object. In addition to recommendations, the configuration manager 1928 may provide links that, when interacted with, cause the configuration manager 1928 to attempt to address the detected connectivity issues automatically. For example, the configuration manager 1928 may enable one or more devices, device groups, or overlay networks, add one or more gateways to a relay rule, or activate managed relay rules for an overlay network, among other operations.

Additional functionality of the configuration manager 1928 includes spoofing traffic from a local device so a gateway can directly ping or pass traffic to a remote device, to address limitations relating to initiating traffic on device that are not under the control of the configuration manager 1928. The configuration manager 1928 can mine data from a policy builder that can indicate what the connectivity intention should be, as well as add the ability to detect device-to-device traffic on overlay networks. The configuration manager 1928 can provide a beacon server on an overlay network to detect whether the beacon server is accessible to a selected device. The configuration manager 1928 can test the basic connectivity of an overlay network by determining whether a selected device can communicate with another device on the network.

### Integration and Containerization of Gateway Components

Edge devices, such as gateways, network devices, or other types of network-capable building equipment can be utilized to manage building subsystems that otherwise lack “smart” capabilities, such as intelligent management or connectivity to cloud computing environments. Edge devices may be any type of device that executes software, including any of the computing devices described herein. Building device gateways, which may include any of the gateways, network devices, or edge devices described herein, can act as interfaces between traditional networked computing systems and building equipment, enabling remote management, automatic configuration, and additional controls. One advantage of these types of systems is the ability to interface with any type of building equipment, enabling conversion of legacy buildings with legacy devices into network-enabled smart buildings.

The techniques described herein provide containerized building management software components. Using containerized components reduces instances of software conflicts (e.g., dependency issues), improves performance and efficiency of updating or on-boarding building device gateways, and/or provides an extensible communication framework based on a publisher-subscriber messaging protocol, in various illustrative implementations. For example, rather than re-imaging entire devices or maintaining cumbersome package management software, the implementation of gateway components as containers enables updates or modifications to system software without inadvertently causing compatibility issues with the gateway components. Communication between containerized gateway components can be facilitated via one or more virtual busses, which may be implemented via virtual IP networks by the processors of the building device gateway.

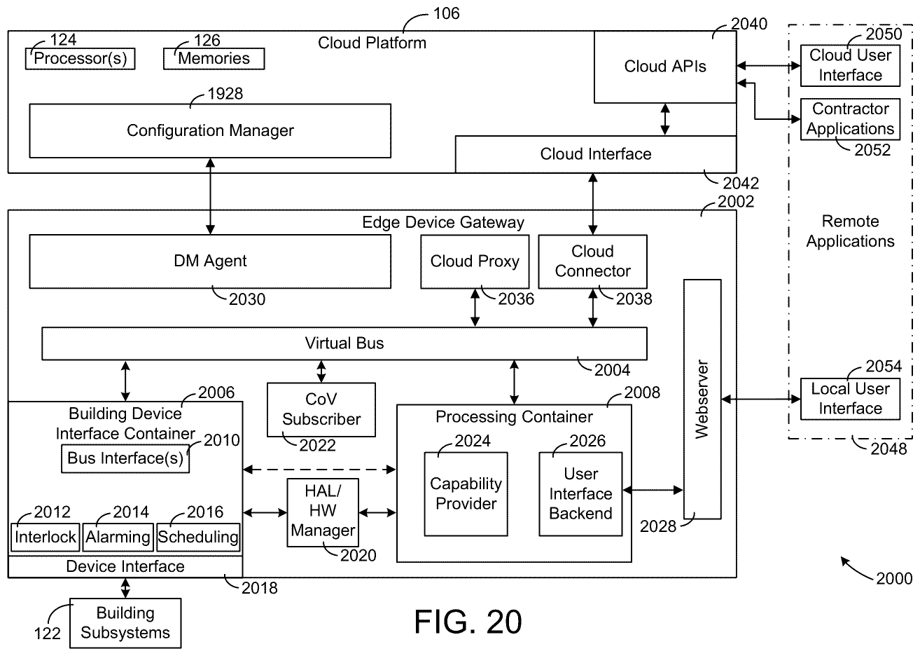

Referring to FIG. 20, illustrated is a block diagram of an example system 2000 including an example building device gateway 2102 that implements containerized gateway components (e.g., the building device interface container 2006, the processing container 2008, the change of value (CoV) subscriber 2022, the cloud proxy 2036, the cloud connector 2038, etc.), in accordance with one or more implementations. As shown, the system 2000 includes the cloud platform 106, the edge device gateway 2002, one or more remote applications 2048 (e.g., which may be implemented or executed by one or more user devices 176 described herein, etc.), and one or more building subsystems 122. The edge device gateway 2002 and the cloud platform 106 can each be separate services deployed on the same or different computing systems. In some embodiments, the cloud platform 106 is implemented in off-premises computing systems, e.g., outside a building. The edge device gateway 2002 and the building subsystems 122 can be implemented on-premises, e.g., within the building. However, any combination of on-premises and off-premises components of the system 2000 can be implemented.

As described herein, the cloud platform 106 can include one or more processors 124 and one or more memories 126. The processor(s) 124 can include a general purpose or specific purpose processors, an ASIC, a graphical processing unit (GPU) one or more field programmable gate arrays, a group of processing components, or other suitable processing components. The processor(s) 124 may be configured to execute computer code and/or instructions stored in the memories 126 or received from other computer readable media (e.g., CDROM, network storage, a remote server, etc.). The processor(s) 124 may be part of multiple servers or computing systems that make up the cloud platform 106, for example, in a remote datacenter, server farm, or other type of distributed computing environment.

The memories 126 can include one or more devices (e.g., memory units, memory devices, storage devices, etc.) for storing data or computer code for completing or facilitating the various processes described in the present disclosure. The memories 126 can include RAM, ROM, hard drive storage, temporary storage, non-volatile memory, flash memory, optical memory, or any other suitable memory for storing software objects or computer instructions. The memories 126 can include database components, object code components, script components, or any other type of information structure for supporting the various activities and information structures described in the present disclosure. The memories 126 can be communicably connected to the processors 124 and can include computer code for executing (e.g., by the processors 124) one or more processes described herein. The edge device gateway 2002 may also include one or more processors 124 and one or more memories 126.

The configuration manager 1928 of cloud platform 106 can store one or more configuration images, which may include full system images that store software for the edge device gateway 2002. The configuration images can be requested by or communicated to the device management (DM) agent 2030 executing on the edge device gateway 2002. The configuration images stored by the configuration manager 1928 of the cloud platform 106 can be specific to (e.g., include software compiled or otherwise configured for) particular edge devices (e.g., the edge device gateway 2002, the edge device 1902, other edge devices described herein, etc.).

The cloud platform 106 can implement or execute the configuration manager 1928, and any of the functionality associated therewith described herein. In some implementations, the cloud platform 106 can include and execute the optimization manager 1930 described in connection with FIG. 19. The configuration manager 1928 can communicate with the DM agent 2030 of the edge device gateway 2002. In some implementations, the configuration manager 1928 can update, remove, provide, or modify one or more of the containerized components of the edge device gateway 2002. In some implementations, the configuration manager 1928 can create, modify, or remove one or more network permissions of the edge device gateway 2002, enabling (or disabling) the ability of the edge device gateway 2002 to communicate via one or more networks.

The cloud platform 106 can implement the configuration manager 1928, as described herein. In some implementations, the configuration manager 1928 can provide, update, modify, or remove any low-level software that can be implemented by the edge device gateway 2002. For example, the configuration manager 1928 can provide, update, modify, or remove device firmware, low-level drivers or system configurations, or host-specific applications that are separate from the containerized gateway components described herein. The configuration manager 1928 can communicate with the DM agent 2030 that executes on the edge device gateway 2002. The DM agent 2030 can retrieve, implement, manage, or execute any of the commands or data received or requested from the configuration manager 1928.

The cloud platform 106 can include one or more cloud interfaces 2042, which can include software, hardware, or combinations of hardware and software that enable communication with the cloud connector 2038 of one or more edge device gateways 2002. The cloud interface 2042 can send or receive various messages to or from the cloud platform 106, or in some implementations, via other computing systems. The cloud interface 2042 can utilize one or more encrypted keys, certificates, or other types of authentication credentials to verify or authenticate the edge device gateway 2002 with which the cloud platform 106 is communicating.

The cloud platform 106 can include one or more cloud APIs 2040, which may be utilized to communicate with one or more computing devices other than the edge device gateway 2002. For example, the cloud APIs 2040 may be utilized to communicate with one or more user devices 176 as described herein, which may implement or execute one or more of the remote applications 2048. For example, the cloud APIs 2040 may provide one or more cloud user interfaces 2050 (e.g., via a webserver and displayed in a web browser, etc.). In some implementations, the cloud APIs 2040 can be utilized to communicate with one or more contractor applications 2052, which may be executing on a device of a contractor that is servicing one or more of the building subsystems 122 of the building.

The system 2000 can include one or more remote applications 2048, which may be executed by one or more user devices 176 in communication with the cloud computing system via a network (e.g., the network 1904 described in FIG. 19, etc.). The remote applications 2048 can include web browsers, native applications, or applications specific to particular edge devices or edge device gateways 2002, among others. The remote applications 2048 can be utilized to present a cloud user interface 2050 (e.g., via one or more web browsers or native applications). The cloud user interface 2050 can be provided via one or more of the cloud APIs 2040, and can enable control of the building subsystems 122 or the edge device gateway 2002, display data from the building subsystems 122 or the edge device gateway 2002, or enable configuration of the building subsystems 122 or the edge device gateway 2002.

In some implementations, the cloud user interfaces 2050 can provide interactive graphical user interface elements that enable provision of, updates to, or configuration of any type of software, firmware, operating system data, or configuration data of the building subsystems 122 in communication with the edge device gateway 2002. The cloud user interfaces 2050 may enable remote management of any number of edge device gateways 2002, and respective building subsystems 122 in communication therewith, at an enterprise level. For example, the cloud user interfaces 2050 may enable management, upgrading, configuration, or access to any number of edge device gateways 2002 of any number of buildings. Graphical user interfaces can be provided via the cloud user interfaces 2050 that enable selection and management of one or more edge device gateways 2002.

In some implementations, the interactive graphical user interfaces can provide interactive elements to enable selection of one or more edge device gateways 2002 and/or one or more building subsystems 122 in communication with one or more edge device gateways 2002. The graphical user interfaces provided by the cloud user interfaces 2050 can be used to configure, update, or otherwise access the edge gateway(s) 2002 or building subsystems 122. The graphical user interfaces can provide elements to select, upload, or otherwise provide firmware, software, or components to the building subsystem(s) 122 and/or the edge device gateway(s) 2002 to facilitate onboarding, upgrading/updating, or other configuration functionality.

Various information relating to an update/configuration process initiated via the cloud user interfaces 2050 can be presented to the user based on messages received from the building subsystems 122 and/or the edge device gateway 2002, including but not limited to confirmation messages, progress messages, error messages, or other notifications. In the event of errors, the cloud user interfaces 2050 can present notifications that indicate a cause of a configuration/update error, which may include or be associated with a respective error code. In some implementations, the cloud user interfaces 2050 can be utilized to upgrade, update, or otherwise configure the edge device gateway 2002 or the components thereof.

The contractor applications 2052 can be executed by one or more user devices 176 in communication with the cloud computing system via a network (e.g., the network 1904 described in FIG. 19, etc.). The contractor applications 2052 can be executing on a device of a contractor that is servicing one or more of the building subsystems 122 or the edge device gateway 2002 of the building. The contractor applications 2052 can provide, for example, low-level configuration functionality to diagnose or configure the functionality of the edge device gateway 2002. In some implementations, the contractor applications 2052 can provide additional administrative functionality that is otherwise absent from the cloud user interface 2050. In some implementations, the contractor applications 2052 can implement similar functionality as the cloud user interfaces 2050 to configure/update the building subsystems 122.

The remote applications 2048 can include one or more local user interfaces 2054, which may be executed by one or more user devices 176 in communication with the edge device gateway 2002 via a network (e.g., the network 1904 described in FIG. 19, etc.). The local user interfaces 2054 can include web browsers, native applications, or applications specific to particular edge devices or edge device gateways 2022, among others. The local user interfaces 2054 can be utilized to present a user interface provided by the webserver 2028 of the edge device gateway 2002. The local user interfaces 2054 can enable control of the building subsystems 122 or the edge device gateway 2002, display data from the building subsystems 122 or the edge device gateway 2002, or enable configuration of the building subsystems 122 or the edge device gateway 2002. The local user interfaces 2054 can be provided via a local network, rather than via the cloud platform 106. In some implementations, the local user interfaces 2054 can be provided via the Internet. In an embodiment, the one or more local user interfaces 2054 themselves may be accessible via one or more remote connections provided via the cloud platform 106.

In some implementations, the local user interfaces 2054 can provide interactive graphical user interface elements that enable provision of, updates to, or configuration of any type of software, firmware, operating system data, or configuration data of the building subsystems 122 in communication with the edge device gateway 2002. For example, the interactive graphical user interface elements may be displayed by any number of graphical user interfaces presented via the local user interfaces 2054, and can be utilized to select one or more building subsystems 122 in communication with the edge device gateway 2002 to configure, update, or otherwise access the selected building subsystems 122. The graphical user interfaces can provide elements to select, upload, or otherwise provide firmware, software, or components to the building subsystems 122 to facilitate onboarding, upgrading/updating, or other configuration functionality.

Various information relating to an update/configuration process initiated via the local user interfaces 2054 can be presented to the user based on messages received from the building subsystems 122 via the edge device gateway 2002, including but not limited to confirmation messages, progress messages, error messages, or other notifications. In the event of errors, the local user interfaces 2054 can present notifications that indicate a cause of a configuration/update error, which may include or be associated with a respective error code. In some implementations, the local user interfaces 2054 can be utilized to upgrade, update, or otherwise configure the edge device gateway 2002 or the components thereof.

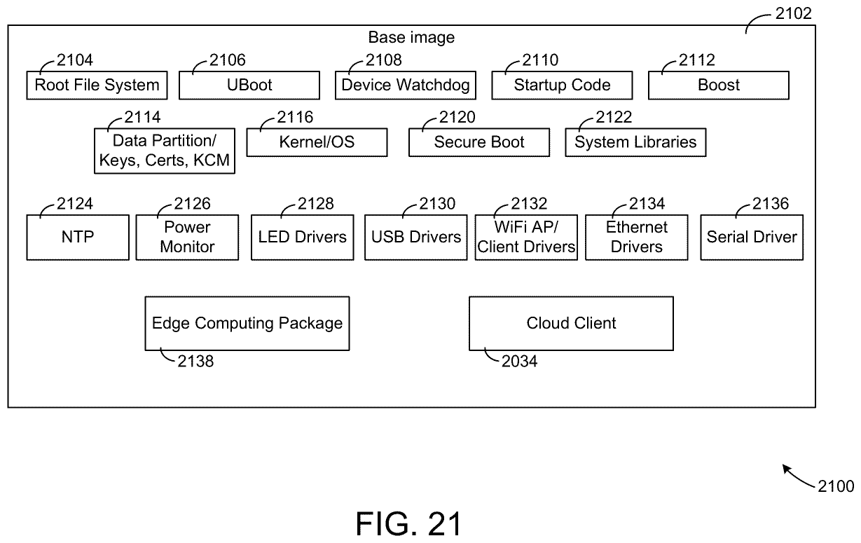

Prior to discussing the functionality of the edge device gateway 2002, an example base image (e.g., one or more of the configuration images stored or managed by the configuration manager 1928) will be described in connection with FIG. 21. Referring to FIG. 21 in the context of the components described in connection with FIG. 20, illustrated is a block diagram 2100 of an example base image 2102 that may be implemented by the building device gateway 2002 described in connection with FIGS. 20, in accordance with one or more implementations. The base image 2102 may be a serialized copy of the entire state of a computer system stored in a non-volatile format. For example, the base image 2012 can include a root file system 2104, which may include a file system and a directory structure for storing one or more of the files described herein.

The base image 2102 can include a boot loader, shown here as UBoot 2106. The UBoot 2106 can include software written in machine code that loads the operating system 2116 into RAM during the boot process, and initiates execution of the operating system 2116. The base image 2102 may specify that UBoot 2106 be stored at a predetermined location in the memory of the edge device gateway 2002 with which the base image 2102 is configured.

The base image 2102 may include a device watchdog 2108. The device watchdog 2108 can be utilized to automatically reset the edge device gateway 2002 if certain conditions are not met. For example, the device watchdog 2108 can be a script or other processor-executable software that monitors the configuration of one or more containerized gateway components as the gateway components are initialized by the operating system 2116. The device watchdog 2108 can determine that a particular container has an error or has become unresponsive during initialization or execution. The device watchdog 2108 can generate a record of the error or unresponsive container, and may automatically reset the edge device gateway 2002. In some implementations, the device watchdog 2108 can transmit a message to the cloud platform 106 or a user device 176. In some implementations, the device watchdog 2108 can request automatic reconfiguration (e.g., re-flashing the base image 2102, upgrading one or more unresponsive containers, etc.) of the edge device gateway 2002 in response to detecting one of the aforementioned conditions.

The base image 2102 may include startup code 2110, which may include scripts or other processor-executable instructions that initialize one or more containerized gateway components and other software implemented by the edge device gateway 2002. When the operating system 2116 of the edge device gateway 2002 is initialized, the operating system 2116 may execute one or more of the startup scripts 2110 to initialize the containerized gateway components. For example, the edge device gateway 2002 may execute the startup scripts 2110 to initiate a Docker compose, which may cause various gateway component containers (e.g., the building device interface container 2006, the processing container 2008, etc.) to become initialized. Additionally, the startup scripts 2110 may initiate the virtual bus 2004, which may include generating one or more virtual IP networks with which the containerized gateway components can communicate.

The base image 2102 can include one or more libraries, such as the Boost libraries 2112, which provide a suite of functions and computer-executable instructions that can be utilized to implement the various functionalities of the edge device gateway 2002. The base image 2102 can include the system libraries 2122, which may include libraries that provide low-level access to system functionalities of the edge device gateway 2002. The base image 2102 can include one or more encrypted keys, certificates, or key continuity management (KCM) functionalities, which may be stored in a separate data partition 2114.

The base image 2102 can include the operating system 2116, which may include a kernel, machine code, or other processor-executable instructions that enable management of the various processes that may execute on the edge device gateway 2002. The operating system 2116 can coordinate scheduling, initiating, and terminating different processes in both user space and kernel space. The operating system 2116 can manage memory for the various components of the edge device gateway 2002. The operating system 2116 can perform system-level management of hardware devices, including loading, implementing, and executing device drivers for various hardware interfaces of the edge device gateway 2002. Examples of such drivers include the light emitting diode (LED) drivers 2128, the Universal Serial Bus (USB) drivers 2130, the WiFi Access Point (AP)/client drivers 2132, the Ethernet drivers 2134, and the serial driver 2136, among others. The operating system 2116 may also execute or coordinate various protocols, including the Network Time Protocol (NTP) 2124. The NTP 2124 can be utilized to synchronize time over a network (e.g., by transmitting a request for the current time to a server and setting a system time to the value retrieved from the server). The operating system 2116 can implement one or more power monitors 2126, which may monitor the voltage or usage of power from one or more batteries or other external power sources.

The base image 2102 may include software, scripts, libraries, or other processor-executable instructions that can implement a node-based network. For example, the base image 2102 may include information relating to a topology of a network, or information relating to the implementation of one or more network interfaces or protocols. The base image 2102 can include secure boot 2120 software, which may include software, scripts, libraries, or other processor-executable instructions that can implement the Unified Extensible Firmware Interface (UEFI) Secure Boot protocol. The Secure Boot protocol can verifies that the code loaded by the firmware on a motherboard is the intended code for the edge device gateway 2002.

The base image 2102 can include the edge computing package 2138. The edge computing package 2138 can include any of the containers or other software implemented by the edge device gateway 2002 as described herein. The edge computing package 2138 can include, for example, software that implements the virtual bus 2004, software that implements the DM agent 2030, software that implements an analytical engine, a logger, a log rotator (e.g., implementing a log rotation policy), and software that initializes the containerized components described herein (e.g., the cloud proxy 2036, the cloud connector 2038, the building device interface container 2006, the processing container 2008, the CoV subscriber 2022, etc.). For example, the edge computing package 2138 may include a container initialization script (or other processor-executable instructions), configuration data for the containers, among other data related to the containers as described herein. The base image 2102 can include additional software that implements the functionality of the DM agent 2030 of the edge device gateway 2002.

Referring back to FIG. 20, the edge device gateway 2002 can include the DM agent 2030. The DM agent 2030 may not be a containerized component of the edge device gateway 2002, and may instead be installed and managed separately from the containerized components described herein. The DM agent 2030 can perform host operating system-level interactions. Portions of the DM agent 2030 may be containerized, and portions of the DM agent 2030 may not be containerized, in some implementations. The DM agent 2030 can manage a container environment (e.g., a Docker Compose) for the various containerized components of the edge device gateway 2002. The DM agent 2030 can configure credentials (e.g., a common shared secret, OAuth tokens, etc.) for retrieving one or more configuration images from the configuration manager 1928.

The DM agent 2030 can communicate with the configuration manager 1928 to retrieve information such as one or more containerized gateway components, gateway component configurations, or configuration images stored or managed by the configuration manager 1928, and deploy said information on the edge device gateway 2002. The DM agent 2030 can further execute or implement one or more remote management commands received from the configuration manager 1928. Some example remote management commands include rebooting the edge device gateway 2002, creating, modifying, or removing configuration settings of one or more components of the edge device gateway 2002, or triggering discovery operations remotely, among others. The DM agent 2030 can implement one or more network functionalities described in connection with the configuration manager 1928 in FIG. 19, for example, to provide isolation of an edge device gateway 2002 on local networks or external networks, as well as enabling secure, remote access to the functionality of the edge device gateway 2002.

In some implementations, the DM agent 2030 can implement additional containers other than those shown in FIG. 20. For example, the DM agent 2030 can implement one or more analytical engines, machine learning models, or Complex Event Processing (CEP) modules that have the ability to monitor or subscribe to messages from the virtual bus 2004. Such components can be utilized to analyze and make decisions based on configured logic, and publish back the analytical results on the virtual bus 2004 using a subscriber-publisher protocol, described in further detail herein. Such processing can be performed on information “in flight” (e.g., recently received from the building subsystems 122). In some implementations, data from the building subsystems is stored as historical data, for example, if a larger data set is required by the analytical modules or containerized components.

The edge device gateway 2002 can include the cloud connector 2038, which can send and receive one or more messages to and from the cloud interface 2042 of the cloud platform 106. The cloud connector 2038 may utilize one or more encrypted keys, credentials, or other authorization mechanisms to establish secure communication channel(s) with the cloud platform 106. The cloud connector 2038 can act as an interface between the cloud platform 106 and the containerized gateway components that communicate via the virtual bus 2004. The cloud connector 2038 can receive commands provided from one or more of the remote applications 2048 via the cloud APIs 2040, for example. The cloud connector 2038 may further provide data via the cloud interface 2042, which can communicate the data for display to the remote application(s) 2048 via the cloud APIs 2040.

In some implementations, the DM agent 2030 can update, modify, remove, or otherwise manage any low-level software that can be implemented by the edge device gateway 2002. For example, the DM agent 2030 can update, modify, remove, or manage device firmware, low-level drivers, system configurations, or host-specific applications that are separate from the containerized gateway components described herein. As shown, the DM agent 2030 can be in communication with the configuration manager 1928, for example, via a network. The DM agent 2030 can retrieve, implement, manage, or execute any of the commands or data received or requested from the configuration manager 1928.

The edge device gateway 2002 can instantiate, implement, execute, or otherwise provide the virtual bus 2004. The virtual bus 2004 can be a virtually defined network bus managed by the operating system or other software (e.g., software retrieved and implemented using the DM agent 2030). The virtual bus 2004 can be a virtual IP network bus, which may enable one or more of the containerized gateway components (e.g., the cloud proxy 2036, the cloud connector 2038, the building device interface container 2006, the processing container 2008, the CoV subscriber 2022, etc.) to communicate with one another. Each container (or interface of a container) that communicates via the virtual bus 2004 may be associated with a corresponding virtual IP address (e.g., assigned by the software managing the virtual bus 2004, etc.). To facilitate communication between the containerized gateway components, the software managing the virtual bus 2004 routes IP packets directed to the container having the IP address indicated in the header of the IP packet.

In some implementations, the virtual bus 2004 can implement a publish-subscribe messaging pattern. Publish-subscribe is a messaging pattern where senders of messages (e.g., various containers or software components transmitting messages via the virtual bus 2004), called publishers, do not program the messages to be sent directly to specific receivers, called subscribers. Instead, the sender containers or components can categorize published messages into classes (sometimes referred to herein as “topics”) without knowledge of which subscribers, if any, there may be. Subscriber containers or components (e.g., containers or components that can receive messages via the virtual bus 2004) can each be associated with one or more topics to which those containers or components “subscribe.”

Such containers or components may only receive messages having topics matching those that they subscribe to, without knowledge of which publishers, if any, there are. Publish-subscribe messaging patterns provide greater network scalability and a more dynamic network topology, with a resulting decreased flexibility to modify the publisher and the structure of the published data. This enables multiple containers to be implemented in a scalable way, and in a manner that is agnostic to other containers that may be implemented by the edge device gateway 2002. In the publish-subscribe model, subscribers may receive a subset of the total messages published. In a topic-based system, messages are published to “topics,” or named logical channels. Subscribers in a topic-based system will receive the messages published to the topics to which they subscribe. The publisher is responsible for defining the topics to which subscribers can subscribe (e.g., via one or more internal configuration settings, configuration settings received via the cloud platform, etc.).

The containerized components of the edge device gateway 2002 described herein may implement a Smart Equipment Messaging (SEM) protocol, which may be implemented on top of HTTP. Other types of messaging protocols may also be utilized, such as RabbitMQ, ZeroMQ (which may, for example, include additional extensions corresponding to the cloud platform 106), MQTT, HTTP, Kafka, etc.). In some implementations, the virtual bus 2004 can implement additional messaging patterns, such as point-to-point Remote Procedure Call (RPC) or bulk transfer messaging protocols. The virtual bus 2004 (or the containers that communicate via the virtual bus 2004) can translate various different building device protocols (e.g., OPC, UA, Modbus, BACnet, etc.) into a common schema (e.g., the SEM protocol, other messaging protocols described herein, etc.)

Each of the containerized gateway components (e.g., the cloud proxy 2036, the cloud connector 2038, the building device interface container 2006, the processing container 2008, the CoV subscriber 2022, etc.) described herein may be implemented using one or more separate containers. Containers, as described herein, is a software package for one or more applications that includes code, and all its dependencies, so the one or more applications can execute quickly and reliably from one computing environment to another. Containers can be standalone, executable packages of software that includes code, runtime, system tools, system libraries and configuration settings. Containers can be distributed as “container images,” which can be loaded and executed by a container manager of the edge device gateway 2002. One example of a type of container image is a Docker container image. Each container may maintain its own storage. In some implementations, scripts or code that instantiate multiple containers can generate a shared region of memory called one or more “volumes,” which may be a location in memory that can be accessed by one or more containers with read access, write access, or read and write access. Read and write permissions for one or more volumes can be specified in the configuration of the respective container, for from other configuration settings.

One advantage of using containers is that containerized software will always run the same, regardless of the infrastructure or conflicting dependencies that may be present on the edge device gateway 2002. This is because containers can isolate software from its environment and ensure that it works uniformly despite differences, for instance, between development and staging. To communicate with other containers, software, or hardware, each container described herein can implement one or more interfaces. The interfaces may be virtual network interfaces (e.g., that communicate with the virtual bus 2004, etc.). In some implementations, a container may access and communicate with one or more hardware interfaces of the edge device 2002, such as a serial interface, a USB interface, an Ethernet interface, or one or more wireless interfaces, among others.

In some implementations, one or more of the containers described herein can communicate with a hardware abstraction layer (HAL)/hardware manager 2020 implemented by the operating system of the edge device gateway 2002. The HAL/hardware manager 2020 includes software components that enables a computer operating system or other containers of the edge device gateway 2002 to interact with a hardware device (e.g., an interface, an external device communicatively coupled to the edge device gateway 2002, etc.), at a general or abstract level rather than at a detailed hardware level. In doing so, the containers described herein can access and control hardware interfaces of the edge computing device, including visual indicators (e.g., display devices, LEDs, etc.), auditory indicators (e.g., alarms, speakers, etc.), network interfaces, or serial interfaces. In some implementations, the HAL/hardware manager 2020 is itself implemented as a container. Additionally, the HAL/hardware manager 2020 is container agnostic, and can be utilized to enable various containers deployed to and executed by the edge device gateway 2002 to communicate with various hardware (e.g., GPIO, LEDs, display devices, other input/output hardware such as interfaces, etc.) in a hardware or software agnostic manner.

The edge device gateway 2002 can implement or execute the CoV Subscriber 2022, which may be implemented and executed as a container in communication with the virtual bus 2004. The CoV subscriber 2022 can manage subscriptions to message topics from multiple sources (e.g., containers or software components that transmit messages via the virtual bus 2004). In some implementations, the CoV subscriber 2022 can implement caching of the latest value from each subscribed topic reference. This enables each container that communicates via the virtual bus 2004 to publish CoVs without having to track the dynamic subscriptions of the containers implemented by the edge device gateway 2004, and frees each container from caching the latest CoV. The CoV subscriber 2022 can subscribe to various CoV data sources (containers for integrations, analytics, etc.) to maintain its cache of the latest value. The CoV subscriber 2022 can cache simple data types (e.g., enums, floats, strings, etc.) or other data types.

The edge device gateway 2002 can implement or execute the cloud proxy 2036, which may be implemented and executed as a container in communication with the virtual bus 2004. The cloud proxy 2036 can implement logic to conserve Internet bandwidth and map locally generated messages from the containers via the virtual bus 2004 to or from the requirements of the cloud interface 2042. For example, the cloud proxy 2036 can transform cloud-formatted cloud-to-device commands into HTTP commands used by the containers implemented by the edge device gateway 2002, to control or implement said commands. The cloud proxy 2036 can further add headers required by the cloud interface 2042 to outgoing messages. In some implementations, the cloud proxy 2036 can accumulate messages from the various components of the edge device gateway 2002, and can transmit the messages to the cloud platform 106 periodically (e.g., once every 30 seconds, etc.).

The edge device gateway 2002 can implement or execute the building device interface container 2006, which may be implemented and executed as a container in communication with the virtual bus 2004. The building device interface container 2006 may also communicate directly with the processing container 2008, for example, via the bus interfaces(s) 2010 using a MUDAC API. The building device interface container 2006 can include the bus interfaces 2010, interlock objects 2012, alarming objects 2014, and scheduling objects 2016.

The building device interface container 2006 can include one or more device interfaces 2018, which may include one or more hardware interfaces, such as RS-485 serial interfaces, USB interfaces, Ethernet interfaces, wireless interfaces, or general serial interfaces, that can be utilized to communicate with one or more of the building subsystems 122. The building device interface container 2006 can include one or more bus interface(s) 2010, which may include one or more MUDAC APIs, or other communication APIs, which enable the building device interface container 2006 to communicate directly with the capability provider 2024 of the processing container 2008. The building device interface container 2006 can communicate with the HAL/hardware manager 2020 container, for example, to activate one or more LEDs or interface with hardware components of the edge device gateway 2002. The interlock objects 2012, the alarming objects 2014, and the scheduling objects 2016 can be Object Runtime Environment (ORE) Objects, and may be utilized to configure operation of the building subsystems 122.

The building device interface container 2006 can automatically discover Master-Slave/Token-Passing (MSTP) equipment over wired or wireless networks, and can interact with and send/receive data and commands to and from multiple BACnet controllers in a building network. The building device interface container 2006 can implement a generic API to allow interaction with the BACnet MSTP equipment using the standardized messages transmitted via the virtual bus 2004. The building device interface container 2006 can implement a MUDAC API, which enables display of information via the processing container 2008 (e.g., using the web server 2028, etc.), and to interact with features of the ORE and Smart Equipment. The MUDAC API interface between the building device interface container 2006 and the processing container 2008 can be leveraged via the virtual bus 2004, for example, using a Rust Bus SDK.

In doing so, the building device interface container 2006 can implement the both the MUDAC API and a BACnet integration API as part of the bus interface(s) 2010, both of which can interface with the virtual bus 2004 and software components and data of the building device interface container 2006. For example, the building device interface container 2006 can implement the ORE Framework, including ORE core assets, ORE objects, base libraries, point mappers, BACnet communication frameworks, equipment mappers, data models, and integrations. Additionally, the building device interface container 2006 can implement discovery functionality as described herein by interfacing with the building subsystems 122. The building device interface container 2006 can execute a protocol engine to carry out building protocols, store a dictionary of building data, store a template cache for the container, implement an IP data link, and implement a CoV manager to manage CoVs produced by the building subsystems 122. The building device interface container 2006 may also interface with one or more operating system APIs. The functionality implemented by the building device container 2006 may include any of the functionalities of the data access layer described in connection with U.S. patent application Ser. No. 17/750,824, filed May 23, 2022, the contents of which is incorporated by reference herein.

In some implementations, the building device interface container 2006 can perform various configuration, update/upgrade, or software modification operations of the building subsystems 122 via the device interface 2018. For example, the building device interface container 2006 can receive instructions, commands, or data indicating that one or more of the building subsystems 122 in communication with the building device interface container 2006 are to be updated/upgraded, configured, onboarded, or otherwise accessed. In response to said data, the building device interface container 2006 can provide software, processor-executable instructions, components, or configuration data the indicated building subsystems 122 via the device interface 2018.

In one non-limiting example, the building device interface container 2006 can update firmware of an AHU (e.g., one of the building subsystems 122) using a suitable communication protocol via the device interface 2018, such as via BACnet. In doing so, the building device interface container 2006 can push data for the firmware updates via the BACnet protocol to the AHU, and receive progress data, notification data, or a confirmation that the data update/transfer has been completed. The building device interface container 2006 can then provide indications of progress/completion/errors for the data transfer process to the AHU via the virtual bus 2004 to the cloud platform 106, in one example. In some implementations, the building device interface container 2006 can receive/provide information for updating/configuring one or more building subsystems 122 via a user interface container (e.g., the processing container 2008), which may provide one or more local user interfaces 2054, as described herein).

The edge device gateway 2002 can implement or execute the processing container 2008, which may be implemented and executed as a container in communication with the virtual bus 2004. The processing container 2008 can include any type of container or set of containers or components that can process information received via the virtual bus 2004. Although one processing container is shown here, it should be understood that any number of processing containers 2008 may be implemented by the edge device gateway 2002.

In one example, the processing container 2008 can be or include a graphical user interface container, as shown in FIG. 20. In some implementations, the processing container 2008 can be or include a reporting container that generates and provides reports based on the data retrieved from the building subsystems 122. The reports may include reports of internal data processed by the edge device gateway 2002, and may include diagnostic data, versioning data, or any data stored or otherwise accessed by the edge device gateway 2002, the components thereof, the cloud platform 106, or other devices in communication with the edge device gateway 2002 or the cloud platform 106.

In some implementations, the processing container 2008 can include an analytical engine container. The analytical engine container can include the processing container comprises one or more of a graphical user interface container, an analytical engine container, an edge management container, a logs management container, a fault detection and diagnostic container, an interlocks or control logic container, an energy management container, a reports generator container, a building health container, an equipment health container, a lighting stack container, an input/output management container, a schedule management container, an alarms management container, a trends management container, a chiller plant optimization container, a roof-top unit (RTU) energy optimization container, a network management container, and a security management container, among others. It should be understood that the edge device gateway 2002 can implement any number and type of processing container 2008, each of which may communicate via one or more virtual buses 2004.

In some implementations, the processing container 2008 can include an analytical edge container. The analytical edge container can be any type of component that can process data received from one or more building subsystems 122, the edge device gateway 2002, the cloud platform 106, or data received via other user interfaces or computing devices to generate analytics data. For example, the analytical edge container can execute one or more machine-learning/artificial intelligence models included in the analytical edge container. The analytical edge container can execute any suitable machine-learning/artificial intelligence framework for executing any type of machine-learning model or application on the edge device gateway 2002. Such machine-learning models may be provided to the edge device gateway 2002 and/or the analytical edge container via the cloud platform or via another computing system in communication with the edge device gateway, in some implementations.

In some implementations, the processing container 2008 can include an edge management container. The edge management container can be any type of component that can add, update/upgrade, or remove containers or other components executing on the edge device gateway. In some implementations, the edge management container can perform additional device management functionality for the edge device gateway 2002. For example, in some implementations, the edge management container can provide functionality for remotely rebooting or controlling the edge device gateway, remotely starting, stopping, or restarting one or more containers or components of the edge device gateway 2002, or collecting diagnostic information from the edge device gateway 2002 or components/containers thereof.

In some implementations, the processing container 2008 can include a logs management container. The logs management container can provide functionality relating to managing logs generated by the edge device gateway 2002 or the components/containers thereof. For example, the logs management container can provide configuration for log rotations, trace collection, log size limits, and can coordinate and manage remote connections to access logs from different graphical user interfaces or devices (e.g., the cloud platform 106, other computing systems in communication with the edge device gateway 2002, etc.).

In some implementations, the processing container 2008 can include a fault detection and diagnostic container. The fault detection and diagnostic container can be any type of component that can provide early fault detection and diagnostic capabilities for the edge device gateway 2002. For example, the fault detection and diagnostic container can provide capabilities for predictive maintenance. In some implementations, the fault detection and diagnostic container can generate service notifications for field technicians, which may be accessed and/or provided to/from the cloud platform 106 or other computing systems in communication with the edge device gateway 2002. In some implementations, the fault detection and diagnostic container can automatically generate service notifications or tickets in response to detecting or predicting that a building subsystem 122 has or is likely to experience a fault. The fault detection and diagnostic container can monitor various diagnostic signals from the building subsystems 122 can generate notifications for predictive maintenance accordingly. In one example, the fault detection and diagnostic container can identify predicted maintenance for a compressor if the compressor charge detecting as falling below a predetermined threshold, and generate a corresponding service ticket indicating a predicted failure time for the building subsystem 122.

In some implementations, the processing container 2008 can include an interlock or control logic container. The interlock or control logic container can be any type of component that can provide interlocks or logical operation capabilities for the building subsystems. One example of logic operation capabilities include rule-based logic operations, such as if-this-then-that (IFTTT) logic. For example, if a temperature input for a building subsystem 122 is greater than a predetermined value (e.g., 72 deg F.), then operate a building subsystem 122 (e.g., a fan) according to a particular configuration (e.g., at medium speed). Any number of logical expressions, rules, or data may be utilized in the operational control functionality of the interlock or control logic container. Further, the interlock or control logic container may be configured or otherwise accessed via the cloud platform 106 or other computing systems in communication with the edge device gateway 2002 to create, modify, delete, or otherwise access the logical operations maintained by the interlock or control logic container.

In some implementations, the processing container 2008 can be or include an energy management container, which can track the energy expenditure of the edge device gateway 2002 and/or the building subsystems 122 in communication with the edge device gateway 2002. For example, the energy management container may track, store, and report energy expenditure of one or more building subsystems 122 to the cloud platform 106, in some implementations. In one example, the energy management container can communicate with one or more controllers, such as energy meters, flow meters, or gas meters, to track energy usage in a building for which the edge device gateway 2002 is configured. In some implementations, the energy management container can identify outliers or other anomalous energy readings and report them or provide options to optimize energy usage in the building. In some implementations, the energy management container can execute automatic actions to reduce usage to a predetermined or provided limit. Such actions may include controlling one or more of the building subsystems 122 according to predetermined rules.

In some implementations, the processing container 2008 can include a reports generator container. The reports generator container can be any type of component that can generate reports or other collections of information for the building subsystems 122 or the edge device gateway 2002. For example, the reports generator container can, in some implementations, generate reports of building subsystem 122 information on a scheduled basis. In one example, the reports generator container can generate a report message (e.g., an electronic message, an email, a text message, etc.) that provides information relating to any device trends, alarms, faults, service conditions, as well as building health reports for the building, among other reporting data. The reports generator container can further provide customized reports based on settings provided by users via the cloud platform 106 and/or other computing systems in communication with the edge device gateway 2002.

In some implementations, the processing container 2008 can include a building health container, which can track and report the operational health of the building subsystems 122 of a building in communication with the edge device gateway 2002. The building health container may determine and provide service status data, maintenance schedule data, operating status data, or other information received and/or processed from the building subsystems 122 in communication with the edge device gateway 2002 to the cloud platform 106 and/or a local user interface 2054 as described herein. The processing container 2008 may be provided to perform any suitable processing operation on data communicated via the virtual bus 2004. In one example, the building health container can monitor air quality in a building by communicating with one or more volatile organic compound (VOC) sensors or filter sensors to provide notifications of bad air quality or faulty/dirty filters.

In some implementations, the processing container 2008 can include an equipment health container. The equipment health container can be any type of component that can track and report the operational health of the building subsystems 122 of a building in communication with the edge device gateway 2002. The building health container may determine and provide service status data, maintenance schedule data, operating status data, or other information received and/or processed from the building subsystems 122 in communication with the edge device gateway 2002 to the cloud platform 106 and/or a local user interface 2054 as described herein. In one example, the equipment health container can track and report faults detected in one or more of the building subsystems 122 or the edge device gateway 2002. For example if a building subsystem 122 is reporting a fault condition at a frequency greater than a threshold within a predetermined time period, such as the firmware of the building subsystem 122 not being up to date, the equipment health container can generate and provide a notification to transmit to a service technician or facility operator (e.g., via the cloud platform 106, via one or more devices in communication with the edge device gateway 2002, etc.) In some implementations, the equipment health container can determine whether any building subsystems 122 have out of date software or if any building subsystems 122 include any faulty parts (e.g., a failed sensor).

In some implementations, the processing container 2008 can include a lighting stack container, which can provide control operations and interfaces for lighting controllers in communication with the edge device gateway 2002 (e.g., as one or more of the building subsystems 122). For example, the lighting stack container may implement a full lighting controller software stack that provides API endpoints or other software interfaces for controlling lighting systems of a building. The lighting stack container may enable configuration of lighting schedules for the building, proximity sensors, or other lighting control functionality.

In some implementations, the processing container 2008 can include an input/output management container. The input/output management container can be any type of component that can provide management and control functionality for one or more input/output controllers in communication with the edge device gateway 2002 (e.g., as one or more of the building subsystems 122). For example, the input/output management container can perform various input/output actions, including activating or deactivating one or more circuits (e.g., refrigeration circuits, door sensors, etc.) or otherwise accessing and controlling any type of input/output device. The input/output management container can be configured or otherwise controlled via messages from the virtual bus 2004, which may be provided via the cloud platform 106 or other computing systems in communication with the edge device gateway 2002.

In some implementations, the processing container 2008 can include a schedule management container. The schedule management container can be any type of component that can provide scheduling operations for standard input/output interfaces of the edge device gateway 2002. The schedules implemented by the schedule management container can be used to activate or deactivate various input/output interfaces of the edge device gateway 2002 according to predetermined time periods. In some implementations, the schedules can be used to activate or deactivate any type of general-purpose input/output of the edge device gateway 2002 to perform various control actions with the building subsystems 122 of the building. For example, the schedule management container can set any configured value on the outputs of the edge device gateway 2002 according to schedules maintained by the schedule management container. Schedules of the schedule management container can be configured via the cloud platform 106 or via other computing systems in communication with the edge device gateway 2002.

In some implementations, the processing container 2008 can include an alarms management container. The alarms management container can be any type of component that can generate manage or generate alerts in response to conditions of the building. For example, the alarms management container may be in communication with other containers implemented by the edge device gateway 2002 that report various information or notifications relating to the building or the building subsystems 122. In some implementations, the alarms management container can monitor alarms produced by various building subsystems 122, and automatically report the alarms to a service technician, building operator, the cloud platform 106, and/or other computing systems in communication with the edge device gateway 2002. The alarms management container can be configured via the cloud platform 106 and/or other computing systems in communication with the edge device gateway 2002.

In some implementations, the processing container 2008 can include a trends management container. The trends management container can be any type of component that can perform long-term storage of various information provided via the building subsystems 122 to derive trends relating to building operations. For example, the trends management container can store datapoints captured via sensors of the building and store said datapoints in association with corresponding timestamps and device/space identifiers. The trends management container can, in some implementations, store said datapoints remotely via the cloud platform 106. In some implementations, the trends management container can store data locally at the edge device gateway 2002. In some implementations, the trends management container generate one or more tables, graphs, or reports indicating the stored data from the building subsystems 122. The trends management container can be configured via the cloud platform 106 and/or other computing systems in communication with the edge device gateway 2002 to start, stop, or schedule storage of datapoints from the building subsystems 122, as well as to select from which building subsystems 122 data is to be stored.

In some implementations, the processing container 2008 can include a chiller plant optimization container. The chiller plant optimization container can be any type of component that can monitor and optimize chiller operations to ensure optimal chiller performance. In such implementations, the chiller plant optimization container can access and process data from one or more chillers and identify operations or actions that can be performed to optimize operations of said building subsystems 122. For example, the chiller plant optimization container can automatically control chiller run times as well as minimum on and off times. In some implementations, the chiller plant optimization container can be manually configured to control various operations of the chiller via the cloud platform 106 and/or other computing systems in communication with the edge device gateway 2002.

In some implementations, the processing container 2008 can include an RTU energy optimizer container. The RTU energy optimizer container can be any type of component that can communicate with one or more RTUs of a building to control building to optimize various parameters and energy consumption of the building. In some implementations, the RTU energy optimizer container can control setpoints based on both internal feedback such as input setpoints, return air temperatures, saturated air temperatures, among other operational data. In some implementations, the RTU energy optimizer container can access external feedback from energy providers such as time of service, energy rates, or demand response, among others, to provide real-time control of RTU operations.

In some implementations, the processing container 2008 can include a network management container. The network management container can be any type of component that can provide network monitoring and reporting functionality to monitor building network operations. The network management container can monitor any aspect of any type of network with which the edge device gateway 2002 is in communication, including but not limited to MSTP bus operational status, BACnet IP network congestion/health, as well as device discovery information or other network information. Data accessed or generated by the network management container can be accessed via the cloud platform 106 and/or other computing systems in communication with the edge device gateway 2002.

In some implementations, the processing container 2008 can include a security management container. The security management container can be any type of component that can provide network security functionality. For example, the security management container can monitor any network activity within the edge device gateway 2002 and can implement various encryption techniques to ensure secure transmission of data between the edge device gateway 2002 and the cloud platform 106. In some implementations, the security management container can control network capabilities within the edge device gateway 2002 and may restrict container or component communications in response to detecting security vulnerabilities.

In the example shown in FIG. 20, the processing container 2008 implements a graphical user interface container, which can provide a webserver 2028 and local user interfaces 2054 as shown. The processing container 2008 can implement a user interface backend 2026, which can translate messages received from the building device interface container 2006 via the capability provider 2024 into format usable by the webserver 2028 (e.g., one or more HTML files, PHP files, JavaScript files, etc.). For example, the user interface backend 2026 can format raw data (e.g., sensor data, diagnostic data, log messages, metadata, data relating to control schedules, fault data, data from the cloud platform 106, state data relating to the edge device gateway 2002, operating system data, information relating to a status of one or more containers implemented by the edge device gateway 2002, etc.) received from the building device interface container 2006 or the virtual bus 2004 into one or more tables, databases, or other formats that can be displayed in a web-based interface. The user interface backend 2026 can both format the raw data and provide the formatted data (e.g., provide access to files generated from the raw data) to the web server 2028 for display as the local user interface 2054. In doing so, the user interface backend 2026 can generate a graphical user interface based on the data from the one or more building devices.

The processing container 2008 can implement the capability provider 2024, which can include software, scripts, or other processor-executable instructions that interface with the HAL/hardware manager 2020 and the building device interface container 2006. For example, the capability provider 2024 may communicate using one or more MUDAC APIs implemented by the bus interface(s) 2010 of the building device interface container 2006. The capability provider 2024 can receive requests from the user interface backend 2026, which may be generated in response to interactions with user interface elements of webpages provided via the webserver 2028.

For example, if an operator requests to view data relating to a particular building device (e.g., one or more building subsystems 122 or any other building computing device described herein, etc.), the user interface backend 2026 can generate a corresponding request for that data, and provide the request to the capability provider 2024. The capability provider 2024 can generate one or more commands to retrieve or access that data, and provide said commands via the MUDAC APIs of the building device interface container 2006. The building device interface container 2006 can execute the commands to retrieve the requested data, and provide the requested data to the processing container 2008 via the MUDAC APIs. Then, the capability provider 2024 can provide the raw data to the user interface backend 2026, which can format it for display via the webserver 2028, as described herein. Although the communication between the processing container 2008 and the building device interface container 2006 are described as MUDAC APIs, it should be understood that any suitable communication channel (e.g., virtual IP networks, the virtual bus 2004, inter-process communication, etc.) may be utilized to facilitate communication between the building device interface container 2006 and the processing container 2008.

The edge device gateway 2002 may implement a webserver 2028. The webserver 2028 may be an Apache webserver or an NGINX webserver, among others. The webserver 2028 can include software or combinations of hardware and software that accept requests via HTTP or HTTPS. Requests can be transmitted to the webserver 2028 via the local user interface 2054, which may include, commonly a web browser or native application implementing web-browsing functionality. The webserver 2028 can receive a request for one or more web pages (e.g., generated or provided by the user interface backend 2026) or other resources using HTTP. The webserver 2028 can responds with the content of that resource or an error message.

The edge device gateway 2002 can execute the various containers described herein according to a startup sequence, which may be specified in one or more configuration settings or files, or may be provided as part of the container(s) received in a configuration image from the configuration manager 1928, for example. In some implementations, different containers implemented by the edge device gateway 2002 can include one or more internal dependencies (e.g., an identification of containers that should be initialized prior to the instant container). A watchdog wrapper script, application startup handshakes, or periodic heartbeats (e.g., where each component publish a periodic heartbeat with its running status that other components on the bus can subscribe to) can be implemented to enforce a startup execution order of the various containers implemented by the edge device gateway 2002.

It should be understood that although the forgoing description has described the edge device gateway 2002 as implementing various containers, that any type of building device described herein may implement containers, connectors, and the virtual bus 2004 to facilitate communication between the implemented container and other software components. For example, the various building gateways, BMS servers, and building devices described herein may also implement various containers. In some implementations, said devices may further implement connectivity with the cloud platform 106 to create, update, or remove container components, and to gather data from and control various building subsystems 122 or other building devices in one or more buildings.

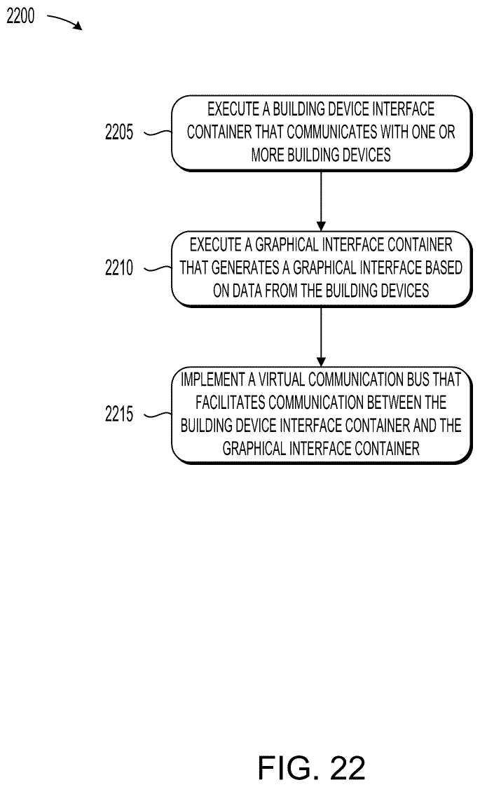

FIG. 22 is a flow diagram of an example method 2200 for the integration and containerization of gateway components on edge devices, in accordance with one or more implementations. In various embodiments, the edge device gateway 2002 performs the method 2200. However, it should be understood that any computing system described herein may perform any or all of the operations described in connection with the method 2200. For example, in some embodiments, the local server 702, the device/gateway 720, the local BMS server 804, the network engine 816, the gateway 1004, the gateway manager 1202, the cluster gateway 1206, the edge device 1902, the edge device gateway 2002, or any other computing systems or devices described herein, may perform the method 2200. The computing system performing the operations of the method 2200 is referred to in the following description as the “building device gateway.” The method 2200 includes steps 2205-2215, however it should be understood that steps may be removed, performed in an alternate order, or additional steps may be performed, while still achieving useful results.

At step 2205, the building device gateway (e.g., the edge device gateway 2002, the local server 702, the device/gateway 720, the local BMS server 804, the network engine 816, the gateway 1004, the gateway manager 1202, the cluster gateway 1206, the edge device 1902, etc.) can execute a building device interface container (e.g., the building device interface container 2006) that communicates, via an interface (e.g., the device interface 2018, etc.) implemented by the building device interface container, with one or more building devices (e.g., one or more building subsystems 122) of a building to control or collect data from the one or more building devices. The building device gateway can provide the building device interface container for execution, for example, by storing the building device interface container in a region of memory of the building device gateway. The data can be sensor data, diagnostic data, log messages, metadata, data relating to control schedules, fault data, operational data, configuration data, or any other type of data described herein.

At step 2210, the building device gateway can execute a processing container (e.g., the processing container 2008). The processing container 2008 can be or include any type of container capable of processing data generated, retrieved, provided to, or otherwise accessed by the building device interface container and/or the virtual bus (e.g., from the cloud platform 106). In one example, the processing container can be or include a graphical user interface container. In some implementations, the processing container can be or include a reporting container that generates and provides reports based on the data retrieved from one or more building subsystems (e.g., the building subsystems 122). The reports may include reports of internal data processed by the edge device gateway, and may include diagnostic data, versioning data, or any data stored or otherwise accessed by the edge device gateway, the components thereof, the cloud platform, or other devices in communication with the edge device gateway or the cloud platform.

In some implementations, the processing container can be or include an energy container, which can track the energy expenditure of the edge device gateway and/or the building subsystems in communication with the edge device gateway. For example, the energy container may track, store, and report energy expenditure to the cloud platform, in some implementations. The processing container may be or include a building health container, which can track and report the operational health of the building subsystems of a building in communication with the edge device gateway. The building health container may determine and provide service status data, maintenance schedule data, operating status data, or other information received and/or processed from the building subsystems of the edge device gateway to the cloud platform and/or a local user interface as described herein.

In some implementations, the processing container can be or include a graphical interface container that generates a graphical user interface (e.g., presented via the local user interface 2054) based on the data from the one or more building devices. The building device gateway can provide the graphical interface container for execution, for example, by storing the graphical interface container in a region of memory of the building device gateway. For example, the graphical user interface may include any of the data captured from or relating to the building devices. In some implementations, an operator can provide one or more requests for particular data or sets of data via the user interface. The graphical interface container can process and forward the request to the building device interface container, which can retrieve the requested data from computer memory or from the corresponding building subsystems 122. The building device interface container can then forward the retrieved data to the graphical interface container, which can format and present the retrieved data in the graphical user interface to satisfy the request.

At step 2215, the building device gateway can implement a virtual communication bus (e.g., the virtual bus 2004) that facilitates communication between the building device interface container and the graphical interface container. The virtual communication bus can include a virtual IP network, and may transmit messages by communicating one or more IP packets between the containers executed by the building device gateway. The messages may include HTTP data or data corresponding to any type of messaging protocol described herein. The virtual communication bus can implement a publish-subscribe messaging pattern, where the virtual communication bus can receive and transmit one or more messages identifying one or more topics. The topics can be specified by the containers that transmitted the one or more message, and the messages can be provided to the container that subscribes to the topics to with which the messages are associated. For example, the graphical interface container can include a configuration that subscribes the graphical interface container to a subset of the one or more topics, such as topics involving raw data that is to be provided for display.

The building device gateway can implement additional containers that communicated via the implemented virtual communication bus. In some implementations, the building device gateway can implement a cloud communication container (e.g., the cloud connector 2038) that communicates data transmitted via the virtual communication bus to or from a cloud computing system (e.g., the cloud platform 106). The cloud communication container can subscribe to a subset of the topics that indicate the messages should be transmitted to the cloud computing system. In some implementations, the building device gateway can execute a cloud proxy container (e.g., the cloud proxy 2036) that formats data transmitted via the virtual communication bus according to a standard format of the cloud computing system. In some implementations, the cloud proxy container can periodically transmit the formatted data to the cloud computing system via the cloud communication container and the virtual communication bus.

In some implementations, the building device gateway can implement one or more software components to instantiate, modify, update, or remove one or more containers. For example, the building device gateway can receive an update (e.g., via the DM agent 2030, from the cloud platform 106, etc.) to one or more of the building device interface container or the graphical interface container. Upon receiving the updates to the container, the building device gateway can modify one or more of the building device interface container or the graphical interface container according to the update. For example, the building device gateway can modify a configuration of the corresponding container, replace the container with an updated container, or remove a container, among other operations described herein.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

References to “or” may be construed as inclusive so that any terms described using “or” may indicate any of a single, more than one, and all of the described terms.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A building device gateway of a building, comprising:
one or more processors coupled to a non-transitory memory, the one or more processors configured to:
execute a building device interface container that communicates, via an interface implemented by the building device interface container, with one or more building devices of the building to control or collect data from the one or more building devices;
execute a processing container that processes the data from the one or more building devices; and
implement a virtual communication bus that facilitates communication between the building device interface container and the processing container.

2. The building device gateway of claim 1, wherein the one or more processors are further configured to:
receive an update to one or more of the building device interface container or the processing container; and
modify one or more of the building device interface container or the processing container according to the update.

3. The building device gateway of claim 1, wherein the virtual communication bus comprises a virtual Internet protocol (IP) network.

4. The building device gateway of claim 1, wherein the one or more processors are further configured to execute a cloud communication container that communicates data transmitted via the virtual communication bus to or from a cloud computing system.

5. The building device gateway of claim 4, wherein the one or more processors are further configured to execute a cloud proxy container that formats data transmitted via the virtual communication bus according to a standard format of the cloud computing system.

6. The building device gateway of claim 5, wherein the cloud proxy container is further configured to periodically transmit the formatted data to the cloud computing system.

7. The building device gateway of claim 1, wherein the virtual communication bus is configured to receive and transmit one or more messages identifying one or more topics.

8. The building device gateway of claim 7, wherein the processing container comprises a configuration that subscribes the processing container to a subset of the one or more topics.

9. The building device gateway of claim 1, wherein the processing container comprises one or more of a graphical user interface container, an analytical engine container, an edge management container, or a logs management container.

10. A method, comprising:
providing, by a building device gateway comprising one or more processors and a non-transitory memory, for execution, a building device interface container that communicates, via an interface implemented by the building device interface container, with one or more building devices of the building to control or collect data from the one or more building devices;
executing, by the building device gateway, for execution, a processing container that processes the data from the one or more building devices; and
implementing, by the building device gateway, a virtual communication bus that facilitates communication between the building device interface container and the processing container.

11. The method of claim 10, further comprising:
receiving, by the building device gateway, an update to one or more of the building device interface container or the processing container; and
modifying, by the building device gateway, one or more of the building device interface container or the processing container according to the update.

12. The method of claim 10, wherein the virtual communication bus comprises a virtual Internet protocol (IP) network.

13. The method of claim 10, further comprising providing, by the building device gateway, for execution, a cloud communication container that communicates data transmitted via the virtual communication bus to or from a cloud computing system.

14. The method of claim 13, further comprising providing, by the building device gateway, for execution, a cloud proxy container that formats data transmitted via the virtual communication bus according to a standard format of the cloud computing system.

15. The method of claim 14, wherein the cloud proxy container, when executed, is further configured to periodically transmit the formatted data to the cloud computing system.

16. The method of claim 10, wherein implementing the virtual communication bus comprises receiving and transmitting one or more messages identifying one or more topics.

17. The method of claim 16, wherein the processing container comprises a configuration that subscribes the processing container to a subset of the one or more topics.

18. The method of claim 10, wherein the processing container comprises one or more of a graphical user interface container, an analytical engine container, an edge management container, or a logs management container.

19. A non-transitory computer-readable medium with processor-executable instructions embodied thereon that, when executed by one or more processors of a building device gateway, cause the building device gateway to perform operations comprising:
executing a building device interface container that communicates, via an interface implemented by the building device interface container, with one or more building devices of the building to control or collect data from the one or more building devices;
executing a processing container that processes the data from the one or more building devices; and
implementing a virtual communication bus that facilitates communication between the building device interface container and the processing container.

20. The non-transitory computer-readable medium of claim 19, wherein the operations further comprise:
receiving an update to one or more of the building device interface container or the processing container; and
modifying one or more of the building device interface container or the processing container according to the update.
